(19) United States
(12) Patent Application Publication
(10) Pub. No.: US 2026/0253036 A1
(43) Pub. Date: Aug. 27, 2026

(54) SYSTEM AND METHODS FOR MANAGING AND ORGANIZING RESOURCES IN A COLLABORATIVE WORK SYSTEM

(71) Applicant: MONDAY.COM LTD., Tel Aviv (IL)

(72) Inventors: Admon SASSON, Tel Aviv-Yafo (IL); Nitzan WOLF, Tel Aviv-Yafo (IL); Sebastian CURLAND, Rehovot (IL); Alon SCHATZ, Tel Aviv-Yafo (IL); Roee FAIGENBLOOM, Petah Tikva (IL); Uri SHMUELI, Kiryat Ono (IL)

(73) Assignee: MONDAY.COM LTD., Tel Aviv (IL)

(21) Appl. No.: 19/437,125

(22) Filed: Dec. 30, 2025

Related U.S. Application Data
(63) Continuation of application No. 19/384,597, filed on Nov. 10, 2025.
(60) Provisional application No. 63/764,309, filed on Feb. 27, 2025.

(51) Int. Cl. G06Q 10/10

(52) U.S. Cl. CPC G06Q 10/103

(57) ABSTRACT

Systems, methods, and computer-readable media for governing a centralized framework that enforces a hierarchical relationship between a template and user-facing applications implementing the template may involve at least one processor configured to: maintain a data structure storing a template integrable with a plurality of user-facing applications and including a data format, at least one existing pre-population rule for configuring data within the data format, variable definitions, and metadata that link each user-facing applications to the template; establish control between the template and the user-facing applications, each user-facing application being structurally and functionally dependent on the template through metadata; provide an interface for modifying the template, wherein template modifications are centrally managed and propagated to each user-facing application integrating the template; update and enforce template modifications across each user-facing application; and maintain hierarchical governance between the template and each user-facing application, wherein template modifications are inherited by each user-facing application.

### CROSS-REFERENCE TO RELATED APPLICATION

This application claims the benefit of priority to U.S. Provisional Patent Application No. 63/764,309, filed Feb. 27, 2025, which is incorporated herein by reference in its entirety.

### TECHNICAL FIELD

The present disclosure relates generally to data management solutions systems, methods, and computer-readable media, in a collaborative work system. More specifically, the disclosed embodiments enable management and organization of resources within a collaborative work system. Various disclosed embodiments employ structures and non-transitory computer-readable storage media that store program instructions executable by at least one processing device to perform any of the steps and/or methods described herein.

### BACKGROUND

Operations of modern enterprises can be complicated and time-consuming. In many cases, managing a single project often requires integrating several employees, departments, and other resources of the entity. To manage challenging operations, project management software applications or platforms (e.g., Software as a Service platforms or SaaS platforms) may be used. Such software applications allow a user to organize, plan, and manage resources in collaboration with other users by providing a collaborative platform in which users share project-related information to optimize the time and resources spent on each project.

As businesses grow, the complexity of managing diverse teams, projects, and workflows increases significantly. While project management tools offer foundational support, they often struggle to provide solutions that effectively balance flexibility with organizational structure. This imbalance can lead to misalignment across departments, inconsistent execution of tasks, and communication breakdowns. Traditional template-based solutions, in particular, present several limitations. For example, they frequently lack the ability to propagate updates in real time across all user accounts, making it difficult to maintain consistency when changes are made. Additionally, these systems may not adequately respect privacy boundaries, especially when templates are shared across teams with varying access levels. Cross-department collaboration can also be hindered when templates are rigid or fail to adapt to the unique needs of different groups. These challenges can result in duplicated efforts, miscommunication, and delays in project execution. The present disclosure describes solutions to address or overcome one or more of the above-stated challenges, among other drawbacks in existing project management systems.

### SUMMARY

Some embodiments consistent with the present disclosure provide digital systems, methods, and computer-readable media for managing and organizing resources in a collaborative work system. Some embodiments may be implemented using a combination of conventional hardware and software as well as specialized hardware and software such as a machine constructed and/or programmed specifically for performing functions associated with the disclosed method steps. Consistent with other disclosed embodiments, non-transitory computer-readable storage media may store program instructions, which may be executable by at least one processing device and perform any of the steps and/or methods described herein.

In one embodiment, systems, methods, and computer-readable media for governing a centralized framework that enforces a hierarchical relationship between a template and a plurality of user-facing applications implementing the template are disclosed. Systems, methods, devices, and non-transitory computer readable media may involve at least one processor configured to: maintain a data structure storing a template integrable with a plurality of user-facing applications, wherein the template includes a data format, at least one existing pre-population rule for configuring data within the data format, variable definitions, and metadata that links each of the plurality of user-facing applications to the template; establish control between the template and the plurality of user-facing applications, wherein each of the plurality of user-facing applications is structurally and functionally dependent on the template through metadata; provide an interface for modifying the template, wherein modifications to the template are centrally managed and propagated to each of the plurality of user-facing applications in which the template is integrated; update and enforcing template modifications across each of the plurality of user-facing applications; and maintain hierarchical governance between the template and each of the plurality of user-facing applications, wherein modifications to the template are inherited by each of the plurality of user-facing applications.

In another embodiment, systems, methods, and computer-readable media for controlling access to information included in user-facing software integrating a template are disclosed. Systems, methods, devices, and non-transitory computer-readable media may involve at least one processor configured to: access a data structure storing a template integrable with a plurality of user-facing applications, and wherein the template includes a data format and at least one existing pre-population rule for configuring data within the data format; receive from a user, via an interface for editing the template, instructions to generate at least one permission rule configured to block control by at least some users of the plurality of user-facing applications in which the template is integrated, of at least a portion of the data included in the data format; receive from the user via the interface for editing the template, instructions to modify the template; update the template by including the newly generated permission rule and modifications in the template; determine compatibility of each user-facing application with the updated template by analyzing a current state of each of the plurality of user-facing applications; and push the updated template to the plurality of user-facing applications integrable with the template by: identifying differences between the updated template and each user-facing application; generating a set of updates that apply only the determined differences to each of the plurality user-facing applications; and applying the set of updates to each of the plurality of user-facing applications.

In yet another embodiment, systems, methods, and computer-readable media for consolidating data from multiple data sources are disclosed. Systems, methods, devices, and non-transitory computer-readable media may involve at least one processor configured to: access data from at least two differently structured databases, each of the at least two differently structured databases being associated with at least one data structure including data fields; in a SaaS platform, maintain a schema including a predefined set of rules and definitions configured to standardize interpretation and organization of data entries across the at least two differently structured databases; implement the schema to: for each of the at least two differently structured databases, use the predefined set of rules of the schema to perform a compliance check on at least one portion of the data entries; upon determining compliance of the at least one portion of the data entries with the predefined set of rules of the schema, identify schema-compliant data entries and associate each of the at least two differently structured databases with the schema; enable interaction between the at least two differently structured databases; and facilitate issuance of one or more high-level commands applicable across the at least two differently structured databases, wherein the schema translates the one or more high-level commands into instructions adapted to the at least one data structure of each of the at least two differently structured databases to execute an intended action.

In yet another embodiment, systems, methods, and computer-readable media for bottom-up data structure development are disclosed. Systems, methods, devices, and non-transitory computer-readable media may involve at least one processor configured to: in a SaaS platform, maintain a schema, including a predefined set of rules and definitions configured to standardize interpretation and organization of data entries across a group of data structures, wherein each data structure of the group is associated with the schema and includes data fields and associated entries; access an additional data structure including data fields and associated entries, wherein the additional data structure is differently structured than at least one data structure from the group of data structures and is initially not associated with the schema; receive a signal to associate the additional data structure with the schema; perform a compliance check on at least one portion of the entries within the additional data structure with the predefined set of rules and definitions of the schema; upon determining compliance of the at least one portion of the entries with the predefined set of rules and definitions of the schema, map data fields and associated entries of the additional data structure with the predefined set of rules and definitions included in the schema; and add the additional data structure to the group of data structures, to thereby establish compatibility and standardization across the group of data structures.

In yet another embodiment, systems, methods, and computer-readable media for connecting user-facing applications governed by distinct templates are disclosed. Systems, methods, devices, and non-transitory computer-readable media may involve at least one processor configured to: in a SaaS platform, access data of at least two user-facing applications, wherein each of the at least two user-facing applications is structurally and functionally dependent on a respective template through metadata and is associated with at least one data structure, including data fields and data entries governed by the respective template; apply a schema including a predefined set of rules and definitions configured to standardize interpretation and organization of data entries across the at least two user-facing applications; receive mapping information, wherein the mapping information identifies schema-compliant data entries included in the at least two user-facing applications; associate the identified schema-compliant data entries included in the at least two user-facing applications with the schema; and translate one or more high-level commands applicable across the at least two user-facing applications, wherein the schema translates the one or more high-level commands into instructions adapted to the at least one data structure governed by the specific template of each of the at least two user facing applications to execute an intended action.

### BRIEF DESCRIPTION OF DRAWINGS

The accompanying drawings, which are incorporated in and constitute a part of this disclosure, illustrate various disclosed embodiments. In the drawings:

FIG. 1 is a block diagram of an exemplary SaaS/project management platform, consistent with some disclosed embodiments;

FIG. 2A is a block diagram of an exemplary computing device or system which may be employed in connection with some embodiments of the present disclosure; and

FIG. 2B is a block diagram of an exemplary computing architecture for collaborative work systems, consistent with some embodiments of the present disclosure.

FIG. 3A is an exemplary layout of a customized template including a single column, consistent with some embodiments of the present disclosure.

FIG. 3B is an exemplary layout of another customized template including a plurality of columns, consistent with some embodiments of the present disclosure.

FIG. 3C is an exemplary layout of another customized template, consistent with some embodiments of the present disclosure.

FIG. 3D is an exemplary layout of yet another customized template and an integrated sub-template, consistent with some embodiments of the present disclosure.

FIG. 4 is a block diagram of an exemplary process for automatically applying changed templates across user applications, consistent with some embodiments of the present disclosure.

FIG. 5 illustrates an example of a logical template displayed in a user interface, consistent with some embodiments of the present disclosure.

FIG. 6 illustrates an example of a table that includes multiple columns, consistent with some embodiments of the present disclosure.

FIG. 7 illustrates an example of a logical template showing a predefined requirement in a user interface, consistent with some embodiments of the present disclosure.

FIG. 8 illustrates another example of a logical template showing a predefined requirement in a user interface, consistent with some embodiments of the present disclosure.

FIG. 9 illustrates an example of a logical template showing a user-definable requirement in a user interface, consistent with some embodiments of the present disclosure.

FIG. 10 illustrates another example of a logical template showing a user-definable requirement in a user interface, consistent with some embodiments of the present disclosure.

FIG. 11 illustrates an example of a logical template showing a dynamic user-definable requirement in a user interface, consistent with some embodiments of the present disclosure.

FIG. 12 illustrates another example of a logical template showing a dynamic user-definable requirement in a user interface, consistent with some embodiments of the present disclosure.

FIG. 13 illustrates another example of a logical template showing a dynamic user-definable requirement in a user interface, consistent with some embodiments of the present disclosure.

FIG. 14 illustrates an example of a logical template in a user interface showing multiple user-definable requirements, consistent with some embodiments of the present disclosure.

FIG. 15 illustrates an example of a logical template showing a logic operation in a user interface, consistent with some embodiments of the present disclosure.

FIG. 16 illustrates an example of re-configuring a logical template in a user interface, consistent with some embodiments of the present disclosure.

FIG. 17 illustrates an example of creating a logical template with free-form texts in a user interface, consistent with some embodiments of the present disclosure.

FIG. 18 is a block diagram of an exemplary process for automating tablature, consistent with some embodiments of the present disclosure.

FIG. 19 is a flowchart of an exemplary process for governing a centralized framework that enforces a hierarchical relationship between a template and a plurality of user-facing applications implementing the template, consistent with some embodiments of the present disclosure.

FIGS. 20A, 20B, and 20C are illustrations of an exemplary user interface for editing a template, consistent with some embodiments of the present disclosure.

FIG. 21 is an illustration of relationships existing between a template and a plurality of user-facing applications, consistent with some embodiments of the present disclosure.

FIG. 22 is a flowchart of an exemplary process for controlling access to information included in user-facing software integrating a template, consistent with some embodiments of the present disclosure.

FIG. 23 is a flowchart of an exemplary process for consolidating data from multiple data sources, consistent with some embodiments of the present disclosure.

FIGS. 24A and 24B are illustrations of two exemplary differently structured databases, consistent with some embodiments of the present disclosure.

FIG. 25 is an illustration of a schema comprising a predefined set of rules and definitions, consistent with some embodiments of the present disclosure.

FIG. 26 is a schematic illustration of a mapping process between the schema of FIG. 25 and the two differently structured databases of FIGS. 24A and 24B, consistent with some embodiments of the present disclosure.

FIG. 27 is a flowchart of an exemplary process for bottom-up data structure development, consistent with some embodiments of the present disclosure.

FIGS. 28A and 28B are illustrations of exemplary user interfaces designed for editing SaaS platform elements, consistent with some embodiments of the present disclosure.

FIG. 29 is a flowchart of an exemplary process for connecting user-facing applications governed by distinct templates, consistent with some embodiments of the present disclosure.

FIGS. 30A and 30B are illustrations of two exemplary user-facing applications, consistent with some embodiments of the present disclosure.

FIG. 30C is an illustration of another schema comprising a predefined set of rules and definitions, consistent with some embodiments of the present disclosure.

### DETAILED DESCRIPTION

Disclosed embodiments provide new and improved techniques for implementing data management solutions enabling user-enhanced data representation.

Exemplary embodiments are described with reference to the accompanying drawings. The figures are not necessarily drawn to scale. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It should also be noted that as used herein and in the appended claims, the singular forms “a,” “an,” and “the” include plural references unless the context clearly dictates otherwise.

In the following description, various working examples are provided for illustrative purposes. However, is to be understood the present disclosure may be practiced without one or more of these details.

Throughout, this disclosure mentions “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure presents various mechanisms for collaborative work systems. Such systems may involve software that enables multiple users to work collaboratively. By way of one example, workflow management software may enable various members of a team to cooperate via a common online platform. It is intended that one or more aspects of any mechanism may be combined with one or more aspects of any other mechanisms, and such combinations are within the scope of this disclosure.

This disclosure is constructed to provide a basic understanding of a few exemplary embodiments with the understanding that features of the exemplary embodiments may be combined with other disclosed features or may be incorporated into platforms or embodiments not described herein while still remaining within the scope of this disclosure. For convenience and form the word “embodiment” as used herein is intended to refer to a single embodiment or multiple embodiments of the disclosure.

Certain embodiments disclosed herein include devices, systems, and methods for collaborative work systems that may allow one or more users to interact with information in real-time. To avoid repetition, the functionality of some embodiments is described herein solely in connection with a processor or at least one processor. It is to be understood that such exemplary descriptions of functionality apply equally to methods and computer-readable media and constitute a written description of systems, methods, and computer-readable media. The underlying platform may allow a user to structure systems, methods, or computer-readable media in many ways using common building blocks, thereby permitting flexibility in constructing a product that suits desired needs. This may be accomplished through the use of boards. A board may be a table configured to contain items (e.g., individual items presented in horizontal rows) defining objects or entities that are managed in the platform (task, project, client, deal, etc.). Unless expressly noted otherwise, the terms “board” and “table” may be considered synonymous for purposes of this disclosure. In some embodiments, a board may contain information beyond what is displayed in a table. For example, a board may further contain cell comments, hidden rows and columns, formulas, data validation rules, filters, specific formatting, audit logs, version history, cross-referencing with different boards, external linking with data sources, permissions of access, or a combination thereof. Boards may include sub-boards that may have a separate structure from a board. Sub-boards may be tables with sub-items that may be related to the items of a board. Columns intersecting with rows of items may together define cells in which data associated with each item may be maintained. Each column may have a heading or label defining one or more associated data types and may further include metadata (e.g., definitions, validation rules, ranges, hyperlinks, macros . . . ). When used herein in combination with a column, a row may be presented horizontally and a column vertically. However, in the broader generic sense as used herein, the term “row” may refer to one or more of a horizontal and/or a vertical presentation. A table or tablature as used herein, refers to data presented in horizontal and vertical rows, (e.g., horizontal rows and vertical columns) defining cells in which data is presented. Tablature may refer to any structure for presenting data in an organized manner, as previously discussed. such as cells presented in horizontal rows and vertical columns, vertical rows and horizontal columns, a tree data structure, a web chart, or any other structured representation, as explained throughout this disclosure. A cell may refer to a unit of information contained in the tablature defined by the structure of the tablature. For example, a cell may be defined as an intersection between a horizontal row with a vertical column in a tablature having rows and columns. A cell may also be defined as an intersection between a horizontal and a vertical row, or as an intersection between a horizontal and a vertical column. As a further example, a cell may be defined as a node on a web chart or a node on a tree data structure. As would be appreciated by a skilled artisan, however, the disclosed embodiments are not limited to any specific structure but rather may be practiced in conjunction with any desired organizational arrangement. In addition, tablature may include any type of information, depending on intended use. As an example, when used in conjunction with a project/task management application, the tablature may include any information associated with one or more tasks, such as one or more status values, projects, time-frames/deadlines, countries, persons, teams, progress statuses, a combination thereof, or any other information related to a task. In some cases, a hierarchy may be established between different items/cells in a same row. For example, a unique identifier (UID) may be assigned to an item and the other cell of the same row may then be associated with the item or the assigned UID.

While a table view may be one way to present and manage the data contained on a board, a table's or board's data may be presented in different ways. For example, in some embodiments, dashboards may be utilized to present or summarize data derived from one or more boards. A dashboard may be a non-table form of presenting data, using, for example, static or dynamic graphical representations. A dashboard may also include multiple non-table forms of presenting data. As discussed later in greater detail, such representations may include various forms of graphs or graphics (which may also be referred to more generically as “widgets”). In some instances, dashboards may also include tablature. Software links may interconnect one or more boards with one or more dashboards thereby enabling the dashboards to reflect data presented on the boards. This may allow, for example, data from multiple boards to be displayed and/or managed from a common location. These widgets may provide visualizations that allow a user to update data derived from one or more boards.

Boards (or the data associated with boards) may be stored in a local memory on a user device or may be stored in a local network repository. Boards may also be stored in a remote repository and may be accessed through a network. In some instances, permissions may be set to limit board access to the board's “owner” while in other embodiments a user's board may be accessed by other users through any of the networks described in this disclosure. In alternative scenarios, permission may not only be provided at the board level, but also at a more granular level such as rows, columns, and even individual cells, allowing for fine-grained control over who may access, view, edit, or interact with the data included in the board, particularly useful when dealing with collaborative boards. When one user makes a change in a board, that change may be updated to the board stored in a memory or repository and may be pushed to the other user devices that access that same board. These changes may be made to cells, items, columns, boards, dashboard views, logical rules, or any other data associated with the boards. Similarly, when cells are tied together or are mirrored across multiple boards, a change in one board may cause a cascading change in the tied or mirrored boards or dashboards of the same or other owners.

Boards and widgets may be part of a platform that may enable users to interact with information in real-time in collaborative work systems involving electronic collaborative word-processing documents. Electronic collaborative word processing documents (and other variations of the term) as used herein are not limited to only digital files for word processing but may include any other processing document such as presentation slides, tables, databases, graphics, sound files, video files or any other digital document or file. Electronic collaborative word processing documents may include any digital file that may provide for input, editing, formatting, display, and/or output of text, graphics, widgets, objects, tables, links, animations, dynamically updated elements, or any other data object that may be used in conjunction with the digital file. Any information stored on or displayed from an electronic collaborative word processing document may be organized into blocks. A block may include any organizational unit of information in a digital file, such as a single text character, word, sentence, paragraph, page, graphic, or any combination thereof. Blocks may include static or dynamic information and may be linked to other sources of data for dynamic updates. Blocks may be automatically organized by the system or may be manually selected by a user according to preference. In one embodiment, a user may select a segment of any information in an electronic word-processing document and assign it as a particular block for input, editing, formatting, or any other further configuration.

An electronic collaborative word-processing document may be stored in one or more repositories connected to a network accessible by one or more users through their computing devices. In one embodiment, one or more users may simultaneously edit an electronic collaborative word-processing document. The one or more users may access the electronic collaborative word-processing document through one or more user devices connected to a network. User access to an electronic collaborative word processing document may be managed through permission settings set by an author of the electronic collaborative word processing document. Alternatively, permissions to specific portions of the electronic collaborative word-processing document may be provided in order to control access, facilitate collaboration, and ensure that different users have appropriate levels of involvement and authority over different parts of the content. An electronic collaborative word-processing document may include graphical user interface elements enabled to support the input, display, and management of multiple edits made by multiple users operating simultaneously within the same document.

Various embodiments are described herein with reference to a system, method, device, or computer-readable medium. It is intended that the disclosure of one is a disclosure of all. For example, it is to be understood that disclosure of a computer-readable medium described herein also constitutes a disclosure of methods implemented by the computer-readable medium, and systems and devices for implementing those methods, via for example, at least one processor. It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer-readable medium containing instructions that when executed by at least one processor, cause the at least one processor to perform a method. Non-transitory computer-readable mediums may be any medium capable of storing data in any memory in a way that may be read by any computing device with a processor to carry out methods or any other instructions stored in the memory. The non-transitory computer-readable medium may be implemented as hardware, firmware, software, or any combination thereof. Moreover, the software may preferably be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium may be any computer-readable medium except for a transitory propagating signal.

As used herein, a non-transitory computer-readable storage medium refers to any type of physical memory on which information or data readable by at least one processor can be stored. Examples of memory include Random Access Memory (RAM), Read-Only Memory (ROM), volatile memory, nonvolatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within an input unit or at a remote location. Additionally, one or more computer-readable storage mediums can be utilized in implementing a computer-implemented method. The memory may include one or more separate storage devices collocated or disbursed, capable of storing data structures, instructions, or any other data. The memory may further include a memory portion containing instructions for the processor to execute. The memory may also be used as a working scratch pad for the processors or as temporary storage. Accordingly, the term computer-readable storage medium should be understood to include tangible items and exclude carrier waves and transient signals.

Some embodiments may involve at least one processor. Consistent with disclosed embodiments, “at least one processor” may constitute any physical device or group of devices having electric circuitry that performs a logic operation on an input or inputs. For example, the at least one processor may include one or more integrated circuits (IC), including application-specific integrated circuits (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction, or the processors may be of differing constructions that are electrically connected or disconnected from each other. For example, the processors may be separate circuits or integrated into a single circuit. When more than one processor is used, the processors may be configured to operate independently or collaboratively and may be co-located or located remotely from each other. The processors may be coupled electrically, magnetically, optically, acoustically, mechanically, or by other means that permit them to interact.

Consistent with the present disclosure, disclosed embodiments may involve a network. A network may constitute any type of physical or wireless computer networking arrangement used to exchange data. For example, a network may be the Internet, a private data network, a virtual private network using a public network, a Wi-Fi network, a LAN or WAN network, a combination of one or more of the foregoing, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or an unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near-field communications (NFC), or other suitable communication methods that provide a medium for exchanging data and/or information between separate entities.

Certain embodiments disclosed herein may also include a computing device for generating features for work collaborative systems, the computing device may include processing circuitry communicatively connected to a network interface and to a memory, wherein the memory contains instructions that, when executed by the processing circuitry, configure the computing device to receive from a user device associated with a user account instruction to generate a new column of a single data type for a first data structure, wherein the first data structure may be a column-oriented data structure, and store, based on the instructions, the new column within the column-oriented data structure repository, wherein the column-oriented data structure repository may be accessible and may be displayed as a display feature to the user and at least a second user account. The computing devices may be devices such as mobile devices, desktops, laptops, tablets, or any other devices capable of processing data. Such computing devices may include a display such as an LED display, augmented reality (AR), or virtual reality (VR) display.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multi-dimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database, or NoSQL alternatives for data storage/search such as MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Certain embodiments disclosed herein may include a processor configured to perform methods that may include triggering an action in response to an input. The input may be from a user action or from a change of information contained in a user's table or board, in another table, across multiple tables, across multiple user devices, or from third-party applications. Triggering may be caused manually, such as through a user action, or may be caused automatically, such as through a logical rule, logical combination rule, or logical templates associated with a board. For example, a trigger may include an input of a data item that is recognized by at least one processor that brings about another action.

In some embodiments, the methods including triggering may cause an alteration of data and may also cause an alteration of display of data with different levels of granularity (e.g., a specific board, a plurality of boards . . . ) or across an entirety of an account or entity (e.g., multiple boards, workspaces, or projects within the account). An alteration of data may include a recalculation of data, the addition of data, the subtraction of data, or a rearrangement of information. Further, triggering may also cause a communication to be sent to a user, other individuals, or groups of individuals. The communication may be a notification within the system or may be a notification outside of the system through a contact address such as by email, phone call, text message, video conferencing, or any other third-party communication application.

Some embodiments include one or more automations, logical rules, logical sentence structures, and logical (sentence structure) templates. While these terms are described herein in differing contexts, in the broadest sense, in each instance an automation may include a process that responds to a trigger or condition to produce an outcome; a logical rule may underly the automation in order to implement the automation via a set of instructions; a logical sentence structure is one way for a user to define an automation; and a logical template/logical sentence structure template may be a fill-in-the-blank tool used to construct a logical sentence structure. While all automations may have an underlying logical rule, all automations need not implement that rule through a logical sentence structure. Any other manner of defining a process that responds to a trigger or condition to produce an outcome may be used to construct an automation.

Other terms used throughout this disclosure in differing exemplary contexts may generally share the following common definitions.

In some embodiments, machine learning algorithms (also referred to as machine learning models or artificial intelligence in the present disclosure) may be trained using training examples, for example in the cases described below. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may include an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes, and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyperparameters, where the hyperparameters are set manually by a person or automatically by a process external to the machine learning algorithm (such as a hyperparameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

Project management platforms are digital tools or software designed to streamline and automate various processes within an organization. They help to coordinate and manage tasks, activities, and information flow among several team members or different departments, ensuring efficient collaboration and productivity. These platforms typically provide features such as task assignment, progress tracking, notifications, and document management. In some cases, these platforms may correspond to a Software-as-a-Service (SaaS) platform. Within the context of this disclosure, a SaaS platform may refer to any kind of cloud-based software delivery model where service providers host software applications and make them accessible to users over the Internet. Instead of installing, managing, and maintaining the software locally, users access and utilize it through a web browser or thin client interface.

SaaS platforms offer a wide range of applications and services to meet various business needs such as customer relationship management (CRM), human resources management (HRM), project management, accounting, marketing automation, and more. In most scenarios, these platforms operate on a subscription basis, with customers paying recurring fees for software access and usage. SaaS platforms may provide several advantages including:
Accessibility: Users may conveniently and securely access software and data from any device with an internet connection.
Scalability: SaaS platforms may easily scale up or down to accommodate changing business requirements, providing flexibility and cost-effectiveness.
Cost-effectiveness: By eliminating upfront investments in hardware and software, SaaS may reduce initial costs. Customers may pay subscription fees based on their usage.
Maintenance and Updates: Service providers handle software maintenance, updates, and security patches, relieving customers of these responsibilities.
Collaboration: SaaS platforms often offer collaboration features, enabling multiple users to work together, share data, and communicate within the platform.
Customization: SaaS platforms can offer a high level of customization, allowing businesses to tailor the software to their specific needs. These applications can be seamlessly integrated with other business applications, particularly those offered by the same software provider. This integration enables smooth data flow and collaboration between different software systems, enhancing overall productivity and efficiency.

Some examples of SaaS platforms include Monday.com™ for project management, Salesforce™ for CRM, Slack™ for team collaboration, Dropbox™ for file hosting and sharing, Microsoft 365™ for productivity tools, Google Workspace™ apps for productivity and collaboration tools, Zendesk™ for customer support, HubSpot™ for marketing, and Shopify™ for e-commerce.

SaaS platforms may include a plurality of SaaS platform elements which may correspond to components or building blocks of the platform that work together to deliver software applications and services over the Internet. Examples of such elements may include application software, infrastructure, or user interface. For example, a platform may offer project management capabilities to its users via dashboards, tables, text documents, a workflow manager, diverse applications offered on a marketplace, all of which constitute building blocks and therefore elements of the platform. Application offered on the marketplace may be provided by developers external to the SaaS platform, accordingly, they may utilize a user interface different from a generic user interface provided by the SaaS platform. In addition, each SaaS platform element may include a plurality of SaaS platform sub-elements which may refer to smaller components or features that are part of a larger element within a SaaS platform. These sub-elements may be designed to perform specific tasks or provide specialized functionality. The collaboration of multiple sub-elements aims to create a comprehensive and integrated SaaS solution. Examples of SaaS platform sub-element may include a widget associated with a dashboard, a column or a cell associated with a table, a workflow block associated with a workflow manager, or pipeline management tools.

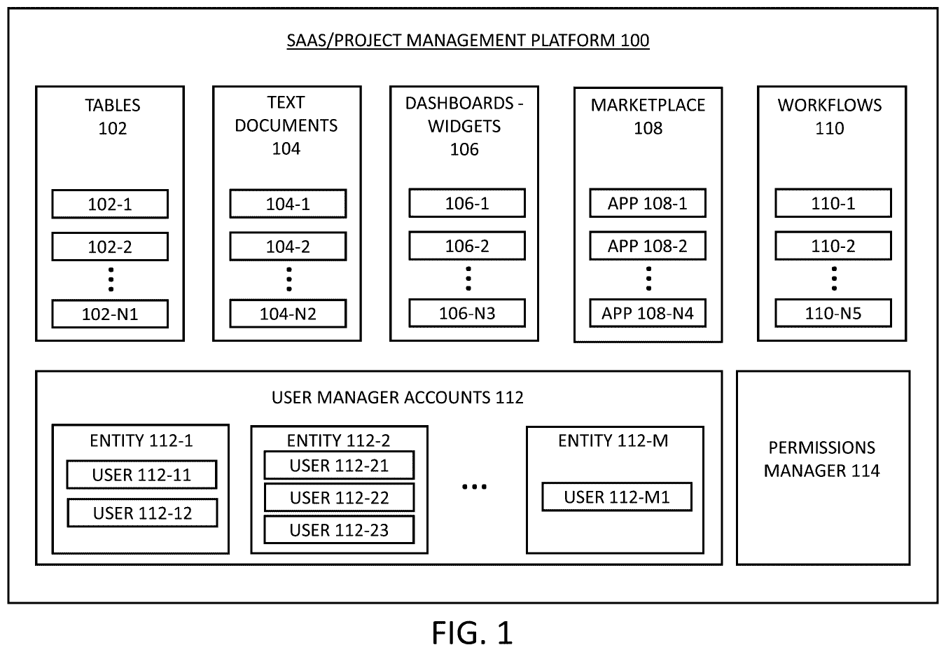

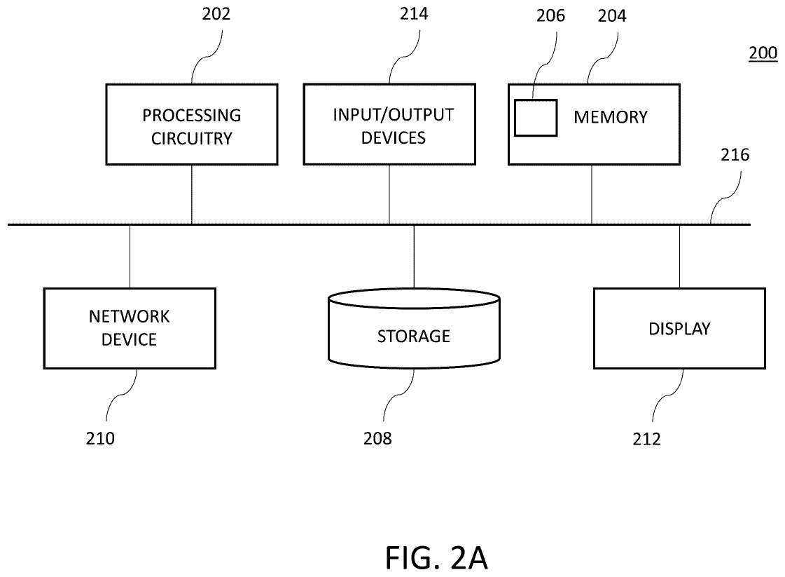

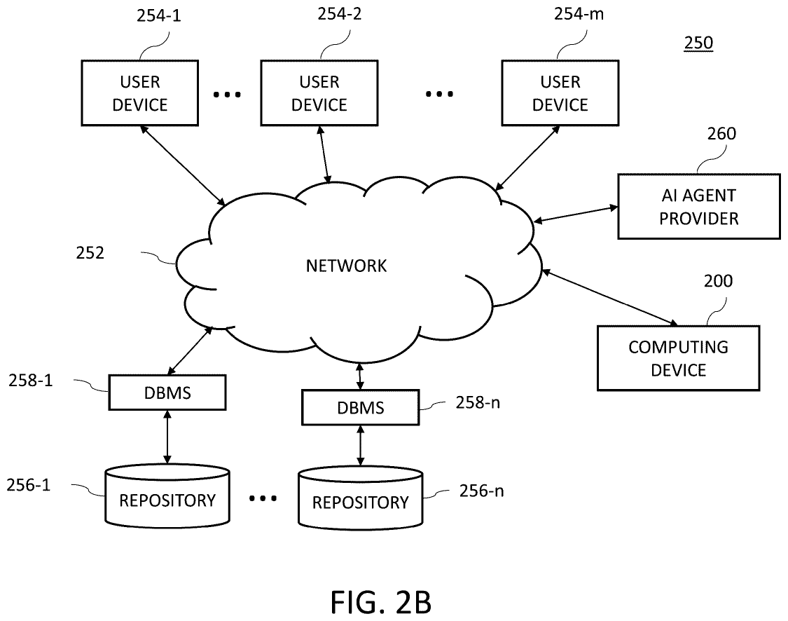

FIG. 1 is a block diagram of an exemplary SaaS platform 100. SaaS platform 100 may be associated with one or more components of a computing network such as the one shown in FIG. 2B. As illustrated, SaaS platform 100 includes a plurality of SaaS platform elements, namely Tables 102, Text documents 104, Dashboards 106, Marketplace 108, and Workflows 110. Each of these SaaS platform elements includes a plurality of SaaS platform sub-elements respectively 102-1 through 102-N1 for Tables 102, 104-1 through 104-N2 for Text documents 104, 106-1 through 106-N3 for Dashboards 106, APP 108-1 through APP 108-N4 for Marketplace 108 and 110-1 through 101-N5 for Workflows 110, wherein N1, N2, N3, N4 and N5 represent natural numbers.

It is to be appreciated that these SaaS platform elements may collaborate seamlessly. For instance, a text document (e.g., 104-1) might incorporate data from a table (e.g., 102-1), and a dashboard/widget (e.g., 106-1) might display data originating from a table (e.g., 102-1). This integration may ensure a cohesive and flexible user experience, allowing different components of the platform to work together effectively and dynamically share data. Additionally, it is to be appreciated that the utilizations of data originating from a first SaaS platform element (e.g., a table), by a second SaaS platform (e.g., a widget included a plurality of graphical representations) may not necessarily lead to additional memory allocation on a SaaS platform server. This efficiency maybe achieved because the data is not duplicated for each view (a table view or a dashboard/widget view). Instead, the data may be dynamically imported from the first SaaS platform element, often using pointers to their specific locations in memory. This approach ensures that the original data remains intact and avoids the overhead associated with creating multiple copies, thereby optimizing memory usage, and improving the overall performance of the server. For example, when a user of the SaaS platform requests a graphical representation (widget view) of data from a table, the platform may retrieve the necessary data by referencing the memory locations where the data is stored, rather than creating new instances of the data. These references, or pointers, serve as links to the original data, enabling the server to efficiently handle multiple requests without incurring significant memory costs. By leveraging this method, the SaaS platform may support numerous simultaneous views and graphical representations without a proportional increase in memory usage. Furthermore, this approach allows for real-time data updates to be reflected instantly across all views. Since all views point to the same data source, any changes to the data are immediately visible, ensuring consistency and accuracy. This method may be advantageous in environments where data is frequently updated, such as in financial systems, real-time analytics, and monitoring applications.

Several entity or organization accounts (user management accounts) 112 (112-1 to 112-M, M being a natural number) may be affiliated with SaaS platform 100 and managed via a user manager. Each of these entity accounts may include at least one user account. For example, entity account 112-1 includes two user accounts 112-11, 112-12, entity account 112-2 three user accounts 112-21, 112-22, and 112-23, and entity account 112-M one user account 112-M1. Within the context of the disclosed embodiments, an entity account may refer to the central account managing the overall SaaS platform subscription, billing, and settings. Within this entity account, multiple user accounts may be created for different individuals within the entity/organization. User accounts may have their own login credentials, access privileges, and settings. The entity account owner or administrators may have control over access, permissions, and data segregation. User accounts may collaborate and share resources within the entity account while maintaining a personalized experience. Each of the user accounts 112 may include different permutations of SaaS platform elements such as a plurality of tables, text documents, dashboards, marketplace applications, or CRM/pipeline management tools (not shown in FIG. 1) in association with the above-mentioned SaaS platform elements 102, 104, 106, 108, and 110. Accordingly, various SaaS platform elements or sub-elements may include metadata associated with users. Metadata associated with users may provide additional information and context about the users themselves, their profiles, roles, preferences, and interactions within the SaaS platform. Examples of metadata may include user profiles, roles and permissions, activity logs, usage indications, preferences and settings, user associations/relationships, user history, or a combination thereof.

In addition, each of these user accounts may include one or more private apps, that have been specifically designed and tailored to suit the needs of a user and that employ functionalities offered by or in association with SaaS platform 100 (via SaaS platform elements 102, 104, 106, 108, and 110 or their associated sub-elements). Private apps are exclusively accessible to users who are affiliated with an entity owning or implementing that app. These applications may not be publicly available (i.e., not on the market/publicly offered on the marketplace 108) and may only be accessed by individuals who have specific authorization or are part of the designated user group. The privacy settings associated with these apps restrict access to ensure that only authorized users can use and interact with them. This level of privacy and restricted access helps maintain confidentiality, control, and security over the application's functionalities and data, limiting usage to approved individuals within the user account. Centralization of user access and authorization management is performed by a permission manager 114 enabling administrators to control and regulate user privileges, ensuring that users have appropriate levels of access to data, features, and resources based on their roles and responsibilities. Permissions Manager 114 may offer granular control, and role-based access, facilitating efficient user management, collaboration, and compliance monitoring. Its objective is to enhance data security, streamline user administration, and maintain proper governance within the SaaS platform.

In some cases, a project management solution may be incorporated into a broader project management platform or may be offered as an offline software or as a Software-as-a-Service (SaaS). Project management solutions represent software application solutions designed to help individuals and teams plan, execute, and monitor projects efficiently. These solutions may provide tools for organizing tasks, managing resources, tracking progress, and facilitating collaboration among team members. Example features may include but are not limited to task scheduling, resource allocation, time tracking, budget management, and reporting. By centralizing project-related information and workflows, project management solutions aim to optimize productivity, ensure timely project completion, and improve overall project outcomes. At their core, project management solutions may encompass a diverse array of utilities. These utilities may include dynamic data tables and interactive boards that empower professionals to monitor and orchestrate every aspect of their project workflow. From the start of the project to the project deliverable, these solutions may offer a versatile toolkit designed to optimize performance and streamline processes.

FIG. 2A is a block diagram of an exemplary computing device 200 consistent with some embodiments. In some embodiments, computing device 200 may be similar in type and function to user device 254, discussed with respect to FIG. 2B. As shown in FIG. 12, computing device 200 may include processing circuitry 202, such as, for example, a central processing unit (CPU). In some embodiments, the processing circuitry 202 may include, or may be a component of, a larger processing unit implemented with one or more processors. The one or more processors may be implemented with any combination of any of the hardware components described earlier or any other suitable entities that may perform calculations or other manipulations of information. The processing circuitry such as processing circuitry 202 may be coupled via a bus 216 to a memory 204.

The memory 204 may further include a memory portion 204 that may contain instructions that when executed by the processing circuitry 202, may perform the methods described in more detail herein. Further details on memory are provided in above sections. The processing circuitry 202 may be further connected to a network device 210, such as a network interface card, for providing connectivity between the computing device 200 and a network, such as a network 252, discussed in more detail with respect to FIG. 2B below. The processing circuitry 202 may be further coupled with a storage device 208. The storage device 208 may be used for the purpose of storing single data type column-oriented data structures, data elements associated with the data structures, or any other data structures. While illustrated in FIG. 2A as a single device, it is to be understood that storage device 208 may include multiple devices either collocated or distributed.

The processing circuitry 202 and/or the memory 204 may also include machine-readable media for storing software. “Software” as used herein refers broadly to any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform the various functions described in further detail herein.

In some embodiments, computing device 200 may include one or more input and output devices 214. Input and output devices 214 may include one or more input interfaces, such as a keyboard device, an electronic mouse, an electronic stylus, a touch-sensitive screen, a camera (e.g., for capturing an input gesture), a microphone (e.g., for capturing audio input), and/or any other type of input interface. Input and output devices 214 may include one or more output interfaces, such as an electronic screen, a speaker, a haptic output device, and/or any other type of output interface. Computing device 200 may also include a display 212, such as a touchscreen display or other display types discussed herein.

FIG. 2B is a block diagram of a computing architecture 250 that may be used in connection with various disclosed embodiments, such as SaaS platform 100 shown in FIG. 1. The computing device 200, as described in connection with FIG. 2A, may be coupled to network 252. The network 252 may enable communication between different elements that may be communicatively coupled with the computing device 200, as further described below. The network 252 may include the Internet, the world-wide-web (WWW), a local area network (LAN), a wide area network (WAN), a metro area network (MAN), and other networks capable of enabling communication between the elements of the computing architecture 250. In some disclosed embodiments, the computing device 200 may be a server deployed in a cloud computing environment.

One or more user devices 254-1 through user device 254-m, where ‘m’ in an integer equal to or greater than 1, referred to individually as user device 254 and collectively as user devices 254, may be communicatively coupled with the computing device 200 via the network 252. A user device 254 may be for example, a smart phone, a mobile phone, a laptop, a tablet computer, a wearable computing device, a personal computer (PC), a smart television and the like. A user device 254 may be configured to send to and receive from the computing device 200 data and/or metadata associated with a variety of elements associated with single data type column-oriented data structures, such as columns, rows, cells, schemas, and the like. Furthermore, external third-party application providers such as an AI agent provider 260 may be communicatively coupled with the computing device 200 via the network 254.

One or more data repositories 256-1 through data repository 256-n, where ‘n’ in an integer equal to or greater than 1, referred to individually as data repository 256 and collectively as data repository 256, may be communicatively coupled with the computing device 200 via the network 252, or embedded within the computing device 200. Each data repository 256 may be communicatively connected to the network 252 through one or more database management services (DBMS) 258-1 through DBMS 258-n. The data repository 256 may be for example, a storage device containing a database, a data warehouse, and the like, that may be used for storing data structures, data items, metadata, or any information, as further described below. In some embodiments, one or more of the repositories may be distributed over several physical storage devices, e.g., in a cloud-based computing environment. Any storage device may be a network accessible storage device, or a component of the computing device 200.

Aspects of this disclosure may include storing a customized template in a repository. A customized template, as used herein, may refer to a group of one or more building blocks that may be combined to form one or more specific structures. The building blocks may include columns, rows, tables, communication components, charts, texts, images, workspaces, board views, dashboards, widgets, actions, triggers, listeners, authentications or any other user interface elements that can accept user input or output information. Actions, for example, may generate duplications, generate assignments, archive, or any other action. In some embodiments, actions may be triggered when a condition is met, such as when a date passes or when something is assigned. A structure may take the form of an entire board, a dashboard, a table, a column, or any other combinations of one or more building blocks. The structures may also include other visible aspects such as a table cell, a table border line, a table header, or any table elements. For example, a customized template may include a table having horizontal and vertical rows (e.g., rows and columns), a single column, a combination of columns, an entire board, a dashboard, a widget, or any combination thereof. Various rows or columns of the table may be defined to represent different projects, tasks, objects or other items, as well as characteristics of such items. For example, a horizontal row may represent an item and a vertical row may represent a status (a characteristic associated with the item.). In some embodiments, the items in the table may be unifying rows or columns that represent projects, tasks, property, people, or any object, action, or group of actions that may be tracked.

In further examples, a customized template may include one or more structures for specific applications such as marketing, content production, project management, sales & customer management, freelancing, design, software development, human resources management, manufacturing, office operations, startup planning, education, real estate, venture capital, or any other category of activities that involve tracking of different metrics and tasks.

As a simple example, a customized template may be a single column. A single column may indicate any information specified by the user or system, including but not limited to, task status, name, email, position, task, performance metric, or any static or dynamic information indicating an aspect of a task. The single column may include at least one cell and may be contained within a table. The template may further include a column title and labels that may be used to populate the cells under the column (e.g., done, waiting, in progress, completed).

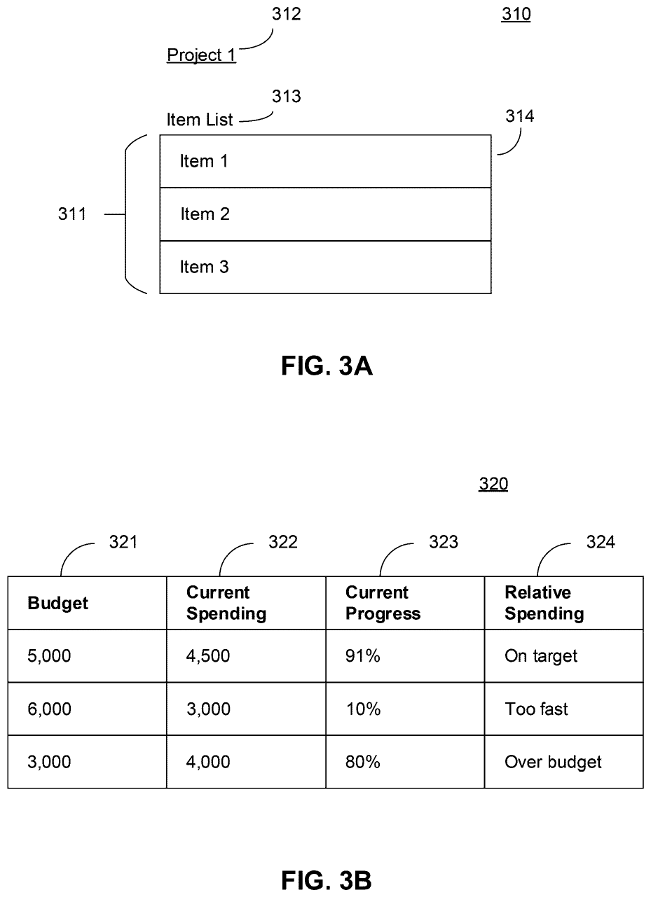

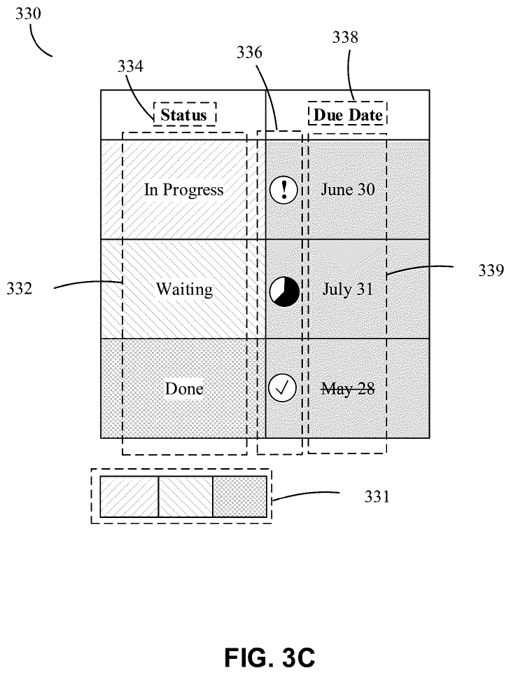

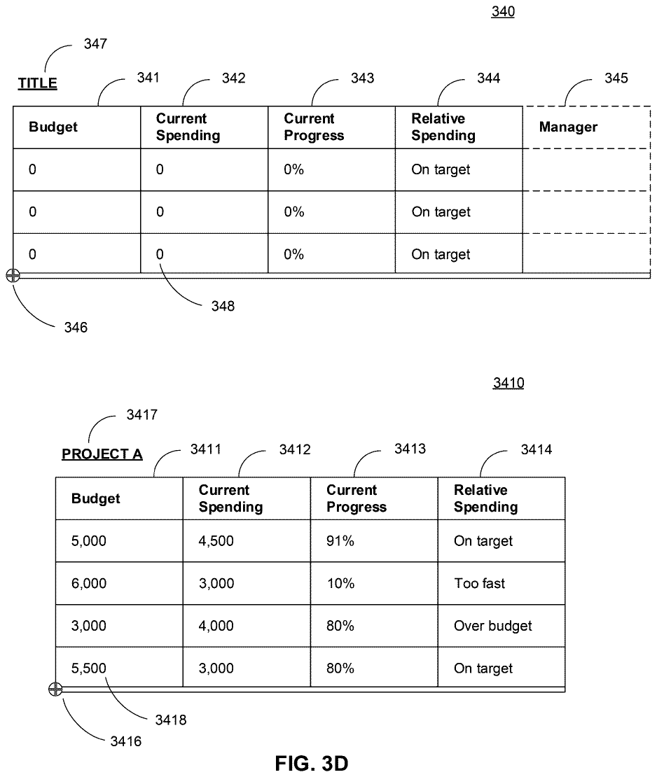

By way of non-limiting example, FIG. 3A illustrates one example of a customized template 310 including a single column 311. The basic customized template 310 may also include a template title 312 and a table or column title 313. In some embodiments, the single column 311 may include one or more rows of cells 314, each of which may include any combination of a number, text, symbol, mark, character, date, time, icon, avatar, hyperlink, picture, video, animation, or any other visible information.

In some embodiments, a customized template may include a plurality of columns with linkages between at least two of the plurality of columns. Each of the plurality of columns may indicate any information specified by the user or system similar to the single column described above. The combination of the plurality of columns may indicate a relationship between the cells of the row as described herein. The linkages (may be referred to as predefined logical combination rules, logical sentence structures, or automations herein) may refer to rules that associate at least two of a plurality of columns with each other. In some embodiments, the rules may include a mathematical function that determines the value of a column based on values of one or more columns (e.g., a column may be customized to display a due date determined by adding 50 days to the date indicated in another column). In other embodiments, the rules may include conditional functions that determine the appearance of a column based on the value of the column itself and/or the values of one or more other columns (e.g., a column may turn red when a due date specified therein has passed). In further embodiments, the rules may include computer-readable instructions that perform certain actions using third-party services (e.g., the template may control a smart light bulb when the value of a column meets a predetermined condition), change the appearances of one or more columns, and/or change the values of one or more columns (e.g., a column may be linked to another column to display the same information). Additional embodiments of linkages or rules are also possible as described herein.

For example, FIG. 3C illustrates an example embodiment of at least two columns that are linked to create additional information such as due dates. The columns may provide additional indicators of the status of an item such as changing color or presenting an indicator based on the current point in time relative to the due date. In some embodiments, the rules for linking columns may be configured by logical combination rules or automations as further described herein.

In further embodiments, aspects of this disclosure may also include storing rules that associate at least two customized templates together. The rules may include logical combination rules described herein or any other logical associations between cells, columns, rows, tables, dashboards, widgets, templates, and any other data structure. The rules may act on columns of more than one table, including tables of different users. For example, a first customized template may include a customized template for a Budget column and a second customized template may include a customized template for a Status column. A rule may include associating both the customized Budget column template and the customized Status column template to create a unique rule template that associates at least two customized templates. Other examples of rules are further described herein.

In some other embodiments, the customized templates may also include a plurality of columns and a display aggregation of the plurality of columns. A display aggregation may include displaying the plurality of columns together such as in a table, a board, a dashboard, a marketplace, or any visual display of the plurality of columns. Additionally or alternatively, the display aggregation may include more than one table, each displaying a subset of the plurality of columns. In some embodiments, the display aggregation may be configured for display on a user's device, such as a desktop, laptop, smartphone, tablet, smart watch, or any electronic device configured to present information.

By way of non-limiting example, FIG. 3B illustrates one example of a multi-column customized template 320 including a budget column 321, a current spending column 322, a current progress column 323, and a relative spending column 324. The budget column 321 may indicate predetermined budgets for different projects; the current spending column 322 may indicate the amounts currently spent for the corresponding project in the same row; the current progress column 323 may indicate the current progress for the corresponding project; and the relative spending column 324 may indicate how the current spending compares to the budget relative to the current progress. For example, the information in the first row may indicate that the current spending of $4,500 is on target because it roughly equates to the current progress of 91%. On the other hand, the information in the second row may indicate that the current spending of $3,000, although being only half of the budget, is too much because it exceeds the current progress of 10%. In this example, the columns 321 through 324 may be grouped by a linkage that may associate the relative spending column 324 to the budget column 321, the current spending column 322, and the current progress column 323. In some embodiments, one or more of the columns may also be associated with one or more columns of another customized template, where the current spending, for example, may be a sum of expenses recorded in the other customized template.

Turning back to storing the customized template in the repository, the repository may include any data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Data structures may be implemented via a storage device that may be used for storing electronic information. The repository may be collocated with the at least one processor or located in different locations as a remote database or a distributed database. The repository may also be accessible by other users through any computer network setup, such as a remote or cloud database, a server, a network-connected local memory, or any other networked database that can support multiple input and output accesses by a plurality of users.

Furthermore, the repository may serve as a network database or a marketplace, where the customized templates can be shared by original authors and other users. The repository may present a number of options for sharing the customized templates. A customized template may be shared via a repository associated with a marketplace or other sharing mechanism, where templates are available for selection and/or purchase. The templates may be shared with or without conditions, where, for example, a condition may be a payment for using the template. Other conditions may include restrictions on modification, where, for example, the users that receive the template may be restricted from modifying the template. The customized templates may be useful for maintaining uniformity across different users working towards the same goal, and the original author may lock portions of the template so that the users are not able to deviate substantially from the template. For example, a customized template may be locked so that users may not add or remove columns or modify rules that are configured for specific workflows.

In conventional systems, devices, or methods, the customized template may be hard-coded to a particular application, or the customized templates, integrated into a user-facing application, may operate independently of the original customized template. When the original author of the customized template needs to update the hard-coded customized template, such update may be complicated and may require many resources and steps to effectuate the update across all users that integrated the customized template.

In the disclosed embodiments, the customized templates may be freely updatable by the original author, where subsequent updates after the initial creation are automatically disseminated to the members who may have integrated the customized templates into their own user-facing applications, as enabled by the disclosed embodiments. In this way, when the original author makes updates to the customized template, the updates may be passed to every secondary user of the customized template, so that all the integrated templates may be reconfigured based on a single update by the original author. In other embodiments, automatic updates to the customized templates used by secondary users may be disabled on an individual level or partially enabled. In yet other embodiments, secondary users may view the update to the customized template and select parts or all of the update to apply to their own board.

By way of non-limiting example, FIG. 2A illustrates an example of memory 204 that may serve as a repository to store the customized template in a user device. The repository may be collocated with at least one processing circuitry 202 or located in different locations as a remote database or a distributed database as illustrated in FIG. 2B. The repository may also be accessible by other users through any computer network setup such as network 252, which may be a remote or cloud database, a server, a network-connected local memory, or any other networked database that can support multiple input and output accesses by a plurality of user devices 254-1 to 254-m.

Consistent with disclosed embodiments, at least one processor may be configured to integrate the customized template into user-facing applications. Once the customized template is stored in the repository and the user has met the criteria for accessing the customized template, a user may be enabled to integrate the customized template into his or her own user-facing application. As used herein, user-facing applications may refer to any computer application employed by a computer user. Customized templates may be associated by the user with the computer application so as to tailor or adapt the computer application to suit the user's needs. Such as adaptions may include adding, removing, or modifying placeholder values, linkages, rows, columns, or any other building blocks included in the customized template.

In some embodiments, the repository may be configured to allow access by only a subset of users that meet certain criteria such as payment for the access or membership, having sufficient authorization, or any other criteria that can be used as a condition for limiting access.

For example, once a customized template is stored in a repository in network 252 of FIG. 2B, a user of computing device 200 may download and integrate the customized template to the computing device 200 for their own user-facing application. In some embodiments the network 252 may require the user of computing device 200 to provide an authentication to authorize the download of the customized template from the network 252 or from the repository 256-1.

In some embodiments, integrating the customized template may refer to retrieving or accessing a copy of the customized template in a manner enabling the template to be used in conjunction with the user-facing application. Integrating may occur, for example by storing the customized template with the user-facing application so that the two can be used together, or linking the two to enable usage of the template with the computer application, regardless of the location of each.

According to some embodiments, integrating the template that may enable tailoring of data associated with the user-facing applications into which the template is integrated. The tailoring of data may refer to modifying the integrated customized template to suit the user's specific application (i.e., the user-facing application). More specifically, the user may modify the customized template by replacing any existing values stored in the customized template, adding more rows to the columns therein, removing a portion of the template that is not needed, or performing any other processes or activities that may manipulate the building blocks or the values of the building blocks in the customized templates. In other embodiments, integrating the customized template may occur simply by linking the customized template (as customized by the original template author) with a user-facing application. In such situations, the user-facing application when used with the customized template may function the same or substantially the same for all users of the combination.

In an example embodiment, the customized template may involve a table that has a plurality of columns, while the integrated customized template may include at least one column that is a subset of the plurality of columns of the customized template, or vice versa. In this way, a user may be enabled to select particular columns from a customized template for their own user-facing application. In some embodiments, the original author of the customized template may also place restrictions on the customized template at the time of creation, so that only some portions of the customized template may be restricted from being modified or removed, or some building blocks may be restricted from being added to the customized template. Such restrictions may be added or removed by the original author or any other authorized user in subsequent updates.

Consistent with the disclosed embodiments, integrating the customized template into the user-facing applications may generate a link between the customized template in the repository and the integrated customized template, so that future updates to the customized template may be disseminated to the integrated customized template. The link may be implemented, in some embodiments, as a record of user accounts that integrated the customized template or a record of unique template identifier for the integrated customized template.

By way of non-limiting example, FIG. 3D illustrates one example of a customized project management template 340 and an integrated project management template 390. The customized project management template 340 may include columns 39 through 344 that are similar to the budget column 321, the current spending column 322, the current progress column 323, and the relative spending column 324 of FIG. 3B described above. The customized project management template 340 may also include an optional column 313 that users may choose to use or remove in their integrated templates. If the user decides to not include optional column 313 to integrate to their user device, the user would subsequently download integrated project management template 390 without optional column 313 instead of the full customized project management template 340. Or, the user might simply disable the optional column 313. The number of rows shown in the customized project management template 340 is only exemplary, and the customized project management template 340 may also include a row insertion button 346 for adding more rows. In some embodiments, the customized project management template 340 may further include other placeholder values such as a generic title 315 and generic value 348.

The integrated project management template 390 may also have similar elements as the customized project management template 340, such as the columns 391 through 394 and the row insertion button 396. The integrated project management template 390 may also include a specific title 397 and specific values 398 that the user entered in order to integrate the template into his or her user-facing application. In some embodiments, however, the integrated project management template 390 may be restricted from adding more columns besides the optional column 313 or removing any of the columns 391 through 394. In further embodiments, the integrated project management template 390 may allow a user to modify the values or linkages in columns 391 through 393, but not necessarily in column 394. These are just a few examples of how an integrated customized template may allow tailoring of data. Any alteration, modification, or option selection associated with the customized template may be considered a tailoring of data, consistent with disclosed embodiments.

Aspects of this disclosure may also include updating the customized template. For example, an original author, a current template owner, persons authorized by the original author or current owner, or any other authorized user or other authorized individual may update the customized template by adding, modifying, or removing building blocks to and from the customized template. Updating the customized template may be substantially similar to creating the customized template in the first place except that updating the template begins with existing building blocks as opposed to adding building blocks from a clean slate. In some embodiments, updating the customized template may also involve adding, modifying, or removing rules that associate different building blocks with one another. Still further, updating the customized template may involve changing permissions so that users are able to modify different aspects of the template as they integrate the customized templates into their applications.

By way of non-limiting example, updating the customized template may include adding, removing, or modifying a linkage between a first column of the customized template and a second column of the customized template. This may occur by modifying a rule in the template. For example, a rule may be modified to change a color of a second column based on a value in the first column. Or a rule may add descriptive text to the second column based on information in the first column. There are an unlimited number of cause-effect functions that could be linked from column to column in accordance with disclosed embodiments. In another example, the update may include a display aggregation of the plurality of columns, such as altering the appearance of visible items (e.g., table border, font type, font size, layout, arrangement of the columns) of the customized template.

Once the original author or other authorized user has completed the update to the customized template, the updated customized template may be stored in the repository. In some embodiments, the data record previously associated with the customized template and stored in the repository above may be overwritten with a data record associated with the updated customized template. In other embodiments, a computing device may determine the difference between the existing data record and the updated data record and selectively overwrite the existing data record to reflect the differences. Furthermore, the computing device may store the updated customized template automatically at a predetermined interval, thereby preventing any loss of data due to unexpected crashes or the user's negligence in saving the changes periodically.

Turning to FIG. 3D for example, updating the customized project management template 340 may include adding or removing any number of rows or columns, changing the placeholder values or titles, or modifying any other aspect of the customized project management template 340 that could not be modified while integrating the customized project management template 340. These updates may occur via computing device 200 in FIG. 2A, which may update the customized template in a repository located in the computing device 200, in the network 252, remote repository 256-1, or any combination of data structures, regardless of where they are located.

Aspects of this disclosure may also include pushing the updated customized template to the user-facing applications in which the customized template was integrated. An address of every user who linked to or downloaded the customized template may be stored in a data structure, and the update may be pushed (e.g., sent) to those users. Alternatively, if the customized template is stored in a central location to which users link, when the user links to the customized template containing updates, the updates may be considered “pushed” to the user, even though the updates may ultimately reside in a remote location.

Pushing the update may include an automatic update to all user-facing applications that contain the customized template as soon as the update has been made. In some embodiments, pushing the updated customized template to the user-facing applications may occur within a predetermined time after storing the updated customized template in the repository. In other embodiments, pushing the update may include sending a notification to every user device associated with the customized template, informing the users that an update has been made and enabling selection via the user device of whether accept or reject the pushed update or reject the update. Such an acceptance or rejection may occur, for example, in response to an input by the user. If the user decides to reject the pushed update, the user device might not download the pushed update, or might manipulate a setting that prevents application of the update. Alternatively, if the user accepted the pushed update so that the user device integrated the updated customized template, the user may decide to revert to the previous version of the customized template prior to integrating the updated customized template. If the user device is not connected to the network or to the repository, the user device may receive the pushed update or the notification relating to the update as soon as the user device is connected to the network or to the repository. A record may be kept of all user devices that implement the pushed update into the integrated customized template.

In FIG. 2B, the computing device 200 may push the data record of the updated customized template to user devices 254 that have integrated the previous version of the customized template. Under this push communication scheme, changes to the customized template may be disseminated to the user device 254 in real-time or near real-time as the original author or other authorized person stores the updated customized template. In alternative embodiments, the computing device may transmit the updated customized template to user device 254 upon a request from the user device 254 under a pull communication scheme as opposed to the push communication scheme.

In FIG. 2B, the computing device 200 may keep a record of the user devices 254 that integrated the customized template by, for example, recording identifying information of the user devices 254 as each user device 254 integrates the customized template. The identifying information may include the IP address, MAC address, the user ID associated with the user device 254, or any other comparable information that can be used to identify a particular user account, a user device 254, or a board that previously integrated the customized template.

In some embodiments, individual user device 254 may choose to reject or postpone the updated customized template from updating the integrated customized template associated with the user device 254. More specifically, the user device 254 may be configured to accept a user input in response to the pushed update, where the user device 254 may reject the updated customized template in response to an input. Any rejected update may be pushed to the user device 254 at another time in the future, where the user device 254 may choose to reject or postpone the pushed update again.

Aspects of this disclosure may also include enabling, via the pushed update, a simultaneous change in tailoring of data within each of the user-facing applications in which the customized template was previously integrated. The changes may involve updating the previously integrated customized templates to adopt the updated customized templates. The changes may also involve altering the data values within the previously integrated customized template to match the structure and format of the updated customized template. The change in tailoring of the data may involve any alteration in which data is displayed, presented, or manipulated as a result of the update. The change may be simultaneous in that multiple users may receive the update at or about the same time. Of course, if some users are disconnected from a network, the update might not immediately take effect, although such users would still be said to be enabled to simultaneously change the tailoring of their data.

In some embodiments, the simultaneous change in tailoring of data may include a recalculation of data within each of the user-facing applications in which the customized template was previously integrated. Any change in the updated customized template may trigger the integrated customized templates to recalculate the data stored therein, thus ensuring that the data stored in the integrated customized templates are consistent with the rules specified by the updated customized template.

In further embodiments, the tailoring of data may result in a display of the updated customized template. For example, upon update, a new or modified presentation may appear on a user device, presenting data in a new or modified way. If the user had previously accessed the integrated customized template on a user device, the manipulation of data may prompt the user device to display the updated customized template so that the user may continue accessing the integrated customized template in the updated form. Additionally or alternatively, this display of the updated customized template may allow the user using the user device that received the updated customized template to review any changes that may be in order and accept or reject the changes as desired.

By way of non-limiting example, in FIG. 2B, the computing device 200 may achieve the simultaneous change across multiple user devices 254 using the push communication scheme, where the updated customized templates may be pushed to each user device 254 upon any changes to the customized template. More specifically, any changes to the customized template may be stored in the repository (located in the computing device 200, network 252, or remote repository 256-1) automatically in real time or at a predetermined interval after the change is made, which may keep the integrated customized templates in sync with the customized template at all times in real-time or near real-time. For example in FIG. 3D, if the change to original customized template 340 includes providing additional data values for column 344, such as “Too fast” or “Over budget,” the update could result in a simultaneous change in the updated customized template 390 to tailor the data values as shown in column 394 to include the data entries of “Too fast” and “Over budget.” In another example, if the change to the original customized template 340 included removing column 313, the updated customized template would then also remove the column in any user device containing the original customized template 340 to result in the updated customized template 390. In yet another example, any changes to the original customized template 340 may result in displaying the updated customized template 390 on a user device 254 containing the customized template so that the user may see a preview of the updated customized template and how it may alter or tailor the user's data or current customized template. In this way, the user may decide whether to accept or reject the updated customized template based on the preview.

In some embodiments, the tailoring of data may also result in a display of an authentication input field to each of the user-facing applications. An authentication input field may include a field that enables a user to enter authentication credentials. The display of the authentication input field may be presented in response to a pushed update or may be presented when a user device attempts to access the updated customized template. Consistent with disclosed embodiments, at least one processor may be further configured to identify an authentication for the authentication input field, which may include enabling a user input of credentials into the authentication input field, thereby allowing the user to input authentication data before being able to accept or reject the pushed update. In some embodiments, the authentication data may include a combination of a user ID and a password, a personal identification number (PIN), a payment key, a hardware key, an RFID input, or any other information that can uniquely identify a particular user. The authentication data may be given to a user as a result of payment or any other verification process to give the user access to future updates to the customized template.

In some embodiments, the at least one processor may be configured to compare the identified authentication with predefined authentication inputs contained in the repository to determine whether the identified authentication corresponds to a predefined authentication input contained in the repository. For example, the predefined authentication inputs in the repository may be based on users who may be verified subscribers to the customized template. The verified subscribers may be based on account creation or payment in exchange of the authentication data so that the verified subscribers have access to all pushed updates while non-verified users may be excluded from all pushed updates.

For example in FIG. 2B, the predefined authentication inputs may be stored in a repository in an encrypted state, where a user device 254 and/or the computing device 200 may be required to use hash functions to compare the user input with the predefined authentication inputs. The encryptions may involve, for example, using pseudo-random encryption keys of different lengths (e.g., 128-, 256-, 1024-, 2048-bit, or any longer bit length keys) and algorithms such as advanced encryption standard (AES), transport layer security (TLS), secure socket layer (SSL), or any other standard encryption algorithms. In an exemplary scenario, an owner of a customized template may store the customized template in a repository located on the owner's computing device 200 or in a remote repository 256-1. In order for other user devices 254 to access the customized template, they may receive authentication data from the owner, in order to access the customized template. The authentication data may be unique to the user device 254 that receives the authentication data so that other user devices cannot access the customized template.

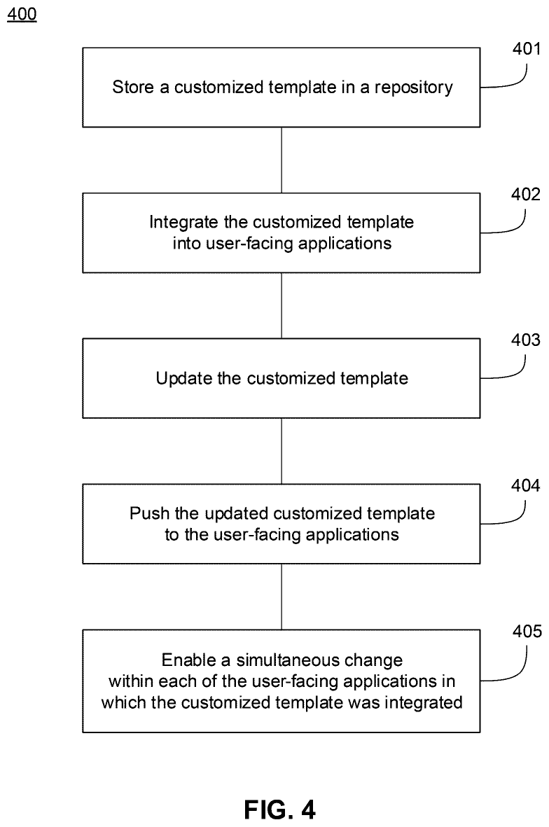

FIG. 4 illustrates a flowchart of an exemplary computerized process 400 for automatically applying changed templates across user-facing applications that may be performed by the various disclosed embodiments. The computerized process 400 may be performed by the computing device 200 and/or any of the user devices 254, where the updates are pushed to the other user devices 254. In some embodiments, the computerized process 400 may include the following operations.

Block 401: Storing a customized template in a repository. In some embodiments, a first user (e.g. an author) may create and store a customized template using a computing device 200 or any of the user devices 254 (e.g., user device 254-1). The customized template may be stored in any of data repositories 256.

Block 402: Integrating the customized template into user-facing applications. Once the customized template is stored in data repository 256, a second user may access the data repository 256 using another one of the user devices 254 (e.g., user device 254-2), thereby allowing the computing device 200 to integrate the customized template into a user-facing application specific for that user.

Block 403: Updating the customized template. In some embodiments, the first user may use the computing device 200 or the user device 254-1 to update the customized template in a manner consistent with the disclosed embodiments.

Block 404: Pushing the updated customized template to the user-facing applications. The updates to the customized template made above at step 403 may then be pushed to the second user's user-facing application. In some embodiments, the updates may be pushed to the user device 254-2 or any other user device associated with the second user.

Block 405: Enabling a simultaneous change within each of the user-facing applications in which the customized template was integrated. Once the updated customized templates are pushed to individual user-facing applications, the respective user-facing applications may simultaneously be changed to adopt the update, so that the updates made to the customized template at step 403 are simultaneously applied to the integrated customized templates.

Aspects of this disclosure may provide a technical solution to the challenging technical problem of project management and may relate to a system for automating tablature with the system having at least one processor (e.g., processor, processing circuit, or other processing structure described herein) in collaborative work systems, including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable mediums, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

Tablature as used herein refers to any organized manner of displaying information in two dimensions, three dimensions, or more. A table having horizontal and vertical rows (e.g., rows and columns) may be one example of two-dimensional tablature. Tablature presented in greater than two dimensions may be simulated on a two-dimensional display or may be presented holographically or through virtual glasses or other virtual displays. Altering tablature displays, as used herein, may refer to any procedure or process of changing a visual presentation form of a display of a table in a collaborative work system. The procedures or processes for altering the tablature displays may involve, for example, any combination of modification, addition, or removal operated on a color, a font, a typeface, a shape, a size, a column-row arrangement, or any visual effect of a visible object in the table. The visible object may include a table cell, a table border line, a table header, or any table elements, and may further include a number, a text, a symbol, a mark, a character, a date, a time, an icon, an avatar, a hyperlink, a picture, a video, an animation, or any visible item included in any table element.

By way of one example, the collaborative work system may utilize workflow management software that enables members of a team to cooperate via a common online platform (e.g., a website). Aspects of this disclosure may display a table with items on a screen of a computing device. A table may be presented, for example, via a display screen associated with a computing device such as a PC, laptop, tablet, projector, cell phone, or personal wearable device. A table may also be presented virtually through AR or VR glasses, or through a holographic display. Other mechanism of presenting may also be used to enable a user to visually comprehend presented information. Aspects of this disclosure may enable a user (e.g., an individual operating the computing device) to maintain a plurality of logical templates, enable formation of a table, enable selection of a logical template, enable input for user-definable requirements into the selected logical template, enable association of the selected logical template with a row, and execute logic operations defined by the selected logical template to operate on the row in response to the association of the selected logical template with the row.

Consistent with disclosed embodiments, at least one processor of the system may carry out operations that may involve maintaining a plurality of logical templates, each logical template of the plurality of logical templates including predefined requirements and user-definable requirements. A logical template (or referred to as a “recipe”) as used herein may include a logical organization of elements for implementing a conditional action. In some embodiments, the logical organization of elements may be a semantic statement or a rule (e.g., a sentence). An instance of the logical template may be referred to as an “automation” herein.

In some embodiments, the logical template may be implemented as program codes or instructions stored in a non-transitory computer-readable medium of the system. The at least one processor of the system may execute the program codes or instructions to perform the conditional action in accordance with the logical template. Maintaining the plurality of logical templates, as used herein, may refer to any means for the system to store (or store a link to) the plurality of logical templates. For example, the system may store the plurality of logical templates in the non-transitory computer-readable medium. By way of non-limiting example, the system may maintain the plurality of logical templates by storing them in the memory 204 in FIG. 2A, the storage 208 in FIG. 2A, or both.

In some embodiments, the logical template may be displayed in a user interface. The user interface as used herein may be a web page, a mobile-application interface, a software interface, or any graphical interface that enables interactions between a human and a machine via the interactive element. The user interface may include, for example, a webpage element that overlays an underlying webpage. In some embodiments, a computing device that implements the operations may provide the user interface that includes an interactive element. The interactive element as used herein may be a mouse cursor, a touchable area (as on a touchscreen), an application program interface (API) that receives a keyboard input, or any hardware or software component that may receive user inputs.

By way of non-limiting example, the computing device (e.g., the computing device 200 in FIG. 2A) may provide the user interface (e.g., a web page or a column store) to a user device (e.g., any of the user device 254-1, 254-2, or 254-m in FIG. 2B) over a network (e.g., the network 250 in FIG. 2B).

A logical template may include one or more triggering elements (referred to as “triggers” hereinafter) and one or more action elements (referred to as “actions” hereinafter). A trigger of the logical template, as used here, may refer to an event or a condition, the occurrence or satisfaction of which may cause another event in the system that implements the logical template. An action of a logical template as used herein may refer to a change of one or more components of the system. For example, the change may include adding, deleting, altering, converting, or any manner of manipulating data stored in the system.

In some embodiments, the at least one processor of the system may maintain one or more of the plurality of logical templates as predetermined, unconfigurable logical templates, in which the system may only select or deselect those logical templates as a whole but cannot alter any element thereof. In some embodiments, the at least one processor of the system may maintain one or more of the plurality of logical templates as configurable logical templates, in which the system may enable the user not only to select or deselect, but also to configure one or more elements thereof. For example, the system may enable the user to configure a maintained logical template in a dynamic manner that will be detailed in later description of this disclosure, in which the user may create a new logical template that might not preexist in the system. In some embodiments, the system may enable the user to store the configured logical template in the system for future configurations or uses.

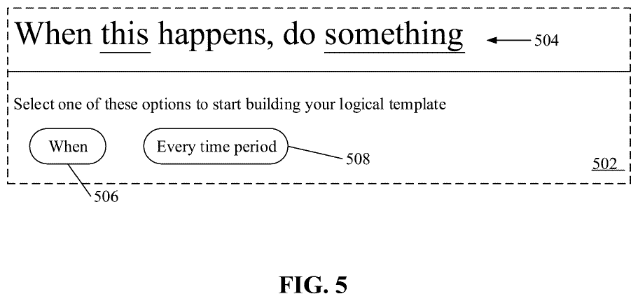

By way of non-limiting example, FIG. 5 illustrates an example of a logical template 504 displayed in a user interface 502, consistent with embodiments of the present disclosure. As illustrated in FIG. 5, the user interface 502 is represented as a dash-line box that does not represent its boundary. In some embodiments, the user interface 502 may be displayed using a computing device (e.g., the computing device 200 illustrated in FIG. 2A) or software running thereon. For example, the user interface 502 may be a portion of a graphical user interface (GUI), such as a webpage or a mobile application GUI displayed on a screen of the computing device 200.

As illustrated in FIG. 5, the user interface 502 displays the logical template 504 (“When this happens, do something”) as a whole or a partial sentence. The logical template 504 may include a trigger “when this happens” and an action “do something.” In accordance with the logical template 504, when the condition “this” is satisfied or the event “this” occurs, the system may cause “something” to occur (i.e., a change of a component of the system).

A logical template may include one or more predefined requirements and one or more user-definable requirements. A requirement of the logical template as used herein may include an element that limits the logical template. The element may be of any datatype. In some embodiments, the requirement may have a default value. A predefined requirement may be a requirement that cannot be configured or altered, and may only be activated or deactivated as a whole. In some embodiments, if the logical template is a conditional statement, the predefined requirement may include a verb-like, a preposition-like, or conjunction-like element. A user-definable requirement may be a requirement that may be configured or altered based on a user input. The user-definable requirement may be activated or deactivated as a whole, or may be activated with configuration or alternation in accordance with user inputs.

By way of non-limiting example, in FIG. 5, the logical template 504 includes predefined requirements “when,” “happens,” and “do,” and user-definable requirements “this” and “something.” For example, the predefined requirement “when” may only be activated as a whole by receiving a user input indicating that a user selects an interactive element 506 (e.g., a button). In another example, the predefined requirement “when” may only be deactivated as a whole by receiving a user input indicating that a user clicks an interactive element 508 (e.g., a button) so that the predefined requirement may be removed and may be replaced.

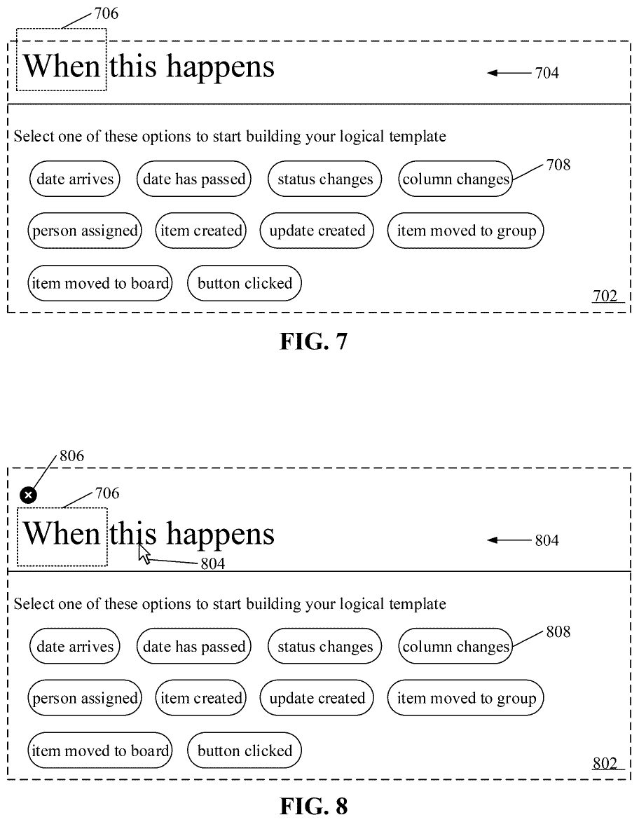

By way of non-limiting example, FIG. 7 illustrates an example of a logical template 708 showing a predefined requirement 706 in a user interface 702, consistent with embodiments of the present disclosure. In some embodiments, the system may display the user interface 702 after receiving data indicating that the interactive element 506 of the user interface 502 of FIG. 5 is activated (e.g., selected by a user). The user interface 702 displays the logical template 708 (“when this happens”) that may include the predefined requirement 706 (“when”). As illustrated in FIGS. 5 and 7, through interaction with the interactive element 506, the predefined requirement 706 may be activated, as a whole, by invoking the display of the user interface 702, in which the predefined requirement 706 cannot be configured or altered by any user input.

By way of non-limiting example, FIG. 8 illustrates another example of the logical template 708 showing the predefined requirement 706 in a user interface 802, consistent with embodiments of the present disclosure. In some embodiments, the system may display the user interface 802 after receiving data indicating that a cursor 804 is hovering over (e.g., as a result of a user operation) or has clicked on the logical template 708 (e.g., over the predefined requirement 706) in the user interface 708 of FIG. 7. The user interface 802 may include an interactive element 806 above the predefined requirement 706. For example, the interactive element 806 may be a clickable button floating above the predefined requirement 706. If the user clicks the interactive element 806, the predefined requirement 706 may be deactivated, as a whole, by invoking the display of the user interface 502 in FIG. 5, in which the predefined requirement 706 cannot be configured or altered by any user input.

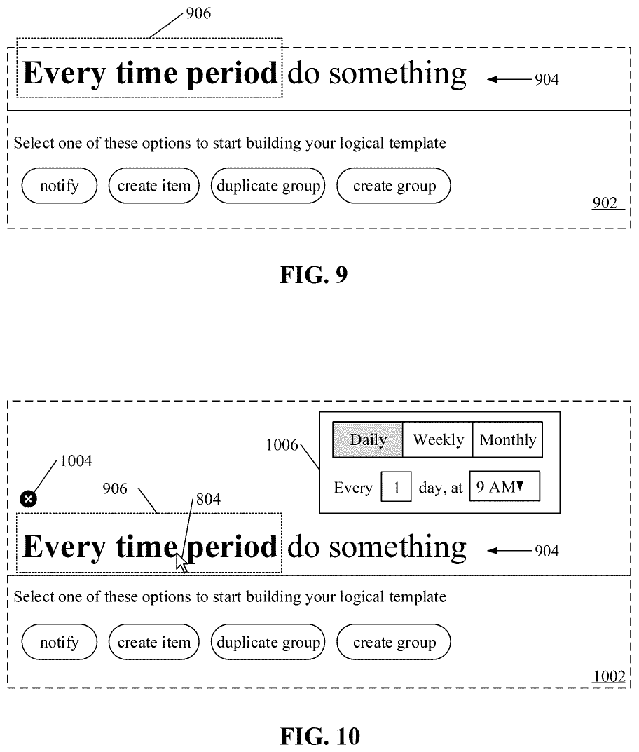

The activation, deactivation, and configuration of the user-definable requirements “this” and “something” will be detailed in association with FIGS. 9 to 12.

Consistent with disclosed embodiments, the at least one processor of the system may carry out operations that may involve enabling formation of a table having a plurality of horizontal and vertical rows. A table as used herein includes the those items described earlier in connection with the tablature, and may include a form, a sheet, a grid, a list, or any data presentation in horizontal and vertical dimensions (e.g., horizontal rows and vertical columns, horizontal rows and vertical rows, or horizonal columns and vertical columns). The table may be presented on a screen of a computing device (e.g., a personal computer, a tablet computer, a smartphone, or any electronic device having a screen).

In some embodiments, the system may store the table as data in a non-transitory computer-readable medium. The at least one processor of the system may access the table from the non-transitory computer-readable medium and perform operations to the table. Formation of the table as used herein may refer to any process, procedure, or manner for the system to build up the table. For example, the system may receive data from user inputs or from other components of the system and organize them into the plurality of horizontal and vertical rows to form the table. By way of non-limiting example, the system may form the table and store it in the memory 204 in FIG. 2A, the storage 208 in FIG. 2B, or both.

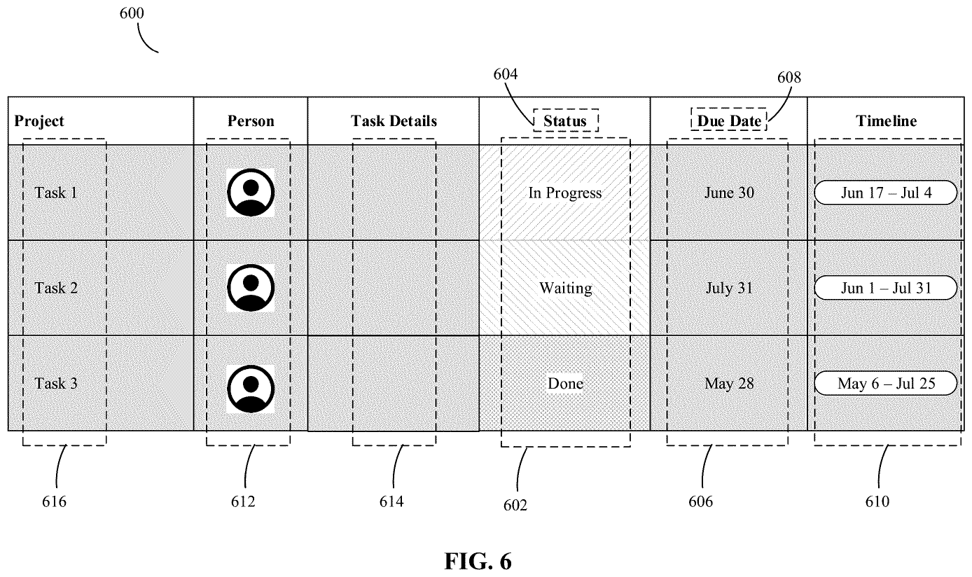

By way of non-limiting example, FIG. 6 illustrates an example of a table 600 that may include multiple columns, consistent with embodiments of the present disclosure. In some embodiments, the table 600 may be displayed using a computing device (e.g., the computing device 200 illustrated in FIG. 2A) or software running thereon. The table 600 may be associated with a project to display and may include, in the multiple rows and columns, tasks (e.g., in rows including “Task 1,” Task 2,” or “Task 3”) included in the project, persons (e.g., in a column 612) assigned to the tasks, details (e.g., in a column 614) of the tasks, statuses (e.g., in a column 602) of the tasks, due dates (e.g., in a column 606) of the tasks, timelines (e.g., in a column 610) of the tasks, or any information, characteristic, or associated entity of the project.

Any column of the table may display cells of a single datatype or of multiple datatypes. A single datatype column may be one where all cells are uniform in at least one aspect or characteristic. The characteristic may be numeric values only, characters only, alphanumeric values, graphic elements only, closed lists of elements, formatting, a specific value range, or any constraint on the format or type of column data. In some embodiments, the first column may be at least a portion of a single datatype (e.g., texts) column-oriented data structure. A single datatype column-oriented data structure may be a digital data structure of a table that includes columns where all cells of the columns may be programmed to include a single category of data.

In FIG. 6, the table 600 includes a first column 602 that has a first column heading 604 (“Status”) and a second column 606 that has a second column heading 608 (“Due Date”). A column heading may be associated with a column within a table. The column heading may be a default text or may be customized by a user. For example, a first column 602 may be a status column type of table 600. Other columns with other characteristics in FIG. 6 may include a due date column type (including a second column 606), a timeline column type (including the column 610), a person column type (including the column 612), and text column types such as the columns 614 and 616.

In FIG. 6, a first column 602 includes three rows, each row including one or more words indicative of a status of each task of the project. A second column 606 includes three rows, each row including a date indicative of a due date of each task of the project. In some embodiments, the computing device that implements the method may enable the user to select the second column heading in the table or through a user interface such as a column store in a manner similar to that of enabling the user to select the first column heading in the table as described above.

Consistent with disclosed embodiments, the at least one processor of the system may carry out operations that may involve enabling selection of a logical template. In some embodiments, the logical template may be one of the plurality logical templates maintained by the system. In some embodiments, the system may enable forming the logical template dynamically and selecting the same.

By way of non-limiting example, with reference to FIGS. 5 and 6, the system may enable selection of the logical template 504 by providing an interactive element (not shown in FIGS. 5 and 6) associated with the table 600 such that when a user interacts with the interactive element, the logical template 504 may be selected. For example, the interactive element may be a button or a menu on a webpage that displays the table 600. When the user clicks or interacts with the button or the menu, the webpage may display the user interface 502 for enabling the user to select the logical template 504.

Consistent with disclosed embodiments, the at least one processor of the system may carry out operations that may involve enabling input for the user-definable requirements into the selected logical template. An input for a user-definable requirement, as used herein, may refer to any data, information, or indication to be used for configuring the user-definable requirement.

By way of non-limiting example, FIG. 9 illustrates an example of a logical template 904 showing a user-definable requirement 906 in a user interface 902, consistent with embodiments of the present disclosure. In FIG. 9, the user-definable requirement 906 may be displayed in bold, underlining, or any other differentiating manner, representing that it is user-definable. In some embodiments, the system may display the user interface 902 after receiving data indicating that the interactive element 508 of the user interface 502 in FIG. 5 is activated (e.g., selected by a user). The user interface 902 displays the logical template 904 (“every time period do something”) that includes the user-definable requirement 906 (“every time period”). As illustrated in FIGS. 5 and 9, through interaction with the interactive element 508, the user-definable requirement 906 may be activated, as a whole, and invoke the display of the user interface 902.

By way of non-limiting example, FIG. 10 illustrates another example of the logical template 904 showing the user-definable requirement 906 in a user interface 1002, consistent with embodiments of the present disclosure. In some embodiments, the system may display the user interface 1002 after receiving data indicating that the cursor 804 is hovering over (e.g., as a result of a user operation) or having clicked on the logical template 904 (e.g., over the user-definable requirement 906) in the user interface 904 of FIG. 9. The user interface 1002 may include an interactive element 1004 above the user-definable requirement 906, but may generally be located adjacent the user-definable requirement 906. For example, the interactive element 1004 may be a clickable button floating above the user-definable requirement 906. If the user clicks the interactive element 1004, the user-definable requirement 906 may be deactivated, as a whole, by invoking the display of the user interface 502 in FIG. 5.

As illustrated in FIG. 10, if the user clicks the interactive element 1004, the user interface 1002 may further display an interactive element 1006 (e.g., a pop-up GUI element) for receiving user inputs to configure the user-definable requirement 906. The interactive element 1006 may provide buttons, text input boxes, drop-down menus, or any combination thereof, for receiving user inputs. For example, in FIG. 10, a user may select a button “daily” (represented as a shaded box), input “1” in a text input box, and select “9 AM” in a drop-down menu, to configure the user-definable requirement 906 as “every 1 day at 9 AM.” In another example, the user may input other data in the interactive element 1006 to configure the user-definable requirement 906 as every N days (N being an integer) at any time, every N weeks at any time on any day of week, or every N months at any time on any date of month.

In some embodiments, the user-definable requirements of the selected logical template may be dynamic such that input of at least one user-definable requirement is configured to cause a change in the logical template. A dynamic user-definable requirement of a logical template as used herein may include a user-definable requirement, that when altered, can cause a change in the logical template. A change of the logical template as used herein may refer to a change in structure or elements (e.g., triggers and actions, or predefined requirements and user-definable requirements).

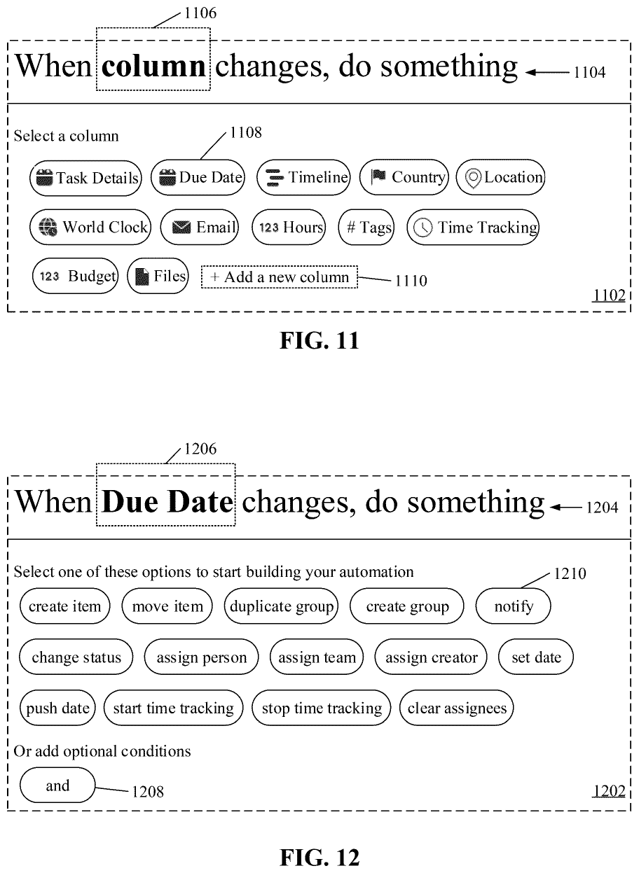

By way of non-limiting example, FIG. 11 illustrates an example of a logical template 1104 showing a dynamic user-definable requirement 1106 in a user interface 1102, consistent with embodiments of the present disclosure. In FIG. 11, the dynamic user-definable requirement 1106 may be displayed in bold or in any other differentiating manner, representing that it is user-definable. Referring back to FIGS. 7 and 8, the user interfaces 702 and 802 display multiple interactive elements (e.g., buttons) below the logical template 708, including an interactive element 708 (“column changes”). For example, the system may retrieve the multiple interactive elements from a repository (e.g., any of data repositories 256-1 through 256-n) and display them in the user interface 702 in FIG. 7 or the user interface 802 in FIG. 8. In some embodiments, the system may select the logical template 1104 and display it in the user interface 1102 as illustrated in FIG. 11 after receiving data indicating that the user selected the interactive element 708 in the user interface 702 or the user interface 802. The user interface 1102 may display the logical template 1104 (“when column changes, do something”) that may include the dynamic user-definable requirement 1106 (“column”).

As illustrated in FIG. 11, the user interface 1102 further displays multiple interactive elements (e.g., buttons) for receiving user inputs to configure the dynamic user-definable requirement 1106, including an interactive element 1108 (“Due Date”). For example, the system may retrieve the multiple interactive elements from a repository (e.g., any of data repositories 256-1 through 256-n) and display them in the user interface 1102. If the system receives an input (e.g., a clicking or tapping of a user) for any of the multiple interactive elements, the system may cause a change in the logical template 1104. For example, if the system receives data indicating that the interactive element 1108 is selected, the system may change the logical template 1104 and display it in another user interface described as follows.

FIG. 12 illustrates an example of a logical template 1204 showing a dynamic user-definable requirement 1206 in a user interface 1202, consistent with embodiments of the present disclosure. In FIG. 12, the dynamic user-definable requirement 1206 are display in bold, representing that it is user-definable. In some embodiments, the system may change the logical template 1104 to the logical template 1204 and display the logical template 1204 in the user interface 1202 after receiving data indicating that the user selects the interactive element 1108 in the user interface 1102. Further, the system may also change the multiple interactive elements associated with the dynamic user-definable requirement 1106, as illustrated in FIG. 11, to multiple interactive elements (e.g., buttons) associated with the action “do something” of the dynamic user-definable requirement 1206, as illustrated in FIG. 12, which are displayed under the dynamic user-definable requirement 1206.

In some embodiments, if the user interface displays multiple interactive elements (e.g., buttons) for receiving user inputs to configure the dynamic user-definable requirement, the user interface may further include an interactive element (e.g., a button or a hyperlink) for adding additional interactive elements other than those displayed. For example, after receiving data indicating that a user selects such an interactive element, the system may display (e.g., in a popup window, a drop-down menu, a new webpage, or any GUI element) options for the user to select the additional interactive elements other than those displayed for configuring the dynamic user-definable requirement.

The additional interactive elements may be of any datatype (e.g., a date, a person, a number, a timeline, a text, a status), in any form (e.g., a checkbox, a link, a clock, an address, a menu, a button, a file, a tag), for any purpose (e.g., for voting, rating, time tracking, calling a phone number, sending an email). In some embodiment, the system may provide the additional interactive elements in combinations, such as a date plus a status, or a timeline plus a status. In some embodiments, the system may acquire (e.g., via an API) the additional interactive elements from an external service provider (e.g., an external email server, an external instant message server, or an external map server) and provide it for the user to select, such as via a “marketplace” user interface.

By way of non-limiting example with reference to FIG. 11, the user interface 1102 includes an interactive element 1110 (“add a new column”) for adding additional interactive elements other than those displayed.

In some embodiments, the change in the logical template may include a presentation of at least one option for an additional user-definable requirement. For example, the presentation of the at least one option may include displaying the at least one option in a user interface. If a user selects the at least one option displayed in the user interface, the system may enable adding an additional user-definable requirement to the selected logical template.

By way of non-limiting example, with reference to FIG. 12, after changing the logical template 1104 to the logical template 1204, the system may present (e.g., display) an option for adding an additional user-definable requirement in the user interface 1202 as an interactive element 1208 (“add”). For example, if the user selects the interactive element 1208, the system may directly add the additional user-definable requirement (e.g., “status”) to the logical template 1204 such that changing “when due date changes, do something” to “when due date and status changes, do something” (not shown in FIG. 12).

In some embodiments, a change in the logical template may include a presentation of at least one additional predefined requirement. For example, the change in the logical template may include a change in its logic structure that may add the additional predefined requirement (e.g., a verb-like, proposition-like, or conjunction-like element) to the logical template.

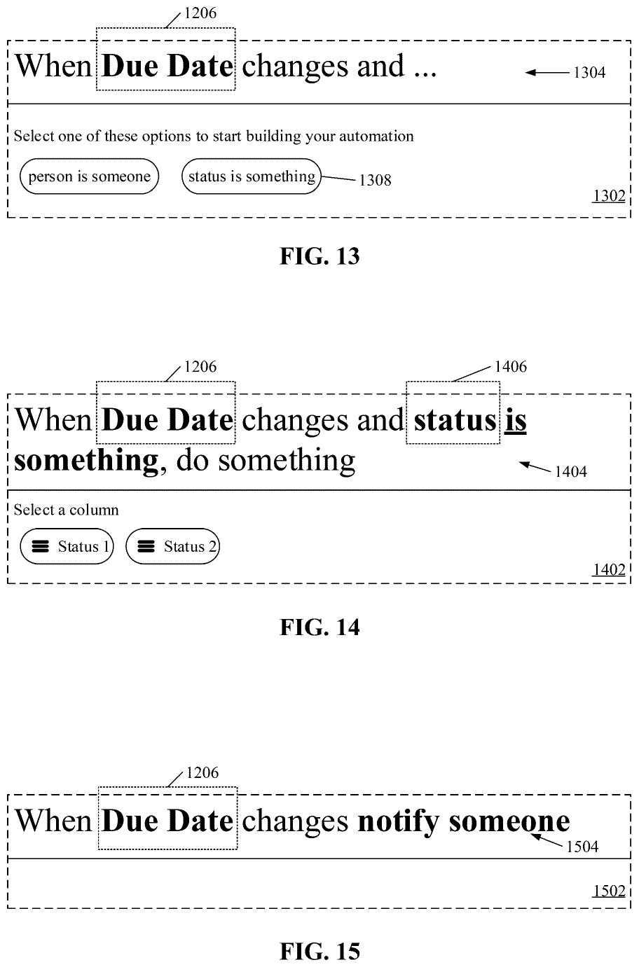

FIG. 13 illustrates an example of a logical template 1304 showing a dynamic user-definable requirement 1206 in a user interface 1302, consistent with embodiments of the present disclosure. In some embodiments, the system may display the logical template 1304 in the user interface 1302 after receiving data indicating that the user selects the interactive element 1208 in the user interface 1202. As illustrated in FIG. 13, the system presents (e.g., displays) an additional predefined requirement “and” (and no longer displays “do”) in the logical template 1304, compared with the logical template 1204 in FIG. 12.

In some embodiments, if the change in the logical template includes a presentation of the at least one first additional predefined requirement, the change in the logical template may further include a presentation of at least one option for an additional user-definable requirement. For example, the presentation of the at least one option may include displaying the at least one option in a user interface. If a user selects the at least one option displayed in the user interface, the system may enable adding an additional user-definable requirement to the selected logical template.

In some embodiments, the change in the logical template may further include a presentation of at least one second additional predefined requirement. For example, if a user selects the at least one option displayed in the user interface, the system may enable adding a second additional predefined requirement to the logical template in addition to adding the additional user-definable requirement to the logical template.

FIG. 14 illustrates an example of a logical template 1404 in a user interface 1402 showing multiple user-definable requirements, consistent with embodiments of the present disclosure. In FIG. 14, the user interface 1402 includes multiple user-definable requirements, including the user-definable requirement 1206 (“Due Date”), the user-definable requirement 1406 (“status”), and “something.” The multiple user-definable requirements in the user interface 1402 may be displayed in bold or in any other manner, representing that they are user-definable. Compared with the logical template 1304, the user-definable requirement 1406 (“status”) and “something” are additional user-definable requirements.

Referring back to FIG. 13, the user interface 1302 displays multiple interactive elements (e.g., buttons) below the logical template 1304, including an interactive element 1308 (“status is something”). For example, the system may retrieve the multiple interactive elements from a repository (e.g., any of data repositories 256-1 through 256-n) and display them in the user interface 1302. In some embodiments, the system may dynamically change the logical template 1304 to the logical template 1404 and display the logical template 1404 in the user interface 1402 after receiving data indicating that the user selected the interactive element 1308 in the user interface 1302. Further, the system may also change the multiple interactive elements associated with the user-definable requirement 1206, as illustrated in FIG. 13, to multiple interactive elements (e.g., buttons) associated with the user-definable requirement 1406 (e.g., “Status 1” and “Status 2”), as illustrated in FIG. 14, which are displayed under the user-definable requirement 1406. For example, the system may retrieve the multiple interactive elements from a repository (e.g., any of data repositories 256-1 through 256-n) and display them in the user interface 1402.

By way of non-limiting example, the user-definable requirement 1406 may be dynamic. For example, similar to the user interface 1102 of FIG. 11, the user interface 1402 further displays multiple interactive elements (e.g., “Status 1” and “Status 2”) for receiving user inputs to configure the user-definable requirement 1406. If the system receives data indicating that the user selected the interactive element “Status 1” in the user interface 1402, the system may change the logical template 1404 to be “when Due Date changes and Status 1is something, do something” (not shown in FIG. 14).

As illustrated in FIG. 14, the logic template 1404 dynamically changed from the logical template 1304 and includes an additional predefined requirement “is” (shown as a bold text with an underline in FIG. 14). In some embodiments, the additional predefined requirement “is” can be deactivated, such as by replacing it with another predefined requirement (e.g., “is not”). For example, if a user clicks on the additional predefined requirement “is”, the system may display an interactive element (e.g., a popup window, a drop-down menu, a new webpage, or any GUI element, not shown in FIG. 14) that may provide a list of predefined requirements (e.g., “is” and “is not”) for the user to select. By enabling the user to select from the list, the system may change the additional predefined requirement “is.”

Consistent with disclosed embodiments, the at least one processor of the system may carry out operations that may involve enabling association of the selected logical template with a row. “Associating,” as used herein, may refer to processes or procedures of establishing a relationship or connection between at least one thing and at least one other thing. The relationship or connection may be implemented as a data structure stored in a memory or through any other linking mechanism. In some embodiments, at least one of the plurality of data objects or columns may store an indicator (e.g., a flag, a pointer, or a shading) for representing that specific data object(s) are associated in some way. For example, if the plurality of objects are data objects or “things” stored in the memory, associating them may be implemented as processes or procedures to link them or represent them using a data structure (e.g., members of a single class). For example, if the two or more things are stored as digital data in a non-transitory computer-readable medium (e.g., a memory or a storage device), the relationship or connection may be established by linking the two or more things, or by assigning a common code, address, or other designation to the two or more things in the non-transitory computer-readable medium. In this example, the two or more things may include a selected logical template and the row.

The row enabled to be associated with the selected logical template may be a row of the table having a plurality of horizontal and vertical rows enabled to be formed by the system. In some embodiments, the user-definable requirements of the selected logical template may be associated with one or more portions (e.g., columns or rows) of the table having a plurality of horizontal and vertical rows enabled to be formed by the system.

By way of non-limiting example, the table may be the table 600 in FIG. 6, and the selected logical template may be the logical template 504 in FIG. 5. The system may associate the selected logical template 504 with one or more rows in the table 600. For example, the logical template 504 includes a user-definable requirement “this” that may be associated with one or more rows or columns of the table 600, such as any combination of the rows that includes “Task 1,” “Task 2,” or “Task 3.” In an example, “this” may be associated with the first column 602 such that “when this happens” in the logical template 504 may be defined as a status change in any row of table 600 (e.g., “when a status of any row changes”).

By way of non-limiting example, a table 600 in FIG. 6, may be associated with selected logical template 1104 in FIG. 11. The multiple interactive elements in the user interface 1102 may be column headings of the table 600. For example, the interactive element 1108 may be the second column heading 608 of the table 600 as illustrated in FIG. 6. After receiving data indicating that any of the multiple interactive elements is selected by a user, the system may enable input into the selected logical template 1104 of a column associated with the column heading represented by the selected interactive element for the dynamic user-definable requirement 1106, enabling association of the selected logical template 1104 with a row of the table. For example, if the system receives data indicating that the interactive element 1108 is selected, the system may enable input into the selected logical template 1104 of the second column 606 of the table 600 for the dynamic user-definable requirement 1106, enabling association of the selected logical template 1104 with one or more rows (e.g., any combination of the rows that includes “Task 1,” “Task 2,” or “Task 3”) of the table 600. The result of the association may be the logic template 1204 as illustrated and described in FIG. 12.

Consistent with disclosed embodiments, the at least one processor of the system may carry out operations that may involve executing logic operations defined by the selected logical template to operate on the row in response to the association of the selected logical template with the row. For example, the logic operations defined by the selected logical template may be any combination of a trigger or an action. In some embodiments, the system may monitor the plurality of horizontal and vertical rows of the formed table to determine whether a trigger of the logic operations is met in the row associated with the selected logical template. If the trigger is met, the system may execute an action of the logic operations. Monitoring, as used herein, may refer to any process or procedure of inspecting, checking, or keeping track of statuses or changes of an object. For example, if the object is a computer data object stored in the memory, monitoring the computer data object may be implemented by inspecting it (e.g., continuously or periodically) to determine whether there is any change in the memory space where it is stored. The inspection may be implemented via an API (e.g., a periodic polling API or a timer).

By way of non-limiting example, with reference to FIG. 5, the selected logical template 504 may define logic operations that includes the trigger “when this happens” and the action “do something.” The system may associate the logical template 504 with the table 600 in FIG. 6. The system may monitor (e.g., via an API, such as a periodic polling API) one or more rows (e.g., any combination of the rows that includes “Task 1,” “Task 2,” or “Task 3”) of the table 600 to determine whether “this” happens in one of the rows. If “this” happens, the system may execute “something” as defined in the logical template 504.

FIG. 15 illustrates an example of a logical template 1504 showing a logic operation in a user interface 1502, consistent with embodiments of the present disclosure. Referring back to FIG. 12, the user interface 1202 displays multiple interactive elements (e.g., buttons) below the logical template 1204, including an interactive element 1210 (“notify”). For example, the system may retrieve the multiple interactive elements from a repository (e.g., any of data repositories 256-1 through 256-n) and display them in the user interface 1202. In some embodiments, the system may change the logical template 1204 to the logical template 1504 and display the logical template 1504 in the user interface 1502 after receiving data indicating that the user selects the interactive element 1210 in the user interface 1202.

As illustrated in FIG. 15, the logic template 1504 includes a trigger “when Due Date changes” and an action “notify someone.” For example, the logic template 1504 may be associated with one or more rows of the table 600 in FIG. 6. In this example, the system may monitor (e.g., via an API, such as a periodic polling API) the table 600, and if a due date (e.g., in the second column 606) of a row (e.g., the row including “Task 1”) changes (e.g., from “June 30” to “August 31”), the system may execute the logic operations defined in the logic template 1504 to operate on the row by notifying someone (e.g., sending an email to a person supervising Task 1). “Notify” and “someone” in FIG. 15 are user-definable requirements (represented as bold texts) in the logic template 1504. For example, if a user selects “notify,” the system may display a first interactive element (e.g., a popup window, a drop-down menu, a new webpage, or any GUI element, not shown in FIG. 15) for the user to configure the manner of notifying (e.g., to type a text message). In another example, if a user selects “someone,” the system may display a second interactive element (e.g., a popup window, a drop-down menu, a new webpage, or any GUI element, not shown in FIG. 15) for the user to configure a person (e.g., the user, a team member of the user, a person included in the table 600, a subscriber to Task 1, the user's entire team, or a guest) to receive the notification.

Consistent with disclosed embodiments, the at least one processor of the system may further carry out operations that may involve recognizing the user-definable requirements from the table, and displaying the recognized user-definable requirements for selection. Recognizing a user-definable requirement from the table, as used herein, may refer to an operation of determining a row or a column of the table as an interactive element in a user interface for configuring the user-definable requirement in a logical template. For example, the system may determine a column heading associated with a column of the table and display the column heading as an interactive element in a user interface, in which, if a user selects the interactive element to configure the user-definable requirement, the system may associate the logical template with the column. In some embodiments, the system may store the interactive element to a repository (e.g., any of data repositories 256-1 through 256-n) after determining the row or the column of the table as the interactive element.

By way of non-limiting example, with reference to FIG. 11, the user interface 1102 displays multiple interactive elements (e.g., buttons) for receiving user inputs to configure the dynamic user-definable requirement 1106, including an interactive element 1108 (“Due Date”), “Timeline,” “Task Details,” and so on. The system may recognize some or all of the multiple interactive elements from the table (e.g., the table 600 in FIG. 6). For example, the system may recognize the interactive element 1108, “Timeline,” and “Task Details” from column headings of the second column 606, the column 610, and the column 614 of the table 600, respectively. Further, the system may display the interactive element 1108, “Timeline,” and “Task Details” as interactive elements for selection in the user interface 1102. If a user selects the interactive element 1108 to configure the dynamic user-definable requirement 1106, the system may associate the logic template 1104 with the second column 606.

Consistent with disclosed embodiments, the at least one processor of the system may further carry out operations that may involve recognizing the user-definable requirements from a plurality of tables, and displaying the recognized user-definable requirements for selection. For example, the system may recognize a user-definable requirement from multiple tables rather than a single table. By doing so, the system may expand the application scope of the logical template beyond a single table.

Consistent with disclosed embodiments, the system may dynamically change the logical template based on the change of the dynamic user-definable requirement in accordance with a dynamic decision tree. For example, the system may receive a user input for a dynamic user-definable requirement, based on which the system may predict (e.g., based on statistics of past user operations or a prediction model determined by a machine learning technique) a next element (e.g., a predefined requirement or another user-definable requirement) for the logical template. Based on the prediction, the system may provide options to change the logical template (e.g., by including the next element as an additional or replacement element). In some embodiments, the change in the logical template may include a change of its presentation, such as a change of the display of the logical template in a user interface.

By way of non-limiting example, with reference to FIGS. 12 and 15, the system may change the logical template 1204 to the logical template 1504 in accordance with a decision tree. For example, based on statistics of past user behaviors, the system may determine that when a user selects the interactive element 1108 (“Due Date”) from the user interface 1102 to configure the dynamic user-definable requirement 1106 (“column”), the probable actions (e.g., determined based on frequencies of past user selections) the user intends to do may include notifying someone, changing a status, pushing a date, and starting time tracking. The system may then predict that a next element (e.g., an action) for the logic template 1204 to possibly include such as “notify,” “change status,” “push date,” and “start time tracking.” Based on the prediction, the system may display the interactive elements 1210 “notify”, “change status,” “push date,” and “start time tracking,” among other interactive elements, in the user interface 1202 for the user's selection to change the logical template 1204. For example, if the user selects the interactive element 1210, the system may change the logical template 1204 to the logical template 1504.

Consistent with disclosed embodiments, before executing the logic operations defined by the selected logical template to operate on the row, the system may enable the user to re-configure or change any of the elements (e.g., a predefined requirement or a user-definable requirement) of the logic template in any order. For example, the system may dynamically determine a logic template in a decision tree manner, in which the system may determine a first element and then determine a second element based on a user input for the first element. After determining the second element, the system may still enable the user to change the first element by changing the previous user input.

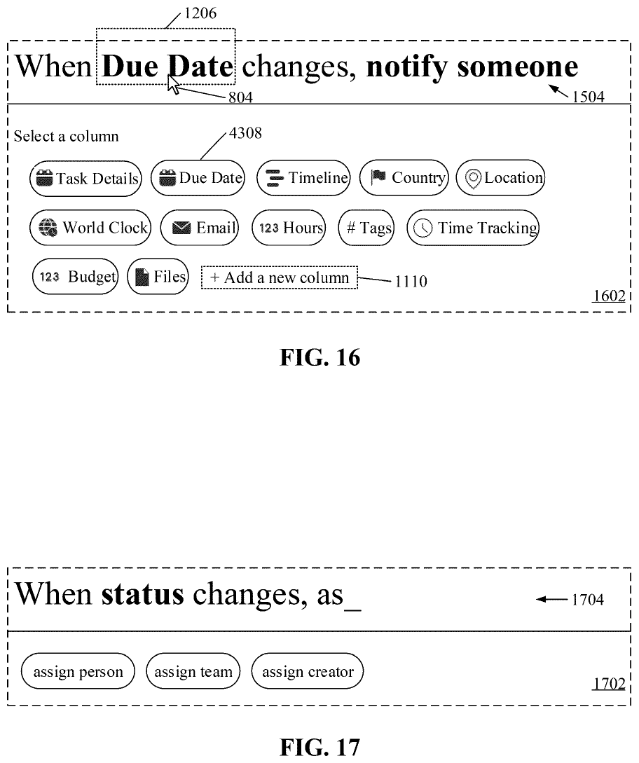

FIG. 16 illustrates an example of re-configuring the logical template 1504 in a user interface 1602, consistent with embodiments of the present disclosure. The logical template 1504 is illustrated and described in FIG. 15. In some embodiments, the system may change from displaying the user interface 1502 to displaying the user interface 1602 after receiving data indicating that the cursor 804 is hovering over (e.g., as a result of a user operation) or having clicked on the dynamic user-definable requirement 1206 of the logical template 1504 in the user interface 1502. Similar to the user interface 1102 in FIG. 11, the user interface 1602 displays multiple interactive elements (e.g., buttons) for receiving user inputs, including the interactive element 1108 (“Due Date”) and the interactive element 1110 (“add a new column”). The user may select a different interactive element to re-configure the dynamic user-definable requirement 1206. For example, if the user selects “Timeline” from the user interface 1602, the system may update the logical template 1504 as “when Timeline changes, notify someone” (not shown in FIG. 16).

Consistent with disclosed embodiments, the at least one processor of the system may further carry out operations that may enable creating a logical template in a free-form textual manner. Different from the selection manner for creating or configuring a logical template as illustrated and described in association with FIGS. 5 and 7 to 16, the system may further enable the user to type free-form text in a user interface from scratch to create a logical template. As the user types the free-form text in the user interface, the system may recognize a word (e.g., by comparing with a keyword list) from the typed text, regardless of its location in the typed text, to determine whether the recognized word is a predefined requirement or a user-definable requirement. Based on the recognized word, the system may predict a next element (e.g., in accordance with a decision tree technique) for the typed text and provide options for the user to select. In some embodiments, the system may recognize one or more synonyms of the recognized word such that any synonym of the word will not change the functional behavior of the system.

FIG. 17 illustrates an example of creating a logical template 1704 with free-form text in a user interface 1702, consistent with embodiments of the present disclosure. As illustrated in FIG. 17, the system may enable a user to type free-form text in the user interface 1702. In FIG. 17, the user types “when status changes, as” with the underscore “_” indication representing a typing cursor. Represented by its bold text, the system may have correctly recognized the word “status” and provided options (not shown in FIG. 17) to the user for selection. For example, the provided options may include an interactive element named with the first column heading 604 (“Status”) in the table 600 of FIG. 6. If the user selects the interactive element or complete typing the name of the interactive element, the system may associate the first column 602 with the logical template 1704.

As illustrated in FIG. 17, although the user has not completed typing “assign,” the system may predict that the next intended element of the logical template 1704 may include a word “assign,” and provide three options (i.e., “assign person,” “assign team,” and “assign creator”) for the user to select for completing the typing. The user may select from one of the three options, or continue typing such that the system may continue predicting what the next element will be.

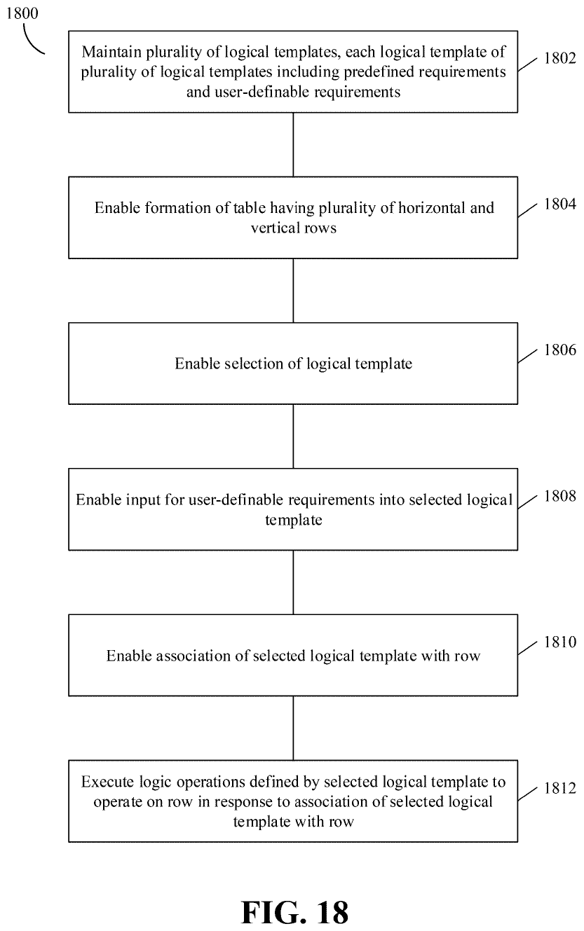

FIG. 18 illustrates a block diagram of an example process 1800 for automating tablature, consistent with embodiments of the present disclosure. While the block diagram may be described below in connection with certain implementation embodiments presented in other figures, those implementations are provided for illustrative purposes only, and are not intended to serve as a limitation on the block diagram. In some embodiments, the process 1800 may be performed by at least one processor (e.g., the processing circuitry 110 in FIG. 1) of a computing device (e.g., the computing device 200 in FIGS. 2A-2B) to perform operations or functions described herein, and may be described hereinafter with reference to FIGS. 5 to 17 by way of non-limiting example. In some embodiments, some aspects of the process 1800 may be implemented as software (e.g., program codes or instructions) that are stored in a memory (e.g., the memory portion 122 in FIG. 1) or a non-transitory computer-readable medium. In some embodiments, some aspects of the process 1800 may be implemented as hardware (e.g., a specific-purpose circuit). In some embodiments, the process 1800 may be implemented as a combination of software and hardware.

FIG. 18 includes process blocks 1802 to 1812. At block 1802, a processing means (e.g., the processing circuitry 110 in FIG. 1) may maintain a plurality of logical templates. Each logical template of the plurality of logical templates may include predefined requirements (e.g., the predefined requirement 706 in FIG. 7 or 8) and user-definable requirements (e.g., the user-definable requirement 906 in FIG. 9 or 10).

At block 1804, the processing means may enable formation of a table (e.g., the table 600 in FIG. 6) having a plurality of horizontal and vertical rows. For example, the horizontal and vertical rows may include columns 602, 606, 610, 612, 614, and 616, and rows the include “Task 1,” “Task 2,” and “Task 3” in the table 600.

At block 1806, the processing means may enable selection of a logical template. For example, the selected logical template may be one of the plurality of logical templates. By way of non-limiting example, the selected logical template may be any of the logical template 504 in FIG. 5, the logical template 708 in FIG. 7 or 8, the logical template 904 in FIG. 9 or 10, the logical template 1104 in FIG. 11, the logical template 1204 in FIG. 12, the logical template 1304 in FIG. 13, the logical template 1404 in FIG. 14, the logical template 1504 in FIG. 15 or 16, or the logical template 1704 in FIG. 17.

At block 1808, the processing means may enable input for the user-definable requirements into the selected logical template (e.g., the logical template 1104 in FIG. 11). In some embodiments, the user-definable requirements may be dynamic such that input of at least one user-definable requirement is configured to cause a change in the logical template. For example, the dynamic user-definable requirement may be the dynamic user-definable requirement 1106 in FIG. 11.

In some embodiments, the change in the logical template may include a presentation of at least one option (e.g., the interactive element 1208 in FIG. 12) for an additional user-definable requirement (e.g., the user-definable requirement 1406 in FIG. 14). In some embodiments, the change in the logical template may include a presentation of at least one additional predefined requirement (e.g., the additional predefined requirement “and” in the logical template 1304 in FIG. 13).

In some embodiments, if the change in the logical template includes a presentation of the at least one additional predefined requirement (e.g., the additional predefined requirement “and” in the logical template 1304 in FIG. 13), the change in the logical template further may include the presentation of at least one option for an additional user-definable requirement (e.g., the user-definable requirement 1406 in FIG. 14).

At block 1810, the processing means may enable association of the selected logical template with a row (e.g., a row of the table 600 in FIG. 6). At block 1812, the processing means may execute logic operations defined by the selected logical template (e.g., the logic operations defined by the logic template 1504 in FIG. 15) to operate on the row in response to the association of the selected logical template with the row.

Consistent with disclosed embodiments, the processing means may further recognize the user-definable requirements from the table (e.g., the table 600 in FIG. 6), and display the recognized user-definable requirements for selection. Consistent with disclosed embodiments, the processing means may recognize the user-definable requirements from a plurality of tables (e.g., including the table 600 in FIG. 6), and display the recognized user-definable requirements for selection.

As companies scale, they face increasing complexity in managing a diverse array of teams, processes, projects, and workflows. This growth often brings about a need for standardization, not only to ensure consistency and alignment across departments, but also to maintain operational efficiency and reduce friction in day-to-day execution. However, implementing effective standardization is far from simple. Organizations have to strike a delicate balance between enforcing structure and preserving the flexibility needed to accommodate the unique needs of different teams.

One common approach to standardization is the use of templates, a top-down method that imposes a predefined structure at the beginning of a design or workflow process. Templates can be powerful tools for establishing uniformity, especially in environments where repeatability and compliance are present. Yet, traditional/standard template systems come with significant limitations. They often fail to propagate updates in real time across all user accounts or template-derived/child entities. Standard templates also do not maintain any relationship with their child entities. This means that when changes are made to a given template, such as adding new fields, modifying dropdown options, or updating task structures, those changes are not reflected or automatically propagated in the child entities. As a result, teams may continue working with outdated structures, leading to misalignment, duplicated efforts, and delays.

Moreover, rigid templates may hinder cross-functional collaboration. When templates are designed without consideration for the varying access levels, privacy boundaries, and operational nuances of different departments, they can become a source of friction rather than cohesion. Teams may find themselves constrained by a structure that doesn't reflect their actual needs, forcing them to work around the system or duplicate efforts in parallel tools. This lack of adaptability can lead to communication breakdowns and inconsistent execution of tasks.

In fast-paced, dynamic organizations, the ability to maintain standardized workflows while allowing for contextual flexibility is valuable. Solutions that enable real-time synchronization between master and child templates, respect privacy boundaries, and support both vertical and horizontal alignment are increasingly necessary to overcome the shortcomings of traditional project management systems. Some disclosed embodiments involve governing a centralized framework that enforces a hierarchical relationship between a template and a plurality of user-facing applications implementing the template. In the context of a project management or SaaS platform (e.g., platform 100), a template refers to a pre-configured, reusable framework that encapsulates one or more platform elements, such as boards, tables, documents, workflows, dashboards, or entire workspaces. A template serves as a foundational structure designed to standardize operational processes, user interfaces, and data formats across multiple implementations. These implementations are referred to herein as user-facing applications, which correspond to instances of a template that are accessible to and built for use by a specific user account or group of user accounts. Each user-facing application implementing the template inherits the structural and behavioral definitions of the originating template, but may be further customized to reflect the operational context, permissions, and data needs of the associated user or group. For example, while the template may define a minimum set of columns, workflows, and access rules, the user-facing application may include additional fields, localized content, or integrations tailored to the user's role or department. Within the context of this disclosure, templates refer to structured configurations that enable dynamic updates across dependent entities. Specifically, changes made to a given template, such as modifications to layout, metadata, or workflow logic, are automatically pushed to all linked child user-facing applications, ensuring that these instances remain synchronized and current. The disclosed templates are therefore distinct from standard templates, which are static in nature. Standard templates serve as a starting point for creating new instances but do not support automatic propagation of changes made to the original template.

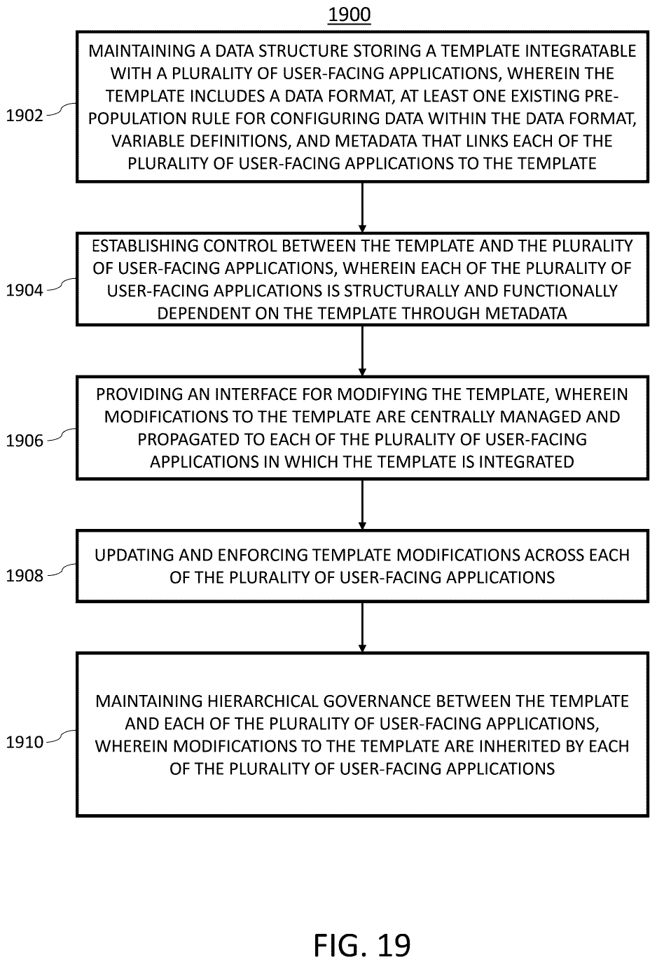

FIG. 19 is a flowchart of an exemplary process 1900 for governing a centralized framework that enforces a hierarchical relationship between a template and a plurality of user-facing applications implementing the template, consistent with some of the disclosed embodiments. Process 1900 is discussed herein for explanatory purposes and is not intended to be limiting. In some embodiments, steps of process 1900 may be changed, modified, substituted, or rearranged, consistent with the present disclosure. Process 1900 may be implemented using one or more components of a computing device 200 (discussed in FIG. 2A) or user device 254 of computing architecture 250 (discussed in FIG. 2B). Some disclosed embodiments may include at least one processor that may be configured to execute stored instructions to perform operations for governing a centralized framework that enforces a hierarchical relationship between a template and a plurality of user-facing applications implementing the template. As shown in FIG. 19, process 1900 may include steps 1902, 1904, 1906, 1908, and 1910, discussed in further detail below. While embodiments of the present disclosure are presented within the context of project management, the disclosed embodiments may apply to different contexts involving collaborative workflow systems, enterprise resource planning, customer relationship management (CRM), content management platforms, and other SaaS-based environments where standardized structures are deployed across multiple user-facing interfaces. These contexts similarly benefit from a centralized framework that governs hierarchical relationships between templates and multiple child instances, enabling consistent propagation of updates, structural integrity, and operational alignment across distributed implementations.

Some disclosed embodiments involve maintaining a data structure storing a template integrable with a plurality of user-facing applications. The template includes a data format, at least one existing pre-population rule for configuring data within the data format, variable definitions, and metadata that links each of the plurality of user-facing applications to the template. Maintaining a data structure, refers to the ongoing set of operations performed by one or more software components or processing units to ensure the integrity, accessibility, and responsiveness of the structure over time. This may include not only accessing the data structure to retrieve or modify its contents, but also managing its organization and performance. From the perspective of a processing unit, accessing a data structure may involve reading specific elements, searching for values, querying based on defined criteria, or updating the structure by inserting, modifying, or deleting data. Maintenance further encompasses tasks such as sorting, reorganizing, or optimizing the structure to ensure efficient operation and scalability. In some embodiments, the data structure may be accessible from an external data source. For example, the data structure may be external to computing device 200 (discussed in FIG. 2A) or user device 254 of computing architecture 250 (discussed in FIG. 2B). Process 1900 includes a step 1902 of maintaining a data structure, as illustrated in FIG. 19.

In the context of the present disclosure, maintaining a data structure that stores a template integrable with a plurality of user-facing applications involves preserving and managing a centralized repository that defines the template's configuration. As previously described, a template serves as a foundational structure intended to standardize operational processes, user interfaces, and data format across multiple implementations. These implementations are referred to herein as user-facing applications, which represent instances of the template that are specifically accessible to and designed for use by an individual user account or a defined group of user accounts. Each user-facing application reflects a localized deployment of the template, allowing for contextual customization while remaining structurally linked to the master template configuration. This relationship enables centralized governance and dynamic update propagation, ensuring consistency across distributed implementations.

To enforce this governance, the template includes a set of structural and behavioral components that define how data is organized, initialized, and linked across the system. These components may include a data format, which specifies the prescribed arrangement and representation of data elements within the template. The data format may define the types of fields, their relationships, constraints, and expected input formats, thereby ensuring consistency in how data is captured and displayed across all user-facing applications. The template may also include at least one pre-population rule, which governs how data is automatically inserted or configured, within the defined data format. These rules may be used to initialize fields with default values, derive content from external sources, or apply conditional logic to populate data based on contextual parameters. Pre-population rules may help streamline setup and reduce manual input errors by ensuring that each user-facing application begins with a coherent and relevant data structure.

In addition, the template may contain variable definitions, which represent named placeholders or dynamic fields that may be resolved or substituted based on user-specific or context-specific information. Variable definitions may allow templates to be flexible and adaptive, enabling the same structural framework to serve multiple use cases while maintaining semantic clarity. Moreover, the template may include metadata that links each of the plurality of user-facing applications to the template itself. Metadata linking refers to the process of associating each user-facing application with a given template using metadata. Metadata may include identifiers, timestamps, versioning information, access permissions, and synchronization flags. Metadata may serve as the connective tissue that enables the system to track relationships, enforce inheritance, and propagate updates from the template to its dependent instances/user-facing applications.

In some embodiments, the data format includes a table format. A table format refers to an organized arrangement of data into rows and columns defining cells, where each column represents a specific attribute or field, and each row corresponds to a discrete record or entry. This format may enable structured data representation, allowing for efficient storage, retrieval, and manipulation of information. A table format may be used to define the layout of user-facing applications such as boards, task lists, or resource trackers, where each cell in the table may be populated according to predefined rules or user input. In some embodiments, the at least one pre-population rule of the template configuring data within the data format includes a pre-population rule configuring content of at least one cell within the table format. In some embodiments, the at least one pre-population rule configuring data within the data format includes a plurality of pre-population rules configuring a content of a plurality of cells within the table format. The table format may support both static and dynamic data, and may include features such as column types (e.g., text, date, status), sorting logic, filtering capabilities, and relational links to other data structures. Adopting a table format within a template may enable consistency in how data is captured and displayed across multiple implementations/user-facing applications, while also enabling scalable customization and update propagation. FIGS. 3A-3D illustrate different templates including a table format.

In some embodiments, at least a portion of the data format is unaffected by the at least one pre-population rule. As used herein, “at least a portion of the data format” refers to only some elements (e.g., certain fields, columns, or cells) within the overall data format. In other words, while the pre-population rule may configure specific elements within the data format, other elements may be empty or retain their default or user-defined values, independent of any automated configuration logic. “Specific elements” refers to those individual elements that are targeted by rules or logic, as opposed to the entire data format. For example, if the data format is a table format, the at least one pre-population rule may initialize the content of one or more cells in a table, without affecting the content of others.

Some disclosed embodiments involve establishing control between the template and the plurality of user-facing applications, wherein each of the plurality of user-facing applications is structurally and functionally dependent on the template through the metadata. As used herein, establishing control refers to the creation and enforcement of a governed relationship whereby the template serves as the authoritative source of configuration, structure, and behavior for all linked user-facing applications. This control may ensure that changes made to the template, such as updates to layout, logic, or metadata, can be systematically propagated to dependent user-facing applications, either automatically or through user-directed synchronization. Each of the user-facing applications is structurally and functionally dependent on the template through metadata. Structural dependency means that the user-facing application inherits its foundational layout (e.g., a core structure defined by the template), data format, and interface components from the template. This may include column definitions, field types, workflow sequences, relational mappings, among other things. Functional dependency, on the other hand, refers to the reliance of the user-facing application on the template's operational logic, such as pre-population rules, variable definitions, and update mechanisms, to perform its intended tasks. The metadata linking each application to the template serves as the connective tissue that enables this dependency, allowing the system to track relationships, enforce consistency, and manage updates across distributed instances. Process 1900 includes a step 1904 of establishing control between the template and the plurality of user-facing applications, as illustrated in FIG. 19. In some embodiments, relationships between the template and the plurality of user-facing applications are stored in the data structure, such as through records that associate template with the user-facing application and/or metadata entries. These entries may include identifiers that explicitly link each user-facing application to its corresponding template, enabling traceability, governance, and efficient propagation of updates across integrated systems.

Some disclosed embodiments involve providing an interface for modifying the template. Modifications to the template are centrally managed and propagated to each of the plurality of user-facing applications in which the template is integrated. As used herein, an interface refers to a dedicated environment, such as a graphical user interface (GUI) that is accessible to the template owner or to individuals with the appropriate access privileges. This interface, also referred herein to as template center or template editor, may be designed specifically for managing templates and is distinct from any workspace environment where active work takes place. While workspaces are used for executing tasks, collaborating, and interacting with live data, the template interface, serves as a controlled space for governing the structure, behavior, and update logic of templates. In this context, providing an interface refers to the operation of enabling authorized users to interact with the dedicated environment separate from active workspaces, through which they can view, edit, and manage the configuration of templates stored within the centralized data structure. Process 1900 includes a step 1906 of providing an interface for modifying the template, as illustrated in FIG. 19.

The process for creating and managing templates may begin with the initial setup of one or more platform elements, such as boards, tables, documents, workflows, dashboards, or entire workspaces, which a user may choose to convert into a template. Once converted, these elements are moved into the template center interface, where they become a template subject to centralized governance (e.g., exerting control over a plurality of user-facing applications). Then through this interface, users can modify the template's configuration. In some embodiments, modifications to the template include at least one of modifications to the data format, variable definitions, or the at least one pre-population rule. Modifications made within this interface may be centrally managed (e.g., modifications to the template are controlled through a single interface) and may be propagated to each of the plurality of user-facing applications in which the template is integrated (e.g., being used) via metadata. In other words, these changes, whether to the data format, variable definitions, or pre-population rules, are not isolated, they are systematically propagated to all user-facing applications that are structurally and functionally linked to the template. As used herein, propagation refers to the distribution of information to linked user-facing applications. Propagation of modifications, thus refers to process by which linked user-facing application update their structure and logic, implement the modification, to match the revised template. This propagation occurs via metadata, which acts as the connective layer between the template and its dependent instances. Metadata may store information such as version identifiers, synchronization flags/statuses (e.g., data indicative of whether a user-facing application is up-to-date with the latest version of a template), and linkage references (e.g., a pointer or identifier that connect a user-facing application to its governing template), allowing determination of which user-facing applications are affected by a given modification and ensuring that updates are accurately reflected across the user-facing applications that are derived from and governed by a particular template.

In some embodiments, at least a portion of the data format is unaffected by the modifications to the template. While the template center interface allows authorized users to alter aspects such as variable definitions, pre-population rules, or structural configurations, these changes do not necessarily apply to every component of the data format. For example, specific fields or sections within a data format may be intentionally excluded from update propagation to preserve user-defined content or maintain contextual integrity within individual user-facing applications. This selective application of modifications may ensure that while centralized governance is maintained, flexibility is preserved, allowing user-facing applications to retain control over at least some elements that are beneficial to their specific operational context. For example, elements that have been created by a given user-application independently of its governing template, such an additional data field, may not be affected by modifications to the template.

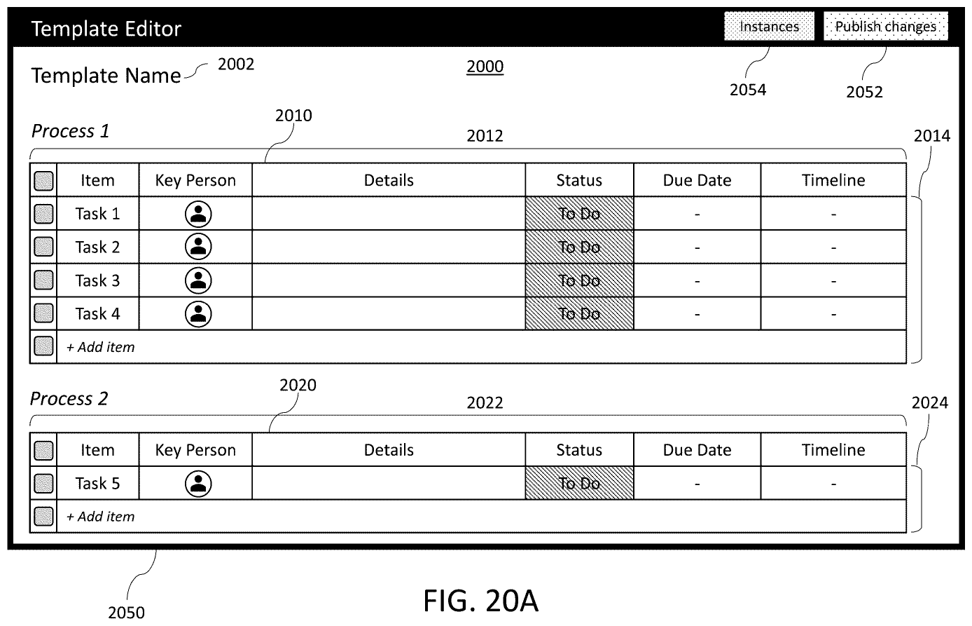

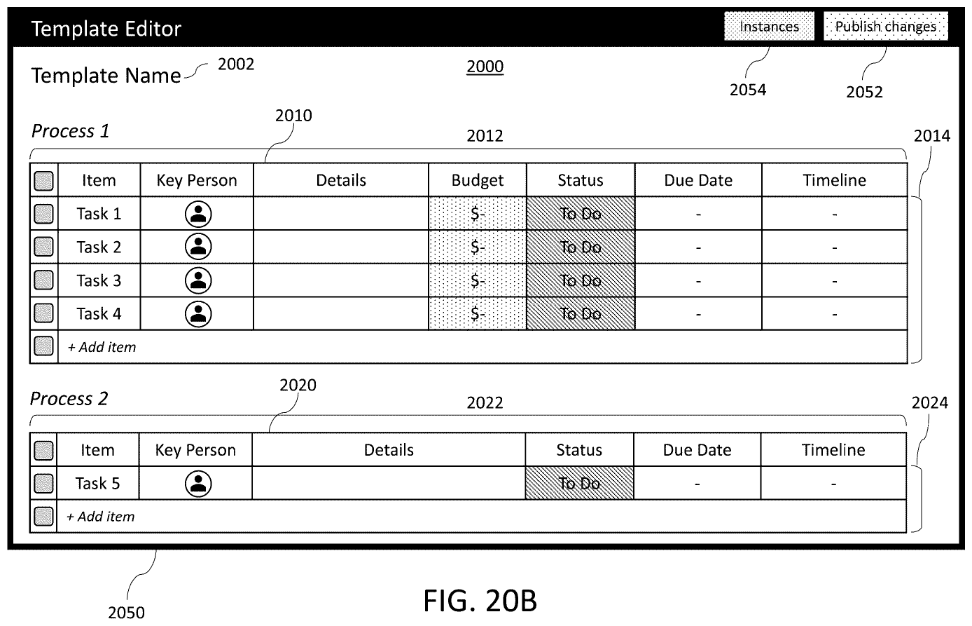

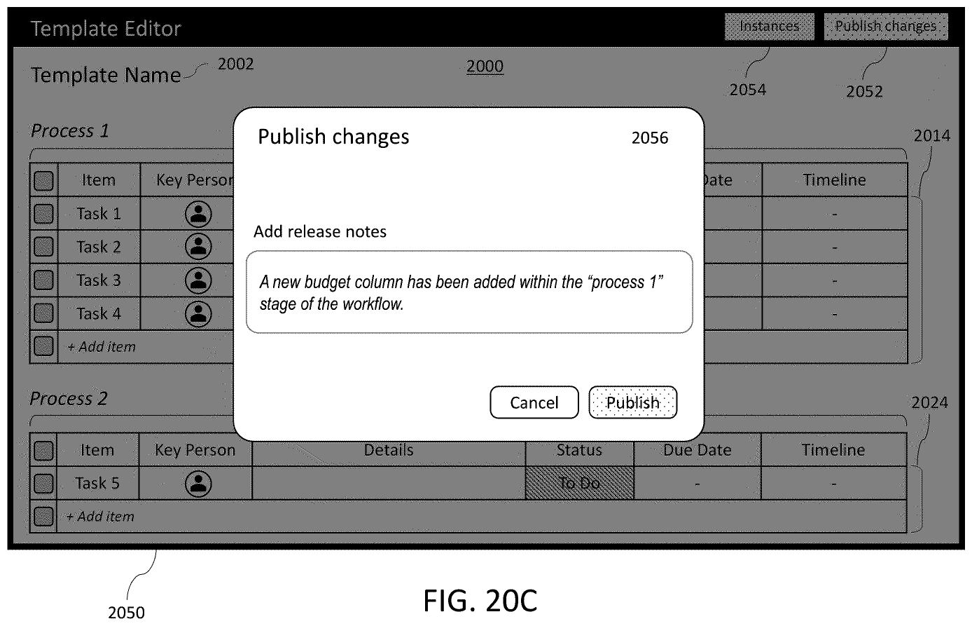

FIG. 20A illustrates an exemplary interface 2050 for editing a template 2000, consistent with the disclosed embodiments. As depicted, template 2000 comprises various elements, including a name field 2002 and two distinct tables, table 2010 and table 2020, each corresponding to a separate process, identified respectively as “Process 1” and “Process 2”. Each of these tables includes a set of columns (2012 and 2022) and rows (2014 and 2024), which together define the tabular structure used to organize and display data relevant to the associated processes.

Consistent with the present disclosure, template 2000 incorporates a data format, pre-population rules, and variable definitions. Within template 2000, the data format includes a table format that governs the layout and organization of tables 2010 and 2020. The template also includes pre-population rules, which automatically configure certain fields within the table. For example, the “Status” column in both tables 2010 and 2020 is pre-populated with the value “To do,” ensuring that each new instance of the template begins with a standardized initial state. Additionally, the template defines variable definitions that specify the expected types of data within particular columns. These may include dynamic fields such as “Key Person” or “Due Date,” which are resolved based on contextual input or user-specific parameters. The interface 2050 provides a graphical environment through which authorized users, such as template owners or individuals with appropriate access privileges, can view, edit, and manage the configuration of template 2000.

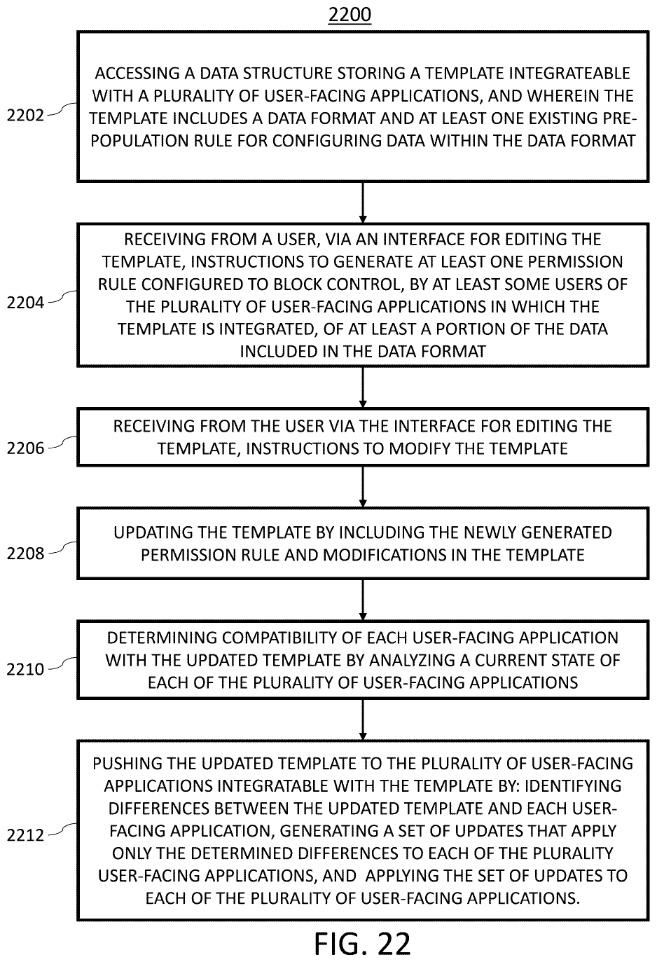

Some disclosed embodiments involve receiving via the interface, instructions to generate permission rules blocking access to at least a portion of the data for at least some users of the plurality of user-facing applications in which the template is integrated. These permission rules may be configured to selectively block access based on user roles, application context, or other criteria. Additional details regarding the generation and application of such permission rules are provided below in connection with process 2200, as illustrated in FIG. 22.

Some disclosed embodiments involve updating and enforcing template modifications across each of the plurality of user-facing applications. When a template is modified via the interface, whether through changes to its data format, variable definitions, or pre-population rules, those changes are not only recorded at the template level but are also actively pushed to all dependent user-facing applications that are structurally and functionally linked to the template. In this context, updating refers to the operation of modifying the configuration, structure, or logic of the user-facing applications, resulting in a revised version of the user-facing applications that reflects the modifications made to the template. Enforcement, on the other hand, refers to the system's ability to ensure that these modifications are properly applied in each linked user-facing applications. This process maintains alignment with the template, meaning that once the template is updated, all user-facing applications governed by it are updated in the same way. Both updating and enforcement are governed through metadata, which serves as the connective framework between the template and its associated user-facing applications. Metadata tracks the relationship between the template and each dependent user-facing applications, allowing the system to identify which applications require updates and to apply those changes in a controlled and consistent manner. This mechanism may ensure that centralized governance is preserved while supporting scalable and synchronized deployment across distributed environment. Process 1900 includes a step 1908 of updating and enforcing template modifications, as illustrated in FIG. 19. Further details regarding how an updated template is being pushed to the plurality of user-facing application are provided below with respect to process 2200 illustrated in FIG. 22.

Some disclosed embodiments involve generating and presenting on the interface a snapshot of an updated template incorporating modifications. A snapshot may refer to a visual and structural representation of a template's current state after the template has been modified or altered in some way, allowing users to review and validate the impact of the modification before the modifications are propagated to dependent user-facing applications. The snapshot may be presented as a visual preview within the interface, allowing users to review changes before they are propagated. The snapshot may be a distinct view or overlay within the template editor. For example, FIG. 20B illustrates a modified version of template 2000, in which a new “Budget” column has been added to table 2010. This addition reflects a structural update to the template's data format and may also involve adjustments to associated pre-population rules and/or variable definitions.

In some embodiments, updating and enforcing template modifications is performed automatically or is performed after receiving from the interface a signal for updating and enforcing template modifications. When performed automatically, modifications made to the template may be immediately propagated and enforced across all structurally and functionally linked user-facing applications. This may ensure real-time synchronization (e.g., matching the latest template configuration) and consistency across distributed instances of the template (e.g., user-facing applications governed by the template) without requiring manual intervention. Alternatively, updating and enforcing template modifications may operate in a controlled mode, and be performed after receiving from the interface a signal for updating and enforcing template modifications. A signal refers to an event or input that triggers an action. This signal may be triggered via user interaction with an element of the interface, such as a GUI component. Examples of user interactions within a GUI include but are not limited to clicking a button, selecting a menu item, checking a box, dragging and dropping an item, double clicking, scrolling, pinching, or toggling. For example, referring to FIGS. 20A-20B, a signal for updating and enforcing modifications made to template 2000 may be received after a user clicked on the “publish changes” button 2052.

Some embodiments involve transmitting a notification to each of the plurality of user-facing applications in which the template is integrated, wherein the notification is configured to inform an owner of the user-facing application that the template has been modified. A notification refers to a message. Examples of a notification format include but are not limited to email alerts, in-app messages, or pop-up dialogs. Transmitting a notification means sending or delivering the notification. The notification may be generated and dispatched either concurrently with the propagation of the updated template or subsequently, depending on system configuration. The notification may include a textual explanation of the changes made to the template, which may be generated by the owner of the template that modified the template or an AI agent capable of analyzing the differences between the previous and updated versions of the template. The notification may be triggered by a signal received from the interface, such as a GUI element configured for editing the template and may be identical to or distinct from the signal used to initiate the push of the updated template.

FIG. 20C illustrates the interface for editing template 2000 following the receipt of a signal to update and enforce modifications made to the template. This signal may be received through activation of a GUI element, such as the “publish changes” button 2052. Upon activation, the interface may dynamically update to include an additional GUI component 2056 that enables the editor of the template to input release notes describing the modifications that have been made. These release notes provide contextual information about the nature and scope of the changes, and once entered, may be automatically integrated into the notification transmitted to the owners of the plurality of user-facing applications governed by the template. Informing user-facing application owners of template modifications, may support transparency, encourage proactive review of inherited changes, and facilitates governance across distributed environments. This mechanism may be beneficial in hierarchical frameworks where templates govern multiple layers of sub-templates and user-facing applications, ensuring that all stakeholders are aware of updates that may affect configuration, behavior, or data formatting within their respective applications.

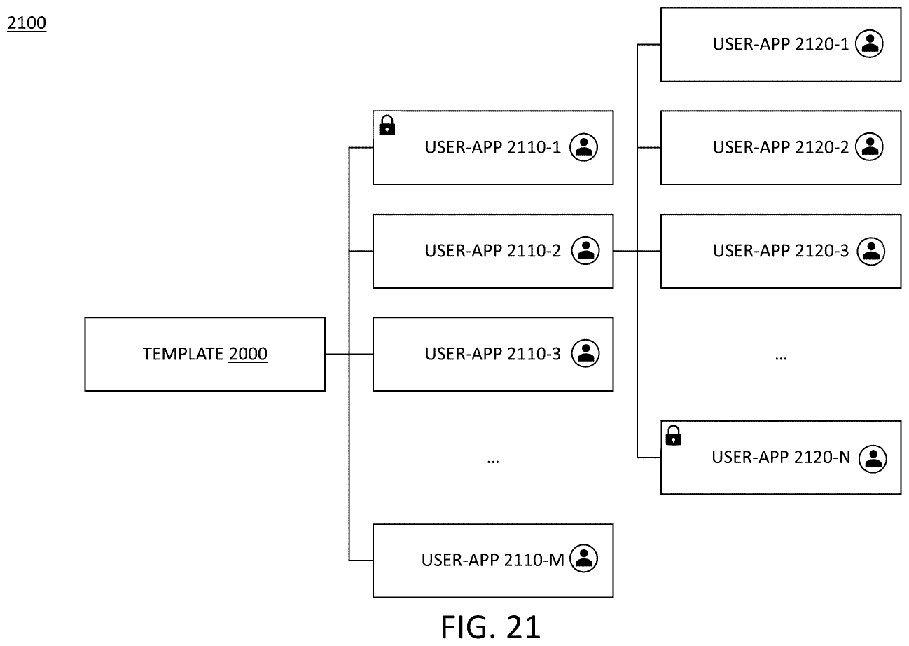

Some embodiments involve receiving, via the interface, a signal to access a representation of the plurality of user-facing applications dependent on the template. A representation of user-facing applications linked to a template refers to a visual, such as a dashboard, table, or flowchart. Accessing a representation means viewing or interacting with this representation. Access to the representation may occur through the interface used for editing the template. The signal to access the representation may be triggered via an element of the interface, such as a GUI component. For example, referring to FIGS. 20A-20B, a signal for accessing a representation of the plurality of user-facing application dependent on template 2000 may be received through activation of the “instances” button 2054. After receiving the signal, a representation such as a widget, a table, a dashboard or a flowchart may be presented on the interface. The representation may reflect the current state of connectivity, including which user-facing applications are actively governed by the template, which are pending updates. Additionally, the representation may enable the template owner to maintain centralized oversight, facilitating governance, auditing, and controlled propagation of template modifications across distributed environments. FIG. 21 illustrates an exemplary representation 2100 of the plurality of user-facing applications that are dependent on template 2000. More specifically, representation 2100 is depicted as a flowchart showing the connectivity between template 2000 and a series of user-facing applications 2110-1 through 2110-M, where M is a natural number representing the total number of linked applications. This visualization supports traceability and management of template influence across the application ecosystem.

In some embodiments, at least one of the plurality of user-facing applications in which the template is integrated is a sub-template. This sub-template is integrable with an additional plurality of user-facing applications that are distinct from the original set. The sub-template includes the data format and variable definitions of the parent template, and at least one additional pre-population rule for configuring data within the defined format, distinct from the pre-population rules of the parent template. Furthermore, the sub-template contains metadata that links each of the additional user-facing applications to the sub-template, enabling structured governance and traceability. Accordingly, updating and enforcing template modifications across the original plurality of user-facing applications may include propagating those modifications to the sub-template in which the template is integrated. This process results in the generation of corresponding modifications within the sub-template, which may then be updated and enforced across each of the additional user-facing applications that depend on the sub-template. This hierarchical propagation ensures consistency and synchronization across both primary and secondary layers of template integration.

For example, as shown in FIG. 21, user-facing application 2210-2 corresponds to a sub-template that is integrable with an additional plurality of user-facing applications 2120-1 through 2120-N, where N is a natural number representing the number of applications governed by the sub-template. This layered structure supports scalable template management across distributed environments while maintaining consistency and auditability. Template modification propagation may follow a hierarchical Grandparent-Parent-Child model. In this model, changes are pushed from the top-level template (grandparent) 2000 to the next level (parent), represented by the sub-template 2210-2, and subsequently to the child templates or user-facing applications integrated with the sub-template 2120-1 through 2120-3. Each level receives updates sequentially, ensuring controlled and traceable propagation of changes throughout the system. In some embodiments, relationships between the sub-template and the additional plurality of user-facing applications, are stored in the data structure. In other words, similar to the relationship between template 2000 and the plurality of user-facing applications 2110-1 through 2110-M, the relationship between sub-template 2110-2 and the additional plurality of user-facing applications 2120-1 through 2120-N may also be stored in a data structure that is accessible to the template center interface.

Some disclosed embodiments involve maintaining hierarchical governance between the template and each of the plurality of user-facing applications, wherein modifications to the template are inherited by each of the plurality of user-facing applications. Hierarchical governance refers to a structured control framework in which a parent template governs subordinate components through inherited relationships. Maintaining this governance refers to the active preservation and enforcement of these relationships, ensuring that any modifications made to the template may be automatically or systematically inherited by all dependent entities. This maintenance may involve not only storing the relationships in a data structure accessible to the interface, but also ensuring that updates are propagated in a controlled and traceable manner. For example, when a change is made to the template, all linked sub-templates and user-facing applications may be identified, the relevant modifications may be applied, thereby synchronizing all connected entities. This process may help prevent configuration drift, supports version integrity, and enables centralized oversight of template-driven environments. By maintaining hierarchical governance, the disclosed embodiments may ensure consistency across distributed user-facing applications while allowing for scalable and efficient management of template modifications. Process 1900 includes a step 1910 of maintaining hierarchical governance, as illustrated in FIG. 19.

In some embodiments, at least one of the plurality of user-facing applications is a private user-facing application. A private user-facing application refers to an application that, while governed by the template, restricts access to its internal data based on ownership, permissions, or confidentiality settings. In such cases, the data contained within the private application is not accessible to the interface, meaning that the interface cannot retrieve, display, or interact with the underlying content of the application. In some embodiments, the interface accesses at least one of a name or an owner of the private user-facing application. which allows for partial visibility without compromising data privacy. In some embodiments, similar to other user-facing applications, a private user-facing application remains governed by the template through metadata enforcement. The metadata defines the relationship between the template and the application but does not include any pointer or mechanism for accessing the actual data stored within the private application. This ensures that governance can be maintained without breaching the privacy boundaries of the application. Referring to FIG. 21, user-facing applications 2110-1 and 2120-N are examples of private user-facing applications, as indicated by the presence of a closed padlock icon displayed within the representation. In some embodiments, a private user-facing application may also function as a sub-template that is integrable with an additional plurality of user-facing applications. In such a scenario, the additional user-facing applications associated with the private sub-template may inherit the same privacy settings. As a result, the data contained within those additional applications also remains inaccessible to the parent template, preserving the privacy model across hierarchical layers of integration.

Some disclosed embodiments involve receiving utilization data from at least some of the plurality of user-facing applications; aggregating utilization data; and generating suggestions for implementing modifications to the template based on aggregated utilization data. As used herein, utilization data refers to any measurable information that reflects how user-facing applications interact with the template. This may include, for example, one or more of frequency of use, types of data entered, error rates, user engagement patterns, performance metrics, and feedback signals. Utilization data may also capture contextual variables such as which pre-population rules are most frequently triggered, which fields are consistently left blank, or which template configurations result in higher user satisfaction or fewer support requests. Once received, the utilization data may be aggregated to form a comprehensive view of template behavior across the plurality of user-facing applications. Based on this aggregated dataset, suggestions may be generated for modifying the template. These suggestions may aim to improve efficiency, reduce errors, enhance usability, or better align the template with observed usage patterns. This process may enable data-driven refinement of template configurations without relying on manual review or anecdotal feedback, and help a template owner in making informed decisions about how the template should evolve.

A user-facing application that implements a template may be independently edited by an associate user or a group of user accounts. Users can personalize their experience by creating custom views and rearranging columns to reflect their individual preferences or operational needs. However, it is important to recognize that any modifications to the user-facing application should remain compliant with the underlying template. When changes are made to the application, verification checks may be performed to ensure that the modifications align with the data format, at least one existing pre-population rule, and/or the variable definitions specified in the template. If the modifications are deemed compliant, the application may be updated accordingly to reflect the received instructions.

The compliance requirement applies to various types of modifications, including changes to the order of rows or columns in a table format, or renaming a column. If a proposed modification does not meet compliance standards, it may be blocked or automatically adapted to achieve compliance. For example, if the template restricts a predefined set of first columns and a user attempts to add a new column, the hierarchical governance between the template and the user-facing application may enforce placement of the new column after the restricted set. This approach preserves the structural integrity and governance of the template while still allowing for user customization. In certain cases, modifications may result in the application losing its connection to the template. When this occurs, the application becomes standalone and is no longer governed hierarchically by the template.

In addition to controlling the types and extent of modifications permitted within a template, while allowing a certain degree of user flexibility, a template owner can also define which specific aspects of the user-facing application are modifiable by users. This granular level of control is comparable to how IT administrators manage permissions on computer systems, determining which applications can be installed or altered. In this context, the template is governed by an owner who may delegate modification rights to individual instances of the user-facing application. Each instance may serve a distinct purpose and operate under different permission settings, whereby certain elements are editable by the instance owner while others remain under the control of the administrator. Permissions can be configured at multiple levels, enabling the template owner to precisely regulate what actions users of the child user-facing applications are allowed to perform. For example, a child user-facing application might be permitted to add new items but restricted from creating or modifying automations. The disclosed embodiments support a hybrid control model, where some permissions are retained by the template owner and others are delegated to users. This approach may enable a balanced framework that upholds centralized governance while accommodating user-specific customization needs.

FIG. 22 is a flowchart of an exemplary process 2200 for controlling access to information included in user-facing software integrating a template, consistent with some of the disclosed embodiments. Process 2200 is discussed herein for explanatory purposes and is not intended to be limiting. In some embodiments, steps of process 2200 may be changed, modified, substituted, or rearranged, consistent with the present disclosure. Process 2200 may be implemented using one or more components of a computing device 200 (discussed in FIG. 2A) or user device 254 of computing architecture 250 (discussed in FIG. 2B). Some disclosed embodiments may include at least one processor that may be configured to execute stored instructions to perform operations for controlling access to information included in user-facing software integrating a template. As shown in FIG. 22, process 2200 may include steps 2202, 2204, 2206, 2208, 2210, and 2212, discussed in further detail below. It is to be appreciated that while embodiments of the present disclosure are presented within the context of project management, the disclosed embodiments may apply to different contexts involving collaborative workflow systems, enterprise resource planning, customer relationship management (CRM), content management platforms, and other SaaS-based environments where standardized structures are deployed across multiple user-facing interfaces.

Some disclosed embodiments involve accessing a data structure storing a template integrable with a plurality of user-facing applications. The template includes a data format and at least one existing pre-population rule for configuring data within the data format. Accessing a data structure refers to the ongoing set of operations performed by one or more software components or processing units to retrieve or modify the data structure contents. From the perspective of a processing unit, accessing a data structure may involve reading specific elements, searching for values, querying based on defined criteria, or updating the structure by inserting, modifying, or deleting data. In some embodiments, the data structure may be accessible from an external data source. For example, the data structure may be external to computing device 200 (discussed in FIG. 2A) or user device 254 of computing architecture 250 (discussed in FIG. 2B). Process 2200 includes a step 2202 of accessing a data structure, as illustrated in FIG. 22.

As mentioned earlier, a template provides a foundational structure to standardize operational processes, user interfaces, and data formats across multiple implementations. These implementations, referred herein to as user-facing applications, are tailored for individual users or groups, allowing contextual customization while remaining linked to the master template. This connection supports centralized governance and enables consistent updates across all instances. To maintain this governance, a template includes structural and behavioural components that define how data is organized and initialized. One of these components may be a data format, which specifies field types, relationships, constraints, and input expectations to ensure uniform data handling. Another one may be a pre-population rule, which automates data insertion using default values, external sources, or conditional logic. In some embodiments, relationships between the template and the plurality of user-facing applications (i.e., which template had an established control over which user facing applications) are stored in the data structure.

Some disclosed embodiments involve receiving from a user, via an interface for editing the template, instructions to generate at least one permission rule configured to block control, by at least some users of the plurality of user-facing applications in which the template is integrated, of at least a portion of the data included in the data format. As mentioned earlier an interface for editing the template, also referred herein to as template center or template editor, may be a graphical user interface distinct from any workspace environment where active work takes place. Within this interface, one or more components enable the template owner to define and manage permission rules.

A permission rule, as used in this context, refers to a configurable constraint that governs which actions users can perform on specific elements of a user-facing application derived from the template. These rules may block or allow control over data fields, automation features, layout elements, or other configurable components. By defining permission rules, the template owner can enforce governance across distributed applications, ensuring that only authorized users can make specific changes. This mechanism allows for hybrid control, where some permissions are retained by the administrator and others are delegated to users, striking a balance between centralized oversight and user-level customization. Process 2200 includes a step 2204 of receiving instructions to generate at least one permission rule, as illustrated in FIG. 22.

Permission rules may be implemented at varying levels of granularity, for example, they may apply to individual items, groups of items, or the entire user-facing application. It is also to be appreciated that not all users of a given user-facing application necessarily share the same rights. A template owner may grant specific modification privileges to the owner of the user-facing application, while restricting other users from making any changes whatsoever. For example, the user-facing application owner may be permitted to add new items or adjust layout configurations, whereas other user may be entirely blocked from performing any modifications.

In some embodiments, the data format defined by the template includes a table format. For example, template 2000, illustrated in FIGS. 20A-20B, incorporates a table format that governs the layout and organization of tables 2010 and 2020. In such cases, at least one permission rule may be configured to restrict user control over specific elements within the table format. In some embodiments, the at least one permission is configured to block control of at least one cell, one group of cells, one column, one group of column, one row, one group of rows, or other structural components within the table format. Referring to FIGS. 20A-20B, the owner of template 2000 may define a permission rule that blocks control of the “Item” column. This restriction may be imposed because the steps listed under that column may be considered mandatory for executing “Process 1” and should remain unaltered to preserve procedural integrity. As a result, users of user-facing applications that integrate template 2000, such as any of the instances 2110-1 through 2210-M, may be prevented from adding new items to “Process 1” or modifying existing entries in that column.

Furthermore, permission rules may be customized to reflect the governance model established by the template owner. These rules are not uniformly applied across all users or all portions of the data format. Instead, they can be tailored to grant or restrict access based on user roles, application instances, or specific data segments. In some embodiments, the at least one permission rule is configured to block control of at least a first portion of the data included in the data format to at least some first users of the plurality of user-facing applications and to block control of at least a second portion of the data included in the data format to at least some second users of the plurality of user-facing applications. In other words, not all users of a given user-facing application are necessarily granted the same rights, nor are they permitted to interact with the same parts of the data format. For instance, the template owner may grant modification privileges to the designated owner of a specific user-facing application instance, allowing that user to customize certain aspects of the application. Meanwhile, other users within the same instance may be entirely restricted from making any changes to such aspects.

Some disclosed embodiments involve transmitting a notification to each of the plurality of user-facing applications in which the template is integrated, wherein the notification is configured to inform users of the user-facing application concerned by the permission rules that control of the at least a portion of the data included in the data format is prohibited. In other words, the notifications may be designed to alert users whose access rights are governed by such permission rules that control over specific portions of the data contained within the data format is not permitted. This prohibition may encompass various forms of interaction with the data, including but not limited to viewing, editing, modifying, exporting, or otherwise manipulating the restricted data elements. This approach may ensure that affected users are made aware of the limitations on data control. These notifications, which are specifically focused on permission rules, are relevant in scenarios where only the access control parameters are modified, without any accompanying changes to the structure or content of the template itself. In such cases, the notification may be dispatched immediately upon the enactment of the new permission rule, ensuring that affected users are promptly informed of any restrictions or updates to their access rights. However, as further described below, updates to permission rules may also occur alongside structural modifications to the template. In such instances, a single consolidated notification may be issued to the relevant users, providing a comprehensive overview of both the changes to the template and the revised permission rules.

Some disclosed embodiments involve receiving from the user via the interface for editing the template, instructions to modify the template. As mentioned earlier, the template center or template editor, may provide a dedicated environment separate from active workspaces, allowing template owners to manage and configure the template in addition to setting permission rules. Modification to the template may include at least one of modifications to the data format, the at least one pre-population rule, or other template features such as variables definitions. Process 2200 includes a step 2206 of receiving instructions to modify the template, as illustrated in FIG. 22.

Some disclosed embodiments involve updating the template by including the newly generated permission rule and modifications in the template. Updating, as used herein, refers to the process of revising the template to reflect newly defined governance parameters, structural changes, or behavioral logic. This may include adding, removing, or altering permission rules that control user access and modification rights across user-facing applications, as well as modifying the data format to accommodate new fields or constraints, adjusting pre-population rules to reflect updated initialization logic, or redefining variables to support new contextual behaviors. Updates may propagate dynamically to all instances linked to the template, preserving consistency while enforcing newly established rules and configurations. Process 2200 includes a step 2208 of updating the template, as illustrated in FIG. 22.

For example, referring to FIGS. 20A and 20B, a template owner may use the editing interface 2050 to provide instructions for modifying template 2000. These instructions may include the creation of a new column labeled “Budget” within table 2010. Simultaneously, the template owner may define a new permission rule that governs access to this column. The permission rule may authorize editing rights for the “Budget” column exclusively to the owners of the user-facing applications 2110-1 through 2110-M, which implement template 2000. Other users of these applications may thus be restricted from modifying or interacting with the newly added column. The update process thus involves structural changes to the template (e.g., adding a column) and control rights changes (e.g., defining permission rules), which are incorporated into the template configuration and propagated to all relevant user-facing applications.

Some disclosed embodiments involve determining compatibility of each user-facing application with the updated template by analyzing a current state of each of the plurality of user-facing applications. This compatibility check may be part of enforcing the updated template across distributed instances and may aim to prevent or minimize disruptions that may arise due to the changes. Compatibility, as used herein, refers to the degree to which a user-facing application remains functionally aligned with the updated template. Determining compatibility may involve verifying whether the structure, data format, pre-population rules, and other template-dependent features within user-facing applications can accommodate the newly introduced modifications without causing errors, loss of functionality, or misalignment with governance rules.

Different scenarios may arise during this process. In some cases, user-facing applications may strictly adhere to the original template configuration, meaning that updates or modifications to the template are unlikely to disturb their operation. These applications are thus considered compatible and can seamlessly integrate the changes. In other cases, however, user-facing applications may have been customized by their respective owners. Such customizations, especially those that diverge from the template's original structure, may introduce incompatibilities when the template is updated. For example, if a user-facing application includes additional fields, altered logic, or modified layouts that conflict with the updated template, corrective actions may be required before enforcing the updated template such as adapting the user-facing application to restore compliance or isolating it from further template updates. This compatibility may ensure that the integrity of the template is preserved across all instances while maintaining operational stability and minimizing disruption for end users. Process 2200 includes a step 2210 of determining compatibility of user-facing applications with updated templates, as illustrated in FIG. 22.

Some disclosed embodiments involve pushing the updated template to the plurality of user-facing applications integrable with the template by: identifying differences between the updated template and each user-facing application; generating a set of updates that apply only the determined differences to each of the plurality user-facing applications; and applying the set of updates to each of the plurality of user-facing applications. Pushing the updated template to the plurality of user-facing applications refers to the final stage of the enforcement process, where the changes made to the template are actively propagated to all integrated instances. Process 2200 includes a step 2212 of pushing the updated template, as illustrated in FIG. 22.

Identifying the specific differences between the updated template and each user-facing application refers to the process of identifying what elements of each user-facing application need to be modified to align with the updated template. This process may involve comparing the current state of each user-facing application with the revised template to isolate only the relevant changes. Once these differences are identified, a set of updates tailored to each application may be generated. These updates apply only the determined differences, ensuring that unnecessary or unrelated changes are not introduced, and preserve any local customizations that do not conflict with the template. Once the update sets are prepared, they are applied to each user-facing application. This selective and controlled propagation maintains consistency across distributed implementations while respecting the governance model defined by the template owner.

In some embodiments, pushing the updated template to the plurality of user-facing applications includes receiving from the interface a signal for pushing the updated template. This signal may be triggered via an element of the interface, such as a GUI component. For example, referring to FIG. 20B, a signal for pushing updated template 2000 may be received through activation of the “publish changes” button 2052. Additionally, or alternatively, in some embodiments, pushing the updated template to the plurality of user-facing applications includes pushing the updated template while at least some of the plurality of user-facing applications are in use. In such cases, updates may be applied in a non-disruptive manner, ensuring that ongoing user interactions are not interrupted. This may involve queuing the updates for background application, applying changes incrementally, or temporarily locking only the affected components of the application. This approach may allow for seamless propagation of template updates across live environments, maintaining real-time consistency without requiring downtime or manual intervention from end users. It may also ensure that the latest governance rules and structural changes are enforced promptly, even in dynamic or continuously active application instances.

In some embodiments, the set of updates includes, when at least one of the user-facing applications has missed one or more previous template updates, applying only the differences between a most recent template update and the at least one user-facing application. In other words, rather than applying all historical changes, only the differences between the most recent version of the template and the current state of the user-facing application may be identified and applied. This targeted update process may ensure that each application is brought up to date efficiently without reprocessing outdated or already superseded changes. This approach thus aims to avoid any form of update backlog or redundant operations and protects user-facing applications from unnecessary disruptions or overwrites.

In some embodiments, the set of updates includes identifying and preserving user-customized elements within each user-facing application while integrating changes from the updated template. Personalized configurations made by users, such as added fields, renamed columns, or adjusted layouts, are not unintentionally overwritten or lost during the update process. For example, if a user-facing application includes a custom column or automation that is not present in the updated template, and it does not interfere with the new template logic, it may be retained. This approach allows the updated template to be integrated seamlessly while respecting individual user preferences and operational needs. A flexible governance model is thereby supported where centralized control is balanced with localized customization, ensuring that updates enhance functionality without disrupting existing workflows or user experience.

In some embodiments, the set of updates includes adapting structural changes in the updated template to each of the plurality of user-facing applications in a manner minimizing impact of the structural changes on each of the plurality of user-facing applications. Put it differently, a best approach may be determined for applying the updates, taking into account the existing configuration of each application to preserve functionality and user experience as well as minimizing disruption. For example, if a child user-facing application contains additional columns not present in the original template, and the updated template introduces a new column, the new column may be inserted in a position that avoids overwriting or displacing the existing custom columns. Rather than applying a rigid structure, the layout may be evaluated and the new column integrated in a way that maintains coherence. In some embodiments, the order of columns may be determined based on timestamps associated with their creation or last modification, ensuring a consistent and logical arrangement across all instances. This adaptive update mechanism may help maintain the integrity of local customizations while enforcing the latest template structure. By minimizing the impact of structural changes, unnecessary reconfiguration, risk of data loss, or user confusion may be avoided.

In some embodiments, the set of updates includes detecting whether at least one of the plurality of user-facing applications already incorporates one or more modifications included in the updated template and, in response, converting corresponding resources in the user-facing application. When such overlap is identified, corresponding resources may be converted within the user-facing application to align with the updated template, rather than duplicating them. For example, referring to FIGS. 20B and 21, if one of the user-facing applications 2110-1 through 2110-M already includes a “Budget” column in its structure, and the updated version of template 2000 also introduces a “Budget” column, this similarity may be recognized. Instead of creating a second “Budget” column, which would be redundant and potentially confusing, the existing column in the user-facing application is preserved and formally incorporated as part of the template-defined structure. This approach may ensure consistency, avoid unnecessary duplication of features, and preserve user-defined content where appropriate.

In some embodiments, the set of updates further includes detecting dependencies between the updated template and pre-existing configurations in each user-facing application; and applying adjustments to resolve conflicts before integrating the updates into each user-facing application. Dependencies may include relationships between data fields, automation logic, layout structures, or permission rules that have been defined locally within a user-facing application. When a newly introduced element in the updated template that overlaps or interacts with an existing configuration is detected, the nature of the dependency may be evaluated to determine whether a conflict exists. Targeted adjustments may be applied to resolve these conflicts before proceeding with the update. For example, if a user-facing application has a custom automation tied to a column that is being redefined in the updated template, the automation logic may be adapted to align with the new structure or preserve it in a way that avoids disruption. Similarly, if naming conflicts or structural overlaps are detected, elements may be renamed, merged, or repositioned to maintain consistency and prevent errors.

The determination of differences and the generation of a corresponding set of updates may be performed by analyzing both the updated template and each individual user-facing application. In particular, this analysis may involve processing the relationships and metadata associated with these entities. As mentioned throughout this disclosure, metadata serves as the connective tissue that links the template to the plurality of user-facing applications. Metadata may enable tracking of structural alignment, permission configurations, and automation logic across distributed instances. Additionally, metadata may act as a unique fingerprint for each user-facing application, providing insight into its level of customization, automation structures, and operational complexity. By leveraging metadata, how each application deviates from or conforms to the template may be assessed, potential conflicts identified, and an efficient and non-disruptive way to apply updates may be determined. This metadata-driven approach may support a dynamic and scalable enforcement model, ensuring that template updates are integrated seamlessly while preserving the integrity and individuality of each user-facing application.

In some embodiments, the analysis of metadata, and by extension how the set of updates is being determined and applied may be performing using at least in part artificial intelligence (AI) techniques or other computational methods executed by a processor. AI models may be trained to recognize patterns and relationships within metadata, enabling structural alignment, conflicts detection, and identification of the level of customization or automation in a user-facing application. Alternatively, rule-based algorithms or heuristic logic may be used to systematically evaluate metadata attributes, such as timestamps, field types, dependencies, and permission settings, to support accurate and efficient update integration.

Some disclosed embodiments involve inputting the differences between the updated template and each user-facing application into an AI agent. The AI agent processes the differences with to ascertain consequences for each user-facing application resulting from the updated template. This analysis includes evaluating how structural changes, permission updates, or data format modifications could affect the functionality, layout, or automation logic of the user-facing application. Based on this assessment, the AI agent develops a textual explanation of the consequences of the updated template. The textual explanation may outline the impact of the update, and describe what has changed, why the change matters, and how it may affect the user's experience or operational workflows. For example, it may highlight whether certain features will be restricted, enhanced, or restructured as a result of the update. Once the explanation is generated, a notification to an owner of each user-facing application is sent. The notification is configured to provide the textual explanation of consequences of the updated template, allowing the owner to understand the implications of the update and take any necessary action. This process may support informed decision-making and help maintain trust in the governance model defined by the template owner. In some embodiments, notifications may be sent not only to the owner of each user-facing applications, but also to any of the respective users. Referring to FIG. 20C, the notification sent to the owner of a user-facing application may include a textual explanation presented in the form of release notes. Consistent with the disclosed embodiments, such release notes may be generated by an AI agent configured to analyze the differences between the updated template and the current state of the user-facing application. Each user-facing application may have a distinct level of customization, meaning the differences between the updated template and each user-facing application may vary significantly. Accordingly, the textual explanation may be adapted to reflect the specific impact of the update on each individual application.

Additionally, in some embodiments sending the notification occurs while the updated template is pushed or after the updated template is pushed. When sent during the push/enforcement process, the notification may serve as a real-time alert, allowing user-facing application owners to anticipate and prepare for the changes as they are being applied. Alternatively, sending the notification after the update may ensure that the user-facing application owner receives a complete and accurate summary of the final state of the user-facing application post-update. In both cases, the timing of the notification may be designed to support transparency and informed decision-making, helping users understand the impact of the update and take any necessary follow-up actions.

As will be appreciated from the foregoing, some of the disclosed embodiments relate to the use of templates as a mechanism for enabling standardization through a top-down approach, wherein such templates provide centralized governance, a predefined structure, and real-time updates. Templates, however, represent only one manner of achieving standardization, and alternative approaches may be employed. One such alternative relies upon the use of a schema.

In the context of the present disclosure, a schema refers to as a structure-less entity, namely, a set of requirements that are independent of any specific underlying data structure, yet which can be applied uniformly to data sets originating from a plurality of differently structured databases, data structures, or associated user-facing applications. The role of such requirements may be to ensure the consistent management, organization, and interpretation of data across disparate systems, irrespective of the native architecture of those systems, the particular arrangement of the data, or the formats employed. Thus, a schema may operate as a logical overlay, abstracting the definition of entities, attributes, and relationships away from any particular storage model and thereby allowing heterogeneous data to be aggregated and processed consistently. In this regard, a schema may be conceived as functioning in the manner of a translator or interoperability layer, enabling data structures that may otherwise be divergent or incompatible to communicate, exchange information, and operate in a unified manner. Unlike templates, which impose a visible and surface-level structure at the point of use, schemas operate at the data level, abstracting the rules of organization from the physical structure itself. By so doing, schemas confer both flexibility and coherence across different databases.

Schema may or may not be implemented within a SaaS platform. Both approaches, namely schemaless and schema-first platforms, are known to present respective advantages and disadvantages. In a schemaless platform, users are permitted to construct without adherence to any predefined data model. Such an approach affords considerable freedom, enabling individuals or teams to create and iterate rapidly on their own terms, without dependence upon an implementation team or extensive upfront planning. This freedom, however, is frequently obtained at the expense of scalability and standardization. Each workspace, board, or other database-like entity, by operating as an isolated unit with its own implicit set of rules, tends to diverge from others, producing inconsistencies in terminology, labeling, and structure. For instance, one IT team may denote a software defect as a “bug,” while another designates the same phenomenon as an “error.” Such divergence complicates downstream reporting and cross-functional collaboration. Although organizations may attempt to introduce standardization retrospectively by e.g., by imposing a certain number of rules or definitions, such post hoc reconciliation is difficult to enforce due to human variability. Each database-like entity thus operates effectively as a silo, with its own definitions, providing high flexibility at the micro level but introducing inconsistency at the macro level and complicating efforts to generate aggregated or high-level reports across the organization.

By contrast, schema-first platforms embody the reverse philosophy. Such platforms require the definition of data entities, attributes, and interrelationships in advance of the creation of any database-like entity. While this approach confers the benefit of structural consistency and semantic alignment across all implementations, it may involve more upfront planning, technical oversight, and administrative control, which may result in slow deployment, reduce adaptability, and increase the barrier to entry for less technical users. As a result, the schema-first model, though effective for long-term governance, may constrain the flexibility necessary for dynamic or fast-moving environments.

The embodiments disclosed herein seek to bridge the gap between the schemaless and schema-first paradigms. In particular, the disclosed embodiments permit users to build database-like entities without enforcing a rigid schema upfront, thereby preserving ease of adoption and user freedom, while also introducing schema-based standardization mechanisms that can be progressively applied in order to support scalability, interoperability, and enterprise-level reporting. In this manner, the disclosed approach combines the adaptability of schemaless design with the structural coherence of schema-first systems, thereby providing a hybrid model suitable for both individual and organizational use cases.

Within the scope of the present disclosure, the term schema refers to a structure-less logical abstraction and is not to be confused or conflated with the conventional notion of a database schema employed in traditional database or in a schema-first platform. A traditional database schema specifies a fixed organization of data within a database, defining tables, columns, data types, relationships, and constraints. For example, a backend relational database typically employs a schema that dictates the columns present, the permissible data types, and the organization of rows. In contrast, the schema disclosed herein is not bound to a particular storage model or database structure. Instead, it exists as an abstract, flexible set of requirements that may be applied across disparate and heterogeneous systems. By abstracting the principles of data organization away from the underlying architecture, the disclosed schema provides a unifying interpretive layer that enables consistency, translation, and cross-database coherence, even where the native data structures themselves remain divergent.

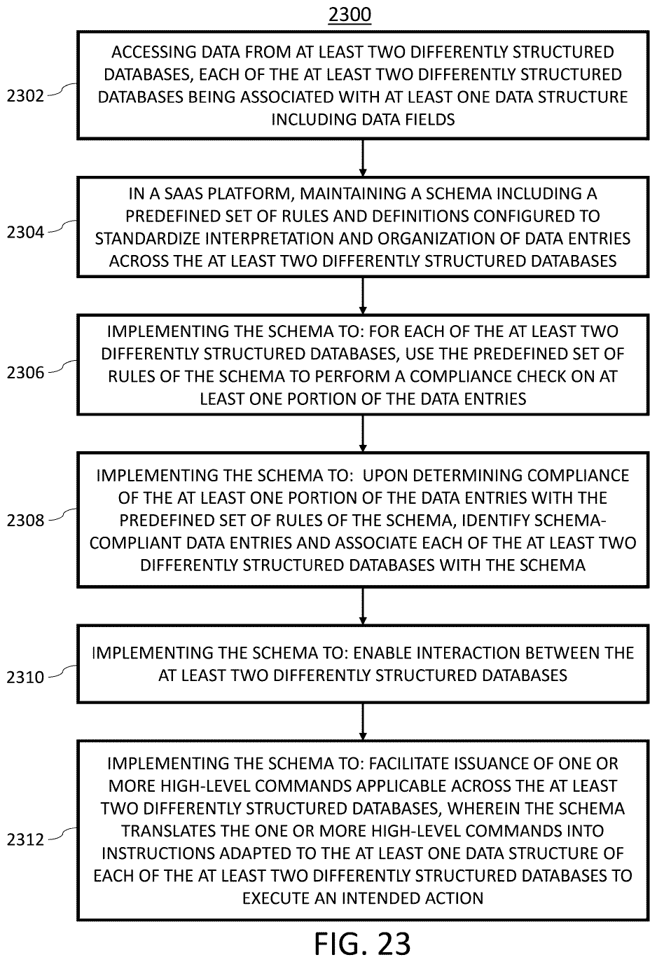

FIG. 23 is a flowchart of an exemplary process 2300 for consolidating data from multiple data sources, consistent with some of the disclosed embodiments. Process 2300 is discussed herein for explanatory purposes and is not intended to be limiting. In some embodiments, steps of process 2300 may be changed, modified, substituted, or rearranged, consistent with the present disclosure. Process 2300 may be implemented using one or more components of a computing device 200 (discussed in FIG. 2A) or user device 254 of computing architecture 250 (discussed in FIG. 2B). Some disclosed embodiments may include at least one processor that may be configured to execute stored instructions to perform operations for consolidating data from multiple data sources. As shown in FIG. 23, process 2300 may include steps 2302, 2304, 2306, 2308, 2310, and 2312, discussed in further detail below.

Some disclosed embodiments involve accessing data from at least two differently structured databases, each of the at least two differently structured databases being associated with at least one data structure including data fields. The term “database” is to be understood broadly and is not limited to traditional relational or non-relational database management systems. Rather, as used herein, a database may encompass any system, repository, or construct that maintains and organizes data, including but not limited to backend storage systems, cloud-based storage layers, or SaaS platform elements such as boards, workspaces, workflows, projects, or any other organizational unit in which information is captured and stored in association with defined fields or attributes.

Each such database may be associated with at least one data structure, wherein the term “data structure” as used in the present disclosure is distinct from the earlier notion of a database schema. A database schema, as previously described, represents a fixed, prescriptive model that governs the permissible organization of data, defining in advance the tables, fields, relationships, and constraints. By contrast, a data structure, as used herein, refers to the physical and logical organization of data elements as they exist within a given database at a particular point in time. A data structure may be considered descriptive rather than prescriptive: it reflects how data is actually arranged, related, and stored, whether in rows and columns, key-value pairs, objects, graphs, or other forms, without necessarily imposing governance rules over that organization. In this sense, a data structure may be understood as a snapshot or instantiation of how data within a database is represented and interconnected.

Two or more databases are said to be differently structured when their respective data structures are not the same and diverge in one or more respects. Such divergence may manifest in differences in entity definitions, field names, attribute sets, permissible values, relationships, or data formats.

Accessing data from at least two differently structured databases refers to the act of retrieving, querying, or otherwise obtaining data elements or records from such databases, regardless of their native organization or format. Accessing data may involve, without limitation, issuing queries, invoking application programming interfaces (APIs), reading directly from storage, or utilizing system-provided connectors, adapters, or integration mechanisms, and may be performed for purposes of processing, transforming, reconciling, analyzing, aggregating, or reporting across disparate databases. Process 2300 includes a step 2302 of accessing data from at least two differently structured databases, as illustrated in FIG. 23.

In some embodiments, the at least two differently structured databases may be, at least initially, unrelated. By “unrelated,” it is to be understood that the databases exist independently of one another, without any prior notion of dependency, integration, or linkage. Even in cases where two databases store information of a similar nature or concerning overlapping subject matter, such databases are nevertheless considered unrelated unless explicit relationships are defined, such as the presence of shared keys, foreign key references, predefined mappings, or other structural linkages that directly connect the two.

Furthermore, in some embodiments, the at least two differently structured databases are, at least initially, maintained without adherence to or governance by any shared schema. In such circumstances, each database may operate autonomously, with its own local data structure, conventions, and organization, absent a unifying model that dictates consistency or interoperability across them. As a result, these databases, while potentially useful in isolation, cannot natively be queried, aggregated, or interpreted together in a coherent manner.

As further described herein, the disclosed embodiments provide mechanisms by which such unrelated and independently structured databases may be associated with one another. More particularly, databases that are initially unrelated and that lack a shared governing schema may be reconciled through the application of a schema disclosed herein. By subjecting such databases to the rules, requirements, and definitions of the disclosed schema, associations may be dynamically established between them, thereby enabling interoperability, unified reporting, and coherent interpretation across what were previously siloed, heterogeneous, and ungoverned data sources.

In some embodiments, the at least two differently structured databases include two databases including identical data entries located at different positions within the databases. Identical or overlapping data entries may also be represented under different field names or organized according to different conventions. However, even in such scenarios, the at least two databases may still be regarded as initially unrelated, insofar as no explicit structural linkage, key relationship, or governing schema exists between them. In other words, mere coincidence or duplication of data content does not, by itself, establish a relationship between databases absent a defined association mechanism.

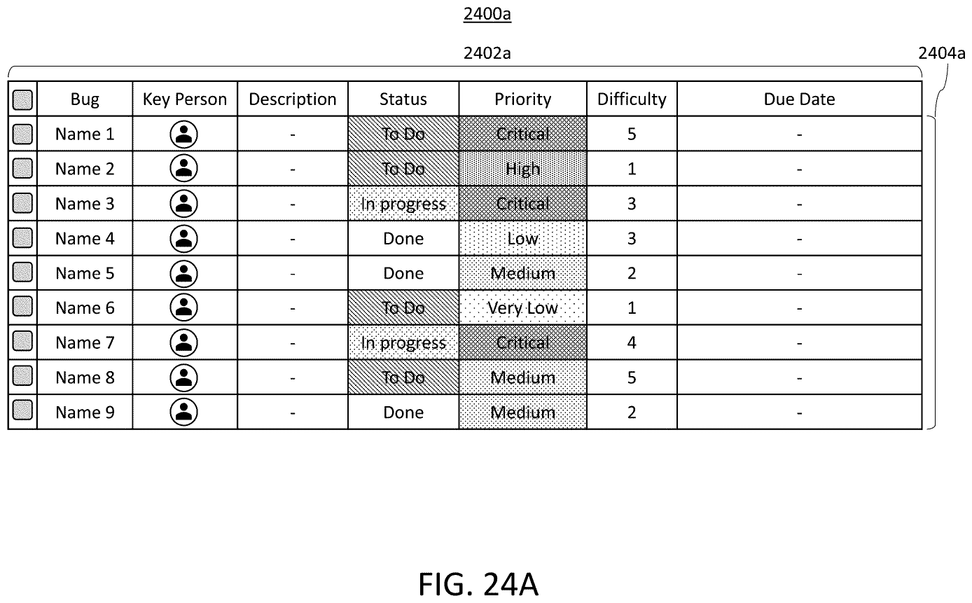

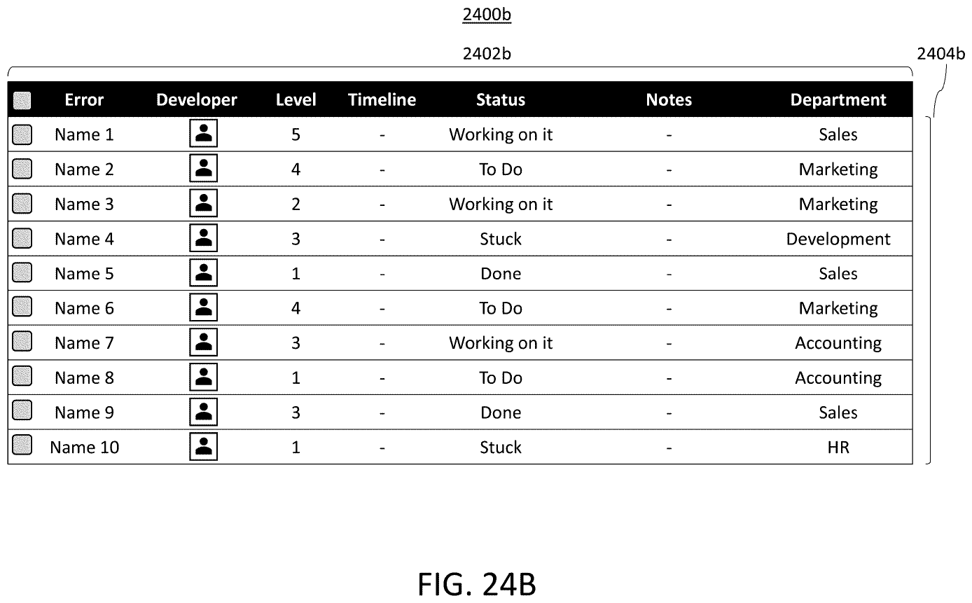

FIGS. 24A and 24B illustrate two exemplary differently structured databases 2400a and 2400b, consistent with the disclosed embodiments. Both databases 2400a and 2400b are represented in the form of a table, including columns (respectively 2402a and 2402b) and rows (respectively 2404a and 2404b). Each database is associated with a respective IT team, with database 2400a corresponding to IT Team A and database 2400b corresponding to IT Team B, each responsible for tracking the number of bugs or errors identified within their purview. Although IT Team A and IT Team B perform substantially the same operational task, namely, resolving software defects, their associated databases differ because each team belongs to a different organizational unit (e.g., a distinct department, antenna, or geographic location such as a different country). Consequently, the teams employ different terminology and different database structures to track their mission.

As shown in FIGS. 24A-24B, the differences between databases 2400a and 2400b extend beyond visual appearance and manifest at the level of their respective data structures. By way of example:
Terminology differences: IT Team A tracks “Bugs,” whereas IT Team B tracks “Errors.” IT Team A associates a “Key Person” with a bug, while IT Team B associates a “Developer”. IT Team A associates “Priority” with each bug, while IT Team B associates “Level” with each error. IT Team A assigns a “Due Date,” while IT Team B employs a “Timeline.”
Structural and positional differences: Even where the natures of information captured are similar, the structure and order of the data fields differ. For example, the “Status” field in database 2400a is located in a different position than the “Status” field in database 2400b. Likewise, “Description” in database 2400a is not aligned with “Notes” in database 2400b, and “Priority” in database 2400a is located differently relative to “Level” in database 2400b. Certain fields may exist in one database but not in the other; for instance, database 2400a contains a “Difficulty” field absent from database 2400b, and database 2400b contains a “Department” field absent from database 2400a.
Data type differences: In some cases, two fields capture the same conceptual information but employ different data types. For example, database 2400a records “Priority” as a textual label (e.g., “Critical,” “High,” “Medium,” “Low,” “Very Low”), whereas database 2400b records “Level” as a numerical score from 1 to 5, with 1 representing the highest level.
Value-set differences: Even when two fields share the same name and employ the same datatype, their possible values may differ. For example, both databases 2400a and 2400b include a “Status” column represented by textual labels. However, database 2400a supports three values (“To Do,” “In Progress,” and “Done”), while database 2400b supports four values (“To Do,” “Working on it,” “Stuck,” and “Done”).

In light of these variations, aggregating data from databases 2400a and 2400b into a unified report presents substantial challenges. For example, an overarching IT manager seeking to determine the total number of resolved/unresolved defects across both IT Team A and IT Team B may be required to manually review and reconcile the respective databases, accounting for differences in terminology, field definitions, and value sets. Such reconciliation is time-consuming, error-prone, and inefficient. As will be described in further detail below, the disclosed embodiments overcome these challenges by applying a schema that operates as a unifying abstraction layer. Through the use of such a schema, the process of aggregating, standardizing, and reporting across differently structured databases such as 2400a and 2400b may be streamlined, thereby enabling standardization, coherent cross-team reporting, and analysis without requiring manual reconciliation of heterogeneous database structures.

Some disclosed embodiments involve, in a SaaS platform, maintaining a schema including a predefined set of rules and definitions configured to standardize interpretation and organization of data entries across the at least two differently structured databases. As described above, the term “schema,” as used herein, refers to a structure-less logical abstraction and is distinct from a conventional database schema, and functions as an abstract overlay independent of any particular physical or logical structure. The rules and definitions of the schema define the requirements that a database and its associated data entries need or should satisfy in order to be associated with the schema. Such requirements may include, without limitation, the presence of certain mandatory data fields, the expected data types for each field (e.g., text, number, link, date), and constraints on the characteristics or relationships of the data entries. For example, a schema may specify that a database must include at least three fields, “A,” “B,” and “C”, corresponding to data types text, number, and link, respectively. Additional rules may specify optional fields, allowable ranges of values, or other semantic or structural requirements necessary for coherent interpretation across systems. Once a database satisfies the rules and definitions of the schema, mapping, association, or integration of data from multiple databases may be performed in accordance with the schema. In this manner, the schema establishes the conditions under which heterogeneous databases can be meaningfully associated, and the actual process of mapping or reconciling data entries occurs in accordance with these predefined rules and definitions. In this context, maintaining a schema within a SaaS platform refers to the storage, management, and application of the predefined rules and definitions that constitute the schema. Such maintenance may include ensuring that databases and their data entries satisfy the schema's requirements, updating the schema as needed, and applying the schema to facilitate the association or mapping of data across differently structured databases. By maintaining such a schema, the SaaS platform may provide a standardized framework for validating, organizing, and harmonizing data across differently structured databases, enabling aggregation, reporting, and analysis without imposing a rigid database-specific structure. Process 2300 includes a step 2304 of maintaining a schema including a predefined set of rules and definitions, as illustrated in FIG. 23.

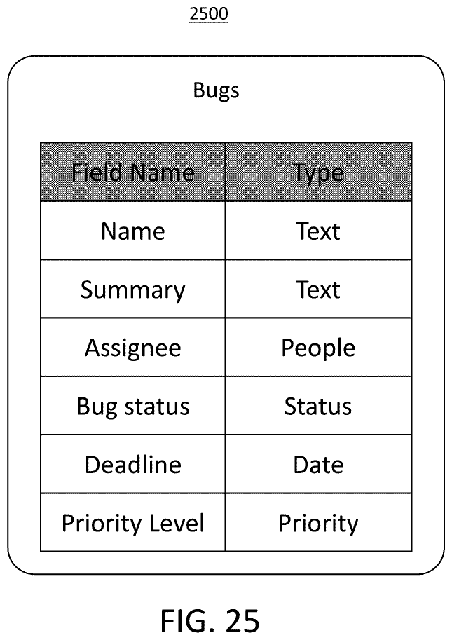

FIG. 25 is an illustration of a schema 2500 comprising a predefined set of rules and definitions, consistent with the disclosed embodiments. Schema 2500 corresponds to a bug schema entity, which defines a plurality of data fields and associated data types that a database is required to include in order to be associated with the bug schema entity. Specifically, to be associated with the bug schema entity, a database must include at least six data fields: a “Name” data field of type “text”, a “Summary” data field of type “text”, an “Assignee” data field of type “people”, a “Bug Status” data field of type “status”, a “Deadline” data field of type “date”, and a “Priority Level” data field of type “priority”. Certain specialized data types, such as people, status, and priority, may impose additional constraints on the data entries (e.g., a list of potential values). For example, the “people” data type may require that at least one individual from the IT employee team be entered. The “status” data type may require that the data entry correspond to a predefined set of options, such as “Resolved” or “Not Resolved.” Similarly, the “priority” data type may require that the data entry correspond to one of a predefined set of levels, such as “High,” “Medium,” or “Low.” Schema 2500 may be maintained within a SaaS platform, and as described further below, may be implemented to enable the association of one or more databases therewith.

All of the data fields illustrated in FIG. 25 are associated with a single schema entity, namely the Bug entity. However, a schema is not limited to a single entity and may include multiple schema entities, each defining its own set of required data fields, data types, and associated rules and definitions. It is further appreciated that a schema may define relationships between different data fields within a schema entity. Specifically, one or more rules may exist that govern interdependencies between data fields, such that the value or content of a first data field can influence or constrain the allowable values, options, or interpretation of a second data field.

In some embodiments, the schema is data structure agnostic, meaning that the rules, definitions, and relationships defined may be independent of any underlying physical or logical database architecture. In other words, the schema may not rely on a specific table layout, column order, storage format, or platform-specific implementation. Instead, the schema may provide an abstract, flexible framework capable of standardizing, validating, and organizing data across heterogeneous databases, regardless of differences in their native data structures, storage models, or organizational conventions. For example, schema 2500 does not require that the column associated with the “Name” data field be positioned relative to the column associated with the “Summary” data field. Moreover, schema 2500 does not mandate that data fields be represented as columns at all. A database may employ a variety of storage structures or formats, including, without limitation, relational tables, spreadsheets, key-value stores, hierarchical trees, graph structures, JSON objects, CSV files, or other structured or semi-structured formats, so long as the data fields and corresponding data entries are identifiable and may be associated with the schema. In this manner, the schema provides a flexible, abstract framework capable of accommodating heterogeneous data representations while preserving standardization, validation, and interoperability across multiple databases.

Some disclosed embodiments involve implementing the schema to, for each of the at least two differently structured databases, use the predefined set of rules of the schema to perform a compliance check on at least one portion of the data entries. As used herein, a compliance check refers to the process of determining whether a database or a subset of its data entries is compatible with the schema, and therefore eligible to be associated with the schema for purposes of integration, aggregation, or standardized interpretation. Databases that pass the compliance check may be deemed compliant, while those that fail may be rejected, flagged for modification, mapping adjustments, or other corrective actions to ensure alignment with the schema. In some embodiments, the compliance check with the predefined set of rules included in the schema is performed in real time as new data entries are added to the at least two differently structured databases, at the time of database registration, or periodically as part of ongoing maintenance of the schema within the platform. Process 2300 includes a step 2306 of implementing the schema to use the predefined set of rules of the schema to perform a compliance check on at least one portion of the data entries, as illustrated in FIG. 23. Referring to FIGS. 24A and 25, a compliance check on at least a portion of the data entries of database 2400a and 2400b may be performed using the set of rules and definitions included in schema 2500.

In some embodiments, performing the compliance check may include verifying that the least one portion of the data entries of each of the at least two differently structured databases fits the predefined set of rules of the schema. In other words, the determination of whether the data entries satisfy the requirements for field presence, data type, allowable values, or other constraints specified by the schema may be performed, thereby confirming that the database or at least its subset of data entries is eligible to be associated with the schema. Additionally, or alternatively, in some embodiments, performing the compliance check includes running the predefined set of rules to identify matching inputs in the least one portion of the data entries of each of the at least two differently structured databases. In this case, the compliance check may not only validate adherence to the schema rules, but also identify specific data entries that correspond to the schema's definitions, such as entries that conform to the expected fields, types, and allowable values.

In some embodiments, a compliance check may be performed on only a portion or on the entirety of the at least two differently structured databases. By default, performing a compliance check on the entire database may be preferred in order to maximize the likelihood of identifying data entries that are compliant with the schema. However, it may also be the case that the owner of a database has imposed certain permission rules or access restrictions on specific portions of the database (e.g., a partially private database). Accordingly, those restricted portions may not be accessible to the schema and, as a result, may not be eligible for integration, aggregation, or reporting with other databases. In such cases, the compliance check is limited to the accessible portions of the database while still enabling association and standardized interpretation of the available data.

In some embodiments, data entries of different types match one rule of the predefined set of rules. In other words, data entries associated with a particular data field may be recognized as compliant with a schema rule even if they do not strictly conform to every requirement, such as belonging to a closed set of permissible values. Put differently, the requirements imposed by the schema on a data entry may be less stringent than the mere presence of a corresponding data field. For example, referring to FIGS. 24A-25, the Priority data field and its associated entries in database 2400a, and the Level data field and its associated entries in database 2400b may both match the rule of schema 2500 associated with the Priority Level data field. This may occur even though neither the entries in database 2400a nor the entries in database 2400b strictly conform to the closed list imposed by the Priority data type (e.g., textual labels “High,” “Medium,” or “Low”). Furthermore, the data entries may be of different types, textual labels in database 2400a versus numerical values ranging from 1 to 5 in database 2400b. Slight discrepancies in data types or representations of data entries do not necessarily prevent compliance with the schema. Such discrepancies may be resolved or normalized during the mapping stage, in which data entries from heterogeneous databases are associated with the schema and translated into a consistent format. Accordingly, a compliance check may recognize that data entries from different databases correspond to the same schema category, even if their values or types differ, thereby enabling subsequent association, aggregation, and standardized interpretation across heterogeneous systems.

Some disclosed embodiments further involve, when at least one of the at least two differently structured databases fails to pass the compliance check, identifying one or more issues with the predefined set of rules of the schema and suggesting one or more actions to resolve the one or more issues. Such issues may arise, for example, when a required data field is absent, when a data entry does not conform to the expected data type, or when values within a data field fall outside of the permissible or anticipated range defined by the schema. Upon identifying such issues, one or more corrective or remedial actions to resolve the noncompliance may be suggested. For example, suggested actions may include, but are not limited to, adding a missing required data field to the noncompliant database, converting or normalizing data entries into an acceptable format (e.g., converting numeric codes to standardized text labels), mapping a noncompliant data field to an equivalent schema-recognized field, or relaxing or updating the rules of the schema to accommodate an alternative but semantically equivalent representation of the data. In this manner, the disclosed embodiments not only facilitate the detection of schema noncompliance but also actively support remediation and harmonization, thereby enabling disparate and initially noncompliant databases to ultimately be associated, standardized, and made interoperable under the schema framework.

Some disclosed embodiments involve implementing the schema to, upon determining compliance of the at least one portion of the data entries with the predefined set of rules of the schema, identify schema-compliant data entries and associate each of the at least two differently structured databases with the schema. As used herein, the term identify schema-compliant data entries refers to the process of determining which data fields and associated entries within a database meet the requirements set forth by the schema. Such identification may include, for example, recognizing that a given data field corresponds to one of the schema's predefined data fields and that its associated entries conform (either directly or through normalization) to the expected data type or permissible value set. Process 2300 includes a step 2308 of implementing the schema to identify schema-compliant data entries and associate each of the at least two differently structured databases with the schema, as illustrated in FIG. 23.

In some embodiments, identifying schema-compliant data entries involve mapping data fields and associated entries of the at least two differently structured databases with the predefined set of rules and definitions included in the schema. As used herein, the term mapping refers to the process of creating a correspondence between the data fields and associated entries of a database, on the one hand, and the predefined set of rules and definitions included in the schema, on the other hand. Such mapping enables heterogeneous data structures, which may differ in terminology, data type, permissible values, or organizational conventions, to be reconciled and aligned under a unified schema framework.

In some embodiments, mapping may take different forms depending on the characteristics of the database and the requirements of the schema. For example, in some embodiments, one schema-compliant data field/possible value may correspond to one data field/entry included in the at least two differently structured databases. In other words, mapping may involve a one-to-one correspondence, in which a particular schema field of a given data type is directly associated with a single database field of a matching or compatible type. Alternatively, in some embodiments, one schema-compliant data field/possible values corresponds to two or more different data fields/entries included in the at least two differently structured databases. In other words, mapping may involve a many-to-one correspondence, in which multiple database fields and/or values are normalized and associated with a single schema field/potential value.

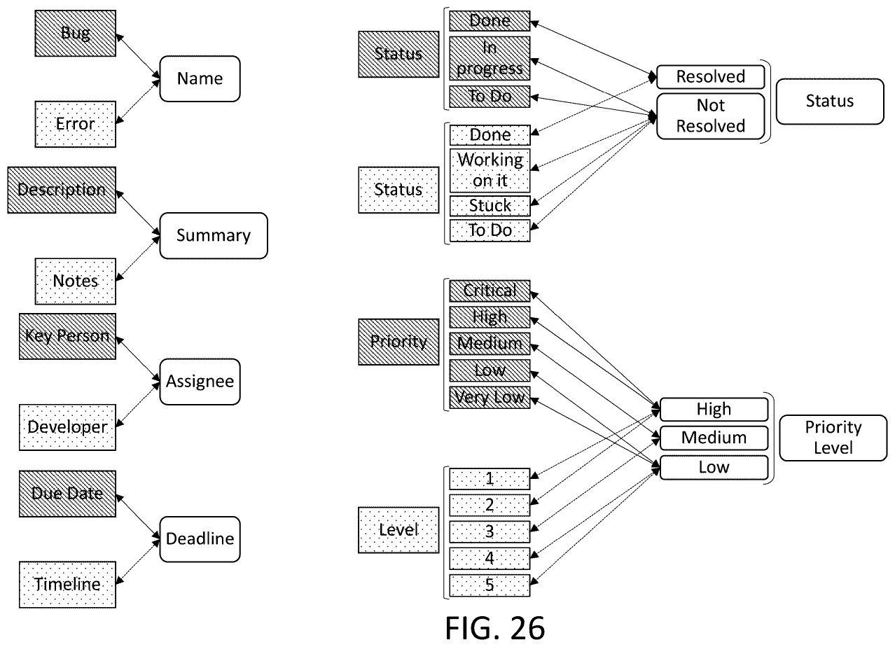

FIG. 26 is a schematic illustration of the mapping process between schema 2500 and databases 2400a and 2400b, consistent with the disclosed embodiments. In this illustration, the data fields of database 2400a are represented using a high-density dotted pattern, while the data fields of database 2400b are represented using a low-density dotted pattern. The data fields of schema 2500 are represented without any pattern to visually distinguish them from the database fields. Mapping relationships between the data fields of database 2400a and the corresponding data fields of schema 2500 are depicted with solid double-headed arrows, whereas mapping relationships between the data fields of database 2400b and the corresponding data fields of schema 2500 are depicted with dashed double-headed arrows. As previously noted, for certain schema data fields, there may exist a one-to-one correspondence with database fields and their associated entries. For example, as illustrated in FIG. 26, the schema “Name” data field is mapped to the “Bug” data field of database 2400a and to the “Error” data field of database 2400b. Similarly, the schema “Deadline” data field is mapped to the “Due Date” data field of database 2400a and to the “Timeline” data field of database 2400b. In other cases, for certain database fields, or more specifically, for certain predetermined values of the entries, it may be the case that a many-to-one correspondence exists between the database fields and associated entries and the schema data field and its permissible entries. For example, as illustrated in FIG. 26, the schema data field “Status” may be defined with only two possible entries, namely “Resolved” and “Not Resolved.” However, neither database 2400a nor database 2400b incorporates such a binary status list in their respective “Status” columns. Instead, database 2400a includes three possible statuses (“To Do,” “In Progress,” and “Done”), while database 2400b includes four possible statuses (“To Do,” “Working on It,” “Stuck,” and “Done”). Accordingly, a many-to-one correspondence is established between the status values of databases 2400a and 2400b and the status values of schema 2500. For instance, in database 2400a, both “To Do” and “In Progress” may be associated with the schema's “Not Resolved” status, while “Done” may be associated with the schema's “Resolved” status. Similarly, in database 2400b, the values “To Do,” “Working on It,” and “Stuck” may be associated with the schema's “Not Resolved” status, while “Done” is associated with the schema's “Resolved” status. A similar many-to-one mapping exists for the Priority/Level fields of databases 2400a and 2400b. Each of these databases supports five distinct priority values, whereas the schema 2500 defines only three possible entries for the “Priority Level” data field. Accordingly, the five levels of priority in the databases may be collapsed into three categories by mapping multiple database values into a smaller set of schema-compliant values.

In some embodiments, identifying schema-compliant data entries is performed using a machine learning model trained to identify common patterns in unlabeled data fields. A machine learning (ML) model configured to detect and classify common patterns in unlabeled or inconsistently labeled data fields may leverage techniques including, but not limited to, natural language processing (NLP) to interpret column names, semantic similarity analysis to compare field labels, or statistical pattern recognition to analyze the distribution and type of data entries. For example, the ML model may learn that database fields labeled as “Due Date,” “Timeline” are likely candidates for mapping to a schema-defined “Deadline” field, even if the labels and value formats differ. Likewise, the model may infer that a numeric field with values ranging from 1 to 5 corresponds to a schema-defined “Priority Level,” despite the absence of explicit labeling. Alternatively, in some embodiments, the mapping may be performed manually by a user or administrator wishing to associate a given database with a schema. In such cases, an interface may be provided through which the user may select the appropriate correspondences between database fields and schema-defined fields based on domain knowledge or operational requirements. In some embodiments, a hybrid approach may be employed, wherein a machine learning model first generates candidate mappings, which are then presented to the user for confirmation, modification, or refinement. This combination of automated inference and human validation may enable both scalability and accuracy, reducing manual effort while ensuring that the mappings reflect the intended semantics of the underlying data.

After identifying schema-compliant data entries, the at least two differently structured databases may be associated with the schema. Associating each database with the schema refers to the establishment of a logical linkage between the database and the schema framework. Once such an association is established, the database can be interpreted, queried, and integrated in accordance with the standardized rules of the schema, rather than on the basis of its native structure or terminology. This association effectively transforms heterogeneous and independently structured databases into interoperable entities governed by a unified schema, thereby enabling consistent aggregation, reporting, and interaction.

In some embodiments, the association within the schema is independent of locations of data fields within the at least two differently structured databases. As previously described, a schema may be data structure agnostic, meaning that it does not rely on the physical or logical arrangement of fields within a database in order to establish a valid association. Accordingly, the relative ordering, positioning, or formatting of data fields, such as whether a “Status” field appears as the first column, the last column, or in the middle of a table, is irrelevant to determining schema compliance. More generally, the location of schema-compliant data entries within the database has no bearing on the establishment of a logical linkage with the schema. Instead, association may be based solely on whether the database contains fields and entries that satisfy the predefined rules and definitions of the schema, regardless of how those fields are stored or represented. For example, in one implementation, a schema “Deadline” field may successfully map to a database field labeled “Due Date,” irrespective of whether that field is stored in column one, column ten, or nested within a JSON object.

In some embodiments, each of the at least two differently structured databases associated with the schema includes schema-compliant data entries and non-schema-compliant data entries. Put differently, it is not a necessary requirement that all data fields and their associated entries within a given database conform to the predefined rules and definitions of the schema. Instead, the disclosed embodiments allow for partial compliance, whereby a subset of the database fields and entries meet the schema requirements while others do not. For example, referring to FIGS. 24A-24B, neither the “Difficulty” data field of database 2400a nor the “Department” data field of database 2400b corresponds to any of the data fields defined by schema 2500. As such, these fields and their entries are considered non-schema-compliant. Nonetheless, both databases 2400a and 2400b may still be validly associated with schema 2500, as long as they contain the required schema-compliant fields (e.g., “Name,” “Summary,” “Assignee,” “Status,” “Deadline,” and “Priority Level”).

In some embodiments, associating each of the at least two differently structured databases with the schema includes associating an entirety of each of the at least two differently structured databases, and wherein the entirety of each of the at least two differently structured databases may be accessible within the schema. In this manner, every portion of the database, including schema-compliant and non-schema-compliant entries, may be referenced, interpreted, or aggregated according to the schema rules and definitions. Alternatively, in some embodiments, only a portion of the at least two differently structured databases may be associated with the schema. This scenario may arise, for example, if certain portions of the database are subject to privacy restrictions, access permissions, or other security rules that prevent their exposure. Similarly, portions of the database containing non-schema-compliant entries for which there is no interest in standardization, mapping, or aggregation may be excluded from the schema association. In such cases, the schema may operate on the accessible or relevant subset of the database, enabling partial integration while respecting privacy, operational constraints, or the presence of irrelevant data.

Some disclosed embodiments further include, after association of each of the at least two differently structured databases with the schema, maintaining the association of each of the at least two differently structured databases by updating the mapping. As used herein, maintaining the association refers to the ongoing management of the logical linkage between a database and the schema. Maintaining the association may include, without being limited to, keeping a persistent record of the established association, monitoring the database for changes that could affect schema compliance, and updating the mapping when necessary. For example, if a database field is added, removed, or modified in a way that violates the schema rules, the system may alert an administrator, trigger a re-evaluation of compliance, or automatically update the mapping to preserve alignment with the schema. Maintaining the association may also involve tracking historical changes, ensuring that previously mapped data entries continue to correspond correctly to schema-defined fields, and supporting consistent interpretation, aggregation, and reporting across heterogeneous databases over time. By continuously maintaining the association, the disclosed embodiments ensure that databases remain interoperable with the schema even as their contents evolve, while preserving standardization and compliance.

Some disclosed embodiments involve implementing the schema to enable interaction between the at least two differently structured databases. As used herein, interaction refers to the ability of the databases to be logically related, coordinated, or leveraged in combination through their association with the schema. Once associated with a common schema, the databases, despite differences in structure, terminology, or data type, may be aggregated, queried, compared, or otherwise operated upon as if they share a unified framework. For example, interaction may include combining data entries from multiple databases to generate consolidated reports or analyzing trends across different databases. Interaction may further enable cross-database operations, such as linking related entities, identifying duplicates, or propagating updates according to schema-defined relationships. The schema may therefore provide a semantic bridge that transforms independently structured databases into interoperable data sources, allowing coordinated access, interpretation, and manipulation of data entries without requiring restructuring of the underlying databases. Process 2300 includes a step 2310 of implementing the schema to enable interaction between the at least two differently structured databases, as illustrated in FIG. 23.

Some disclosed embodiments involve implementing the schema to facilitate issuance of one or more high-level commands applicable across the at least two differently structured databases, wherein the schema translates the one or more high-level commands into instructions adapted to the at least one data structure of each of the at least two differently structured databases to execute an intended action. As used herein, a high-level command refers to an abstract or schema-level instruction specifying a desired operation or analysis on the data, without requiring knowledge of underlying structure, format, or implementation details of the individual databases. Examples of high-level commands include, but are not limited to, aggregating data, filtering entries based on specific criteria, updating fields, generating reports, calculating statistics, or performing cross-database comparisons. The schema may be configured to translate each high-level command into instructions that are adapted to the specific data structures of each of the at least two differently structured databases, such that the intended action can be executed correctly in each database. For example, if a high-level command requests the aggregation of data to count the number of occurrences of a particular entry, the schema may translate this command to identify the appropriate fields and/or entries in each database, regardless of differences in column names, data types, or layouts, and then execute the counting operation on the relevant data in each database. Similarly, a high-level command to filter entries by status or priority may be translated into corresponding operations on differently labeled or structured fields in each database, while maintaining semantic consistency. In this manner, the schema may enable operations on multiple heterogeneous databases using a unified set of instructions. This translation mechanism may ensure that operations may be executed across disparate data sources while preserving the intended meaning of the high-level command, without requiring manual adaptation or deep knowledge of each underlying database structure. Process 2300 includes a step 2312 of implementing the schema to facilitate issuance of one or more high-level commands, as illustrated in FIG. 23.

In some embodiments, the one or more high-level commands include aggregating schema-compliant data entries from the at least two differently structured databases associated with the schema. The aggregation is performed in accordance with the predefined set of rules of the schema. By performing the aggregation in accordance with the schema, data entries that may differ in structure, terminology, or format across the databases may be interpreted and processed uniformly, ensuring that the resulting dataset is standardized and semantically consistent. Additionally, in some embodiments, the one or more high-level commands include generating a unified report based on the aggregated data entries. The unified report present schema-compliant data entries standardized across the at least two differently structured databases. In other words, such a report may present schema-compliant data entries in a standardized format, thereby enabling a coherent, cross-database view of the information. For instance, the unified report may include summaries, statistics, or other derived information that reflects the combined data from the at least two differently structured databases. Additionally, in some embodiments, the unified report is generated following a request received from at least one SaaS platform user, allowing stakeholders to access a consolidated view of the data without needing to manually reconcile differences across the underlying databases.

Referring to FIGS. 24A and 25, a SaaS platform user may issue a high-level command to aggregate the number of unresolved bugs across both IT teams and generate a unified report. The schema 2500 may first map the fields of each database to the corresponding schema fields: status entries map to either “Resolved” or “Not Resolved” according to the schema's many-to-one mapping. Next, the schema may translate the high-level aggregation command into instructions adapted to each database's structure. In database 2400a, all entries in the “Status” field corresponding to “Not Resolved”, i.e., all entries corresponding to “To Do” or “In progress”, may be counted. Similarly, in database 2400b, all entries in the “Status” field corresponding to “Not Resolved”, i.e., all entries corresponding to “To Do”, “Working on it”, or “Stuck”, may be counted. Finally, a unified report that presents a consolidated, schema-standardized view of unresolved bugs may be generated. The report abstracts away differences in terminology and data type, showing a combined summary across both IT teams, enabling the user to quickly assess the total number of unresolved issues without needing to manually reconcile the heterogeneous databases.

In some embodiments, the one or more high-level commands include implementing at least one additional rule to schema-compliant data entries from the at least two differently structured databases associated with the schema. As used herein, an additional rule refers to a rule or constraint that is applied at the level of the aggregated or schema-compliant data, beyond the predefined rules and definitions of the schema itself. Such rules may specify operations, validations, transformations, or business logic to be applied to the data entries after they have been identified as compliant with the schema. For example, an additional rule may include filtering schema-compliant entries to select only those meeting a certain condition, such as unresolved bugs with high priority, or transforming data entries according to a specific formula or threshold, such as converting all dates into the YMD (Year-Month-Day) format. These additional rules may enable more complex or context-specific operations on the standardized data entries, ensuring that the output, such as a report, summary, or aggregated dataset, meets the precise analytical or operational requirements of the user, while maintaining consistency across the heterogeneous databases.

In some embodiments, the schema supports user-defined extensions to allow at least one SaaS platform user to customize the schema. As used herein, an extension refers to any modification or augmentation of the baseline schema, including but not limited to adding or removing required data fields; changing the data type of a field (e.g., from a text to a number); defining or modifying rules; and expanding or restricting the set of allowable values for certain data types. For example, referring to FIGS. 25-26, a SaaS platform user, such as an IT manager, may customize schema 2500 by extending the different allowable values for a status attribute. In the baseline schema, the status field was represented as a binary list of possible values, such as “Resolved” or “Not Resolved.” Through the extension mechanism, the IT manager may redefine the field to support a broader set of status indicators, such as “Resolved,” “In Progress,” and “Not Started,” thereby increasing the granularity of the status information captured by the schema.

As previously explained, some of the disclosed embodiments focus on a hybrid schema framework that enables standardization and interoperability across differently structured and initially unrelated databases by applying a flexible, structure-less schema. This schema acts as a logical overlay, abstracting data organization rules from storage models. While the earlier section detailed how multiple databases may be associated with an existing or newly generated schema and cross-database operations, high-level commands can be applied; the following sections explore how a SaaS platform user can associate their own working product or custom database with an existing schema. Such a process includes the interfaces and mechanisms involved in integrating a user's database into the schema-connected ecosystem, thereby enabling bottom-up standardization, i.e., starting from a fully customized, non-standardized entity and progressively aligning it with schema rules. This approach contrasts with template-based standardization, which follows a top-down approach, where entities are created from a fully standardized template and then customized while maintaining linkage to the original template, as described in relation to Processes 1900 and 2200.

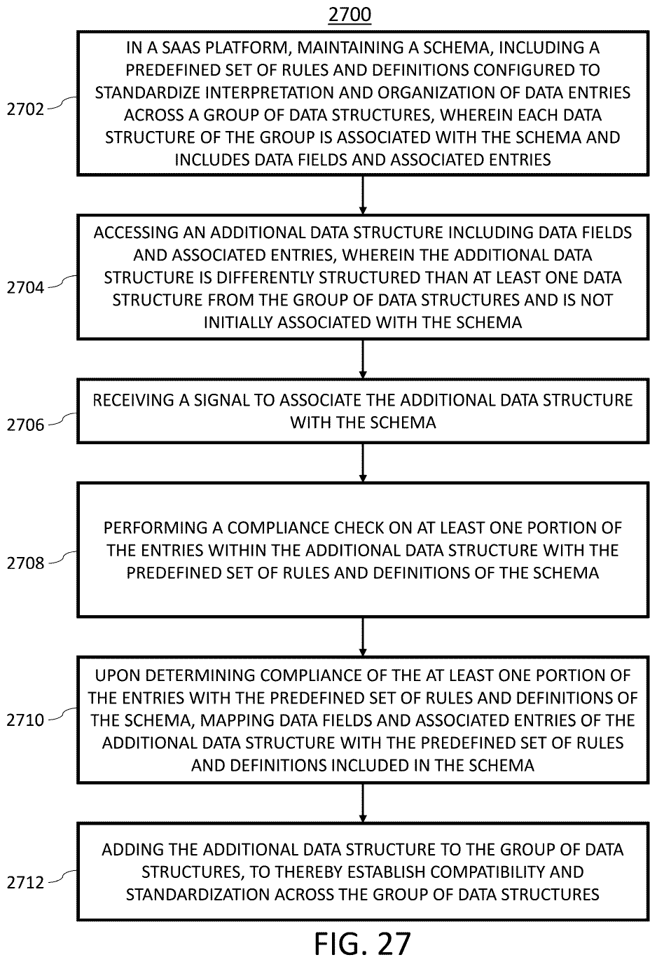

FIG. 27 is a flowchart of an exemplary process 2700 for bottom-up data structure development, consistent with some of the disclosed embodiments. Process 2700 is discussed herein for explanatory purposes and is not intended to be limiting. In some embodiments, steps of process 2700 may be changed, modified, substituted, or rearranged, consistent with the present disclosure. Process 2700 may be implemented using one or more components of a computing device 200 (discussed in FIG. 2A) or user device 254 of computing architecture 250 (discussed in FIG. 2B). Some disclosed embodiments may include at least one processor that may be configured to execute stored instructions to perform operations for consolidating data from multiple data sources. As shown in FIG. 27, process 2700 may include steps 2702, 2704, 2706, 2708, 2710, and 2712, discussed in further detail below.

Some disclosed embodiments involve, in a SaaS platform, maintaining a schema, including a predefined set of rules and definitions configured to standardize interpretation and organization of data entries across a group of data structures. Each data structure of the group is associated with the schema and includes data fields and associated entries. As described above, the term “schema” refers to a structure-less logical abstraction and is distinct from a conventional database schema, and functions as an abstract overlay independent of any particular physical or logical structure. The rules and definitions of the schema define the requirements that a database or corresponding data structure (i.e., the physical and logical organization of data elements as they exist within a given database) and its associated data entries need or should satisfy in order to be associated with the schema. Maintaining a schema within a SaaS platform refers to the storage, management, and application of the predefined rules and definitions that constitute the schema. Such maintenance may include ensuring that databases and their data entries satisfy the schema's requirements, updating the schema as needed, and applying the schema to facilitate the association or mapping of data across differently structured databases. By maintaining such a schema, the SaaS platform may provide a standardized framework for validating, organizing, and harmonizing data across differently structured databases, enabling aggregation, reporting, and analysis without imposing a rigid database-specific structure. Process 2700 includes a step 2702 of maintaining a schema including a predefined set of rules and definitions, as illustrated in FIG. 27.

Referring to FIGS. 24A and 25, databases 2400a and 2400b, along with their respective data structures, form a group of data structures whose interpretation and organization of data entries have been standardized by schema 2500. Schema 2500 includes a predefined set of rules and definitions. Specifically, to be associated with the bug schema entity, a database/data structure may be required to include at least six data fields: a “Name” data field of type “text”, a “Summary” data field of type “text”, an “Assignee” data field of type “people”, a “Bug Status” data field of type “status”, a “Deadline” data field of type “date”, and a “Priority Level” data field of type “priority”. In accordance with the disclosed embodiments, at least some of the data structures within the group may differ from one another. For example, the data structure associated with database 2400a is different from the data structure associated with database 2400b.

Some disclosed embodiments involve accessing an additional data structure including data fields and associated entries. The additional data structure is differently structured than at least one data structure from the group of data structures and is not initially associated with the schema. In the context of this disclosure, “accessing a data structure” refers to the act of retrieving, querying, or otherwise interacting with the data contained within a database or similar repository. This process may involve reading the structure's contents, identifying its fields and entries, and evaluating its format and organization for potential integration (e.g., with a schema). While the schema has already standardized interpretation and organization across a set of data structures, each conforming to a predefined set of rules, the newly accessed data structure, because it is not yet associated with the schema, remains outside the schema's governance. The structural differences between the additional data structure and the group of data structures may manifest in various ways, such as variations in field names, data types, value sets, or the arrangement of data elements. For example, the additional data structure might use different terminology to describe similar concepts, or it may organize its data in a format that diverges from the format used by at least one data structure of the group. Process 2700 includes a step 2704 of accessing an additional data structure including data fields and associated entries, as illustrated in FIG. 27.

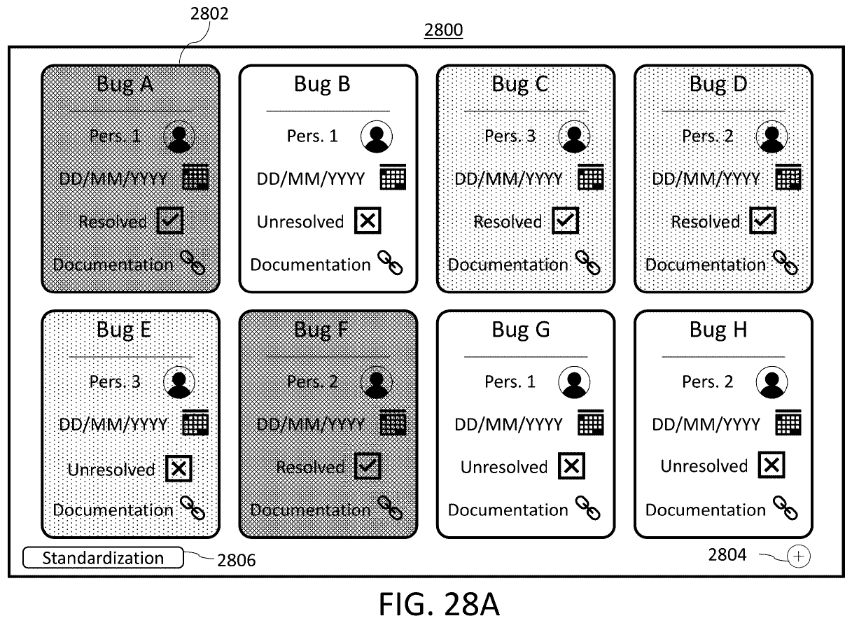

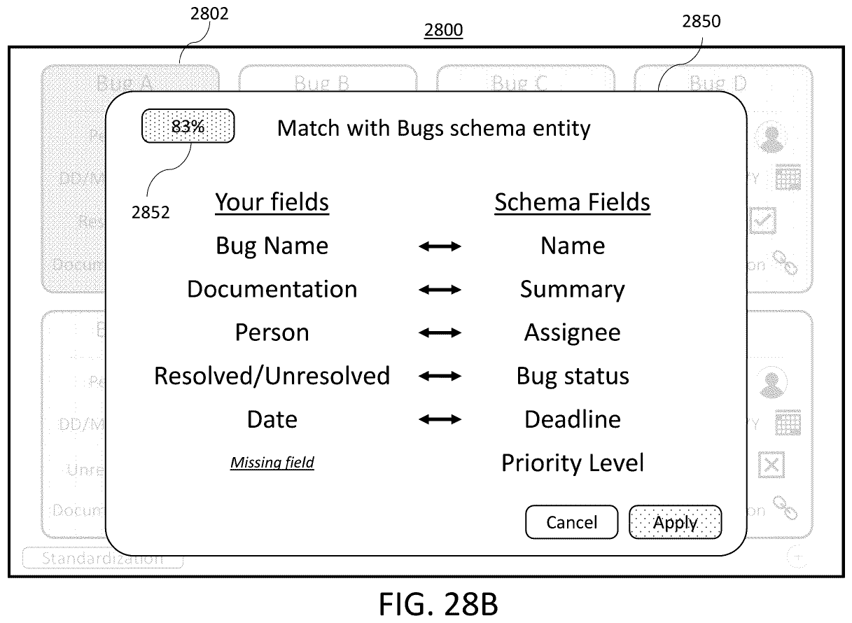

FIG. 28 illustrates an exemplary user interface 2800 designed for editing SaaS platform elements, consistent with the disclosed embodiments. Specifically, user interface 2800 enables users to interact with a user-facing application and edit visual components referred to as cards 2802, each of which is associated with a specific bug. In this example, the SaaS platform user is a member of IT Team C, which is distinct from IT Teams A and B that are associated with databases 2400a and 2400b shown in FIGS. 24A-B. Each card 2802 corresponds to a bug being tracked by IT Team C and includes various data fields such as “Bug Name,” “Person,” “Date,” “Resolved/Unresolved,” and “Documentation.” These cards are linked to a database, and the database itself is associated with a data structure. The data structure may take different formats, including JSON. In such a case, each card 2802 would correspond to a separate JSON object containing fields that directly reflect the bug-related data displayed on the card, as well as additional fields that define the card's visual properties, such as shape, size, and color.

As shown in FIG. 28, the appearance of each card may vary depending on the priority level of the associated bug. For example, a high-density dotted pattern may indicate a high-priority bug, a low-density dotted pattern may represent a medium-priority bug, and a card with no pattern may correspond to a low-priority bug. In the underlying JSON object, the priority level may be represented either as a textual field (e.g., “High,” “Medium,” “Low”), which the interface translates into the appropriate visual representation, or directly as a visual property (e.g., pattern density).

Through user interface 2800, the SaaS platform user can interact with and modify cards 2802. This includes editing field values, such as changing a bug's status from “Unresolved” to “Resolved”, by clicking or otherwise interacting with the card. Users can also add new cards using button 2804, which allows them to expand the database with additional bug entries. As further explained below, interface 2800 may support the association of cards 2802 and their corresponding data structures with schema 2500. This association may occur voluntarily, where the SaaS platform user chooses to align their data with the schema, or involuntarily, where the platform prompts or invites the Saas platform user to make the association. This mechanism may enable the integration of IT Team C's custom database into the broader schema-based framework, facilitating standardization and interoperability across teams (i.e., IT Teams A, B, and C)

In some embodiments, the additional data structure is associated with at least one additional schema different from the maintained schema. In other words, the additional data structure, which is not initially associated with the schema that governs the group of data structures, may be initially linked to another schema. This reflects the flexible nature of schema associations within the disclosed framework. A data structure, and by extension, its associated database, is not limited to a single schema. As long as the schemas are not logically or functionally incompatible, a data structure may be simultaneously associated with multiple schemas. Each schema may define its own set of rules, requirements, and interpretive logic, and a data structure may satisfy the conditions of more than one schema without conflict. For example, a database used for bug tracking might conform to a general schema for issue management. Referring to FIG. 28A, the data structure associated with cards 2802 may initially be linked to a schema related to IT ticketing, where each ticket corresponds to a bug tracked by IT Team C. This initial schema may define rules and fields relevant to general ticket management, such as issue type, status, assigned personnel, and documentation. However, the same data structure may later be considered for association with schema 2500, which is specifically designed for bug tracking and standardization across IT teams.

Some disclosed embodiments involve receiving a signal to associate the additional data structure with the schema. In this context, “receiving a signal” refers to any form of input, instruction, prompt, or indication, whether initiated by a user, system, or external process, that triggers or authorizes the association of a data structure with a schema. Process 2700 includes a step 2706 of receiving a signal to associate the additional data structure with the schema, as illustrated in FIG. 27.

In some embodiments, the signal to associate the additional data structure with the schema is received from a SaaS platform user. In other words, the signal could be generated through direct user interaction, such as clicking a button in a user interface, selecting an option from a dropdown menu, or confirming a prompt. For example, referring to FIG. 28A, the signal may be generated after the SaaS platform user has clicked in button “Standardization” 2806.

Alternatively, in some embodiments, the signal to associate the additional data structure with the schema is generated in response to a data recognition framework applied to the data fields and associated entries of the additional data structure. The data recognition framework is configured to identify similarities between the data fields and associated entries of the additional data structure, and the predefined set of rules and definitions included in the schema. As used herein, a data recognition framework refers to a rules, models, and pattern-matching techniques, such as machine learning algorithms, regular expressions, semantic mappings, and contextual analysis, that are executed by a processor to identify and label data. This framework is designed to detect similarities between the structure and content of the additional data and the predefined rules and definitions of the schema. Put differently, the signal to associate the additional data structure may arise from automated system behavior, such as a recommendation engine suggesting schema alignment based on detected patterns, or a compliance module identifying a match between the data structure and schema requirements. Additionally, the signal might be embedded in a workflow, API call, scheduled task, or integration event that implicitly or explicitly initiates schema association.

Accordingly, in this context, the act of receiving a signal may encompass both voluntary actions, where a SaaS platform user intentionally chooses to associate their data structure with the schema, and involuntary or system-driven actions, where the platform prompts, recommends, or automatically initiates the association based on contextual analysis or operational logic.

In some embodiments, applying a data recognition framework includes the use of artificial intelligence (AI) technologies to analyze, interpret, and classify data fields and entries within a given data structure. This framework may leverage machine learning models, natural language processing (NLP), pattern recognition, and semantic analysis to identify similarities, relationships, and potential mappings between data elements and schema-defined categories. AI may be used to detect patterns in field names, infer semantic meaning from labels, and evaluate the structure and content of data entries, even when those entries are unlabelled, inconsistently formatted, or presented in heterogeneous ways. The data recognition framework may operate across multiple layers of abstraction, enabling it to recognize not only direct matches but also conceptual or contextual similarities. For example, referring to FIG. 28, a data recognition framework may identify that a field in a JSON object labelled “Date” in one database corresponds to a “Deadline” field in a schema, or that different visual properties (e.g., high-density dotted pattern, low-density dotted pattern, no pattern) represent priority levels even if not explicitly labelled as such. This intelligent recognition may allow for more flexible and scalable schema association.

Some disclosed embodiments further involve presenting the similarities identified by the applied data recognition framework on a user interface. This presentation may include visual indicators, suggested mappings, or annotated comparisons that help the SaaS platform user understand how their data structure aligns with the schema. The interface may highlight fields that are likely matches or group similar entries for review, making the recognition process transparent and actionable.

In other words, the data recognition framework, operating silently in the background like the hidden part of an iceberg, may continuously analyze the user's data structure for potential alignment with existing schema definitions. When the framework identifies meaningful similarities, it may trigger a visual cue, such as a banner or notification, inviting the user to consider aligning their product or database with the organization's standards as defined by a schema. If the user responds positively to this invitation, the interface may then reveal the identified similarities, allowing the user to review and interact with the proposed mappings. For example, some disclosed embodiments further comprise querying the user, via the interface, for accuracy confirmation of the presented similarities. In other words, the user may confirm, reject, or refine the suggested associations. This step may ensure that the schema association process remains both intelligent and user-guided, combining automated pattern recognition with human validation to support reliable and scalable standardization.

FIG. 28B is an illustration of user interface 2800, supplemented with a user interface element configured to display similarities identified by an applied data recognition framework. More specifically, the data recognition framework may have been applied to the data structure associated with cards 2802. As a result of this application, several similarities between the card fields and schema-defined fields have been identified. For example, the field labeled “Bug Name” on the cards has been identified as corresponding to the schema field “Name.” Likewise, the field “Documentation” has been identified as corresponding to the schema field “Summary,” the field “Person” has been identified as corresponding to the schema field “Assignee,” the field “Resolved/Unresolved” has been identified as corresponding to the schema field “Bug Status,” and the field “Date” has been identified as corresponding to the schema field “Deadline.” These identified similarities are surfaced through the user interface, allowing the SaaS platform user to view and interact with the proposed mappings/identifications.

Some disclosed embodiments involve performing a compliance check on at least one portion of the entries within the additional data structure with the predefined set of rules and definitions of the schema. In some embodiments, a compliance check may be performed on at least one portion of the entries within the additional data structure to determine whether they conform to the predefined set of rules and definitions of the schema. As previously explained, a compliance check refers to the process of evaluating whether a database or a subset of its data entries is compatible with the schema and therefore eligible for association—enabling integration, aggregation, or standardized interpretation. Databases that pass the check are considered compliant, while those that do not may be flagged for modification, mapping adjustments, or other corrective actions to bring them into alignment. Process 2700 includes a step 2708 of performing a compliance check, as illustrated in FIG. 27.

Details and mechanisms of the compliance check described earlier remain applicable here and are thus not repeated. It is also to be appreciated that part of the evaluation process involved in the compliance check may already be carried out by the applied data recognition framework. Operating in the background, this framework may proactively analyze the structure and semantics of the data entries, identifying potential matches and similarities with schema-defined fields. These preliminary insights can streamline the compliance check by pre-validating certain fields, suggesting mappings, and highlighting areas of likely conformity or divergence. In this way, the data recognition framework may act as a preparatory layer, reducing the effort required during the formal compliance check and enhancing the overall efficiency of schema association. As such, the user interface previously discussed in relation to the data recognition framework may also be used during the compliance check process and the subsequent matching process. The interface may present the identified similarities, offer visual indicators, and allow the user to interact with the proposed mappings. In scenarios where the signal to associate the additional data structure with the schema results from proactive user input via an interface, the compliance check may be initiated from scratch, evaluating the compatibility of the data structure independently and without relying on prior background analysis. Referring to FIG. 28A, a compliance check on at least a portion of the data structure associated with cards 1802 may be performed using the set of rules and definitions included in schema 2500.

Some disclosed embodiments involve, upon determining compliance of the at least one portion of the entries with the predefined set of rules and definitions of the schema, mapping data fields and associated entries of the additional data structure with the predefined set of rules and definitions included in the schema. As previously described, the mapping process refers to the act of establishing a logical correspondence between the structure and semantics of the additional data and the schema's standardized framework. Mapping may involve identifying which fields in the additional data structure align with schema-defined fields. It is also to be appreciated that the mapping may be informed or partially pre-processed by the data recognition framework previously applied. This framework, operating in the background, may have already identified potential matches and similarities between the data structure and the schema, thereby streamlining the mapping process. These insights may be surfaced through the user interface (e.g., as shown in FIG. 28B), allowing the SaaS platform user to review, confirm, or refine the proposed mappings. Process 2700 includes a step 2710 of mapping data fields and associated entries of the additional data structure with the predefined set of rules and definitions included in the schema, as illustrated in FIG. 27.

In some embodiments, mapping data fields and associated entries of the additional data structure with the predefined set of rules and definitions included in the schema includes using artificial intelligence. This AI-driven mapping process can leverage machine learning models, natural language processing (NLP), and semantic analysis to intelligently interpret field names, data types, and contextual relationships, even when the data is inconsistently labeled or formatted. For example, AI may infer that a field labeled “Date” corresponds to the schema's “Deadline” field. By analyzing patterns across multiple data structures, the AI system can suggest mappings that go beyond simple lexical matches, identifying conceptual equivalences and structural similarities. These suggestions may be surfaced through the user interface, allowing the SaaS platform user to review, confirm, or refine the proposed associations. This intelligent mapping capability enhances scalability and accuracy, especially in environments where data structures are user-defined, loosely governed, or highly variable.

In some embodiments, mapping data fields and associated entries of the additional data structure with the predefined set of rules and definitions included in the schema includes running an AI agent configured to analyze at least some of the data fields and associated entries of the additional data structure and to identify a mapping with a given definition of the schema. In other words, the AI agent's capabilities may extend beyond simple field name matching or direct translation. The AI agent may infer implicit relationships and semantic equivalences even when no field in the data structure explicitly corresponds to a schema-defined field. In other words, a data structure does not need to contain columns, variables, or fields that directly match the schema's definitions. Instead, it may include data entries distributed across multiple fields that, when interpreted collectively, reflect the meaning or intent of a schema-defined attribute. For example, a database may lack a dedicated “Priority Level” field but include a “Deadline” column and a “Completion Rate” or “Status” field. Based on these inputs, the AI agent may infer the urgency or importance of each entry and estimate a priority level, which it then maps to the schema's “Priority Level” definition. This process may allow for the mapping of both explicit and implicit values. Explicit mapping involves direct correspondence between field names and schema definitions, while implicit mapping relies on intermediary rules, contextual analysis, and derived interpretations. The AI agent may apply learned models, statistical relationships, or domain-specific heuristics to perform this mapping, enabling the schema to accommodate flexible and heterogeneous data structures without requiring rigid conformity.

In some embodiments, mapping data fields and associated entries of the additional data structure with the predefined set of rules and definitions included in the schema includes mapping one or more different data entries to a given definition of the schema. As previously explained, mapping may involve a many-to-one correspondence, in which multiple database fields and/or values are normalized and associated with a single schema field/potential value.

In some embodiments, mapping data fields and associated entries of the additional data structure with the predefined set of rules and definitions included in the schema includes mapping one or more different data types to a given definition of the schema. Data entries may be recognized as compliant with a schema rule or definition even if they do not strictly match the expected data type specified by the schema. The mapping process may accommodate variations in how information is represented, allowing for semantic equivalence rather than requiring exact structural conformity. For example, as illustrated in FIGS. 24B and 25, the “Level” field in database 2400b contains numerical values ranging from 1 to 5. Although the schema 2500 defines the “Priority Level” field as a closed list of textual labels, such as “High,” “Medium,” and “Low”, the numerical values can still be mapped to the schema's priority level categories. This mapping may involve intermediary rules or logic that translate numeric ranges into corresponding textual labels, enabling consistent interpretation across different data formats. Similarly, referring to FIG. 28A, visual properties such as high-density dotted patterns, low-density dotted patterns, or the absence of a pattern may be used to visually encode priority levels. Even though these visual cues are not textual or numeric, they can still be mapped to the schema's “Priority Level” field. In such cases, the mapping may rely on interpreting the appearance attributes of the data object, such as pattern density, as implicit indicators of priority.

In some embodiments, mapping data fields and associated entries of the additional data structure with the predefined set of rules and definitions included in the schema includes receiving input from a SaaS platform user via an interface. This input may serve multiple purposes: the user may confirm, amend, or reject mappings that have been pre-established by the applied data recognition framework or by an artificial intelligence agent. Alternatively, the platform may directly prompt the user to specify which data field in the additional data structure should be mapped to a given schema definition. For example, referring to FIG. 28B, even though the platform may have applied a data recognition framework or other mapping techniques described herein, it may fall short of identifying a suitable correspondence between the “Priority Level” field defined in schema 2500 and any field present in the data structure associated with cards 2802. In such cases, the platform may rely on user input to resolve ambiguity or fill in gaps where automated mapping is inconclusive. The interface may present the user with a list of candidate fields, visual indicators, or contextual suggestions to assist in the decision-making process.

Some disclosed embodiments further involve presenting on an interface a compliance score of the at least one portion of the entries within the additional data structure with the predefined set of rules and definitions of the schema. As used herein, a compliance score may refer to any quantitative indicator of compatibility that may help the SaaS platform user assess whether the data structure is suitable for schema association. The compliance score may be calculated based on various factors, including the presence of required fields, conformity of data types, alignment of values, and semantic similarity between the data structure and schema definitions. The compliance score may also incorporate insights generated by the applied data recognition framework or AI agent, which may have already identified potential mappings or inferred implicit relationships. For example, if several fields in the data structure partially match schema definitions, either directly or through derived interpretations, the score may reflect a high degree of compatibility even if full conformity is not achieved. By displaying this score, the platform may provide users with a transparent and actionable overview of the schema alignment process. The compliance score may also guide users in deciding whether to proceed with association, make adjustments to improve compliance, or seek further clarification. Referring to FIG. 28B, a compliance score 2852 is calculated and presented within interface element 2850. This score reflects the degree of alignment between the data fields included in the data structure associated with cards 2802 and the predefined data fields of schema 2500

Additionally, some disclosed embodiments further involve presenting on the interface suggestions for improving the compliance score of the at least one portion of the entries within the additional data structure. These suggestions may be generated based on the results of the compliance check and the analysis performed by the data recognition framework or AI agent. They may include, but are not limited to, recommendations to add missing fields, rename existing fields to better align with schema definitions, adjust data types, or normalize values to match expected formats. For example, referring to FIG. 28B, when a user interacts with the displayed compliance score 2852 within interface element 2850, the platform may present a list of actionable suggestions aimed at improving schema alignment. One such suggestion might be to explicitly add a “Priority Level” field to the data structure associated with cards 2802, especially in cases where priority is currently represented only through visual properties, such as pattern density, rather than through a clearly labeled textual or numeric field. These suggestions may serve to guide the user in refining their data structure to meet schema requirements more effectively, thereby increasing the compliance score and enabling more robust schema association.

Some disclosed embodiments involve adding the additional data structure to the group of data structures, to thereby establish compatibility and standardization across the group of data structures. In other words, after completing the mapping step, the additional data structure may become formally associated with the schema. This inclusion establishes compatibility and standardization across the group, allowing the newly associated data structure to participate in schema-driven operations. By becoming part of the schema-associated group, the additional data structure may gain access to a unified framework for data interpretation, enabling consistent aggregation, cross-database querying, and execution of schema-level commands. This means that even if the data structure was originally created independently, with its own field names, formats, or organizational logic, it can now be integrated into broader workflows and reporting mechanisms that rely on schema-defined standards. This process, therefore, supports scalable interoperability across heterogeneous systems, allowing diverse data sources to be harmonized without requiring rigid restructuring. Once added to the group, the data structure benefits from the same governance, validation, and automation capabilities as other schema-compliant entities, ensuring coherence and consistency across the platform. Process 2700 includes a step 2712 of adding the additional data structure to the group of data structures, as illustrated in FIG. 27.

Some disclosed embodiments further involve updating schema reports based on entries included within the additional data structure. In other words, once the additional data structure has been formally integrated into the group of data structures governed by the schema, existing schema-based reports may be updated to incorporate the entries from the newly added structure. More generally, the inclusion of the additional data structure may enable it to participate in any of the previously discussed high-level standardized operations, such as unified reporting, cross-database querying, or execution of schema-level commands. For example, if a report had previously been generated to summarize the number of bugs or errors handled by IT Team A and IT Team B, based on data from databases 2400a and 2400b, then, following the association of the data structure associated with cards 2802 with schema 2500, that report may be updated to include bugs being tracked by IT Team C. The result is a more comprehensive and unified report that reflects data across all three teams, ensuring consistency and completeness in organizational insights. In some embodiments, the schema report updates may occur automatically upon successful schema association, with the platform dynamically incorporating the new data entries into existing reporting logic. Alternatively, the update may be initiated manually by a SaaS platform user (e.g., an IT team manager) who has the necessary permissions and oversight across the various data structures. This user may choose to regenerate or refresh the report to reflect the newly integrated data, ensuring that reports are based on the most current and complete information available.

Some disclosed embodiments further involve applying metadata definitions to the additional data structure associated with the schema. Once the additional data structure has been successfully associated with the schema, metadata definitions may be applied to preserve and manage that association. This metadata may act as a persistent layer of information that records the mapping between the data structure and the schema, ensuring that the connection remains intact even as the SaaS platform user customizes or modifies the data structure over time. Once the schema association is established, it may not be fragile or easily broken by superficial changes. For example, if a user decides to change the format of the “Date” field, the association with schema 2500 will not be lost. The metadata may ensure that the underlying semantic link between the field and the schema definition remains valid, regardless of cosmetic or structural adjustments. More generally, any customization performed by the user that does not involve removing required fields defined by the schema or breaking the predetermined set of rules and definitions is permitted. These changes may include renaming fields, reordering columns, adjusting visual properties, or modifying input formats. Because the metadata captures the schema mapping independently of the physical layout or appearance of the data structure, such modifications do not disrupt the standardized interpretation or interoperability enabled by the schema.

As explained in the preceding sections, different approaches to standardization exist, namely, the top-down and bottom-up paradigms. Each of these approaches carries its own merits and may be suited to particular organizational contexts and user needs. The top-down approach, implemented through templates, may offer centralized governance and immediate structural consistency, making it ideal for environments that require uniformity and oversight from the outset. Conversely, the bottom-up approach may allow users to begin with fully customized, non-standardized entities and progressively align them with schema rules, offering flexibility and adaptability in dynamic or decentralized settings. These two approaches are not mutually exclusive. Rather, they may be reconciled within a unified framework that leverages the strengths of both. As described herein below, an hybrid schema model may enable such reconciliation by allowing user-facing applications, each potentially generated from distinct templates and operating with different data structures, to be connected through a schema that acts as a semantic layer. In this way, multiple applications, even if developed independently and under the governance of separate templates, may be semantically aligned and made interoperable. The schema may therefore serve as the connective tissue, enabling these disparate entities to communicate, exchange information, and participate in unified reporting and analysis.

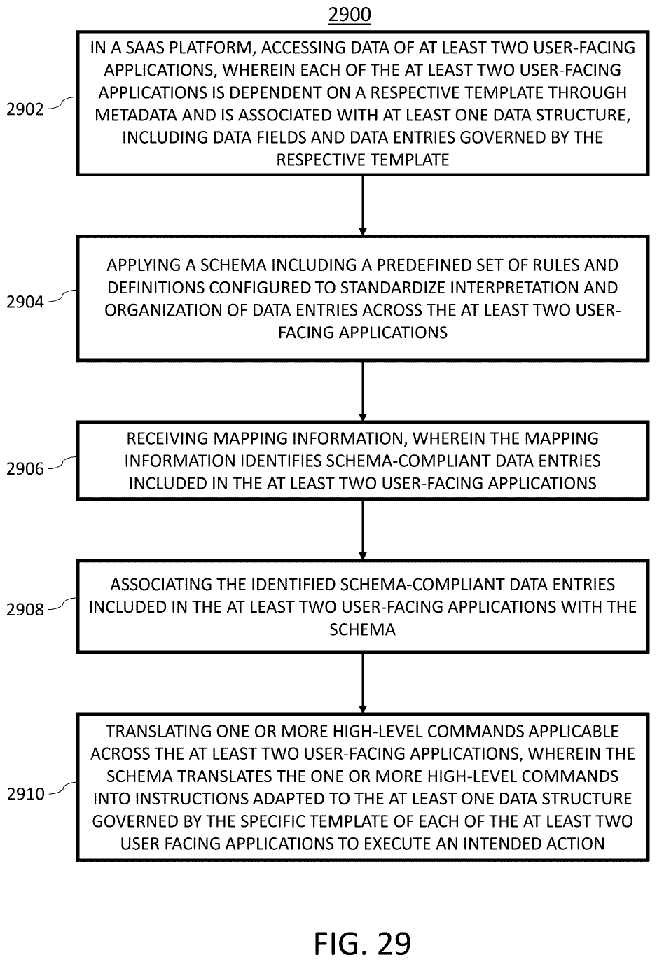

FIG. 29 is a flowchart of an exemplary process 2900 for connecting user-facing applications governed by distinct templates, consistent with some of the disclosed embodiments. Process 2900 is discussed herein for explanatory purposes and is not intended to be limiting. In some embodiments, steps of process 2900 may be changed, modified, substituted, or rearranged, consistent with the present disclosure. Process 2900 may be implemented using one or more components of a computing device 200 (discussed in FIG. 2A) or user device 254 of computing architecture 250 (discussed in FIG. 2B). Some disclosed embodiments may include at least one processor that may be configured to execute stored instructions to perform operations for connecting user-facing applications governed by distinct templates. As shown in FIG. 29, process 2900 may include steps 2902, 2904, 2906, 2908, and 2910, discussed in further detail below. While embodiments of the present disclosure are presented within the context of customer relationship management (CRM), the disclosed embodiments may apply to different contexts involving collaborative workflow systems, enterprise resource planning, customer relationship management (CRM), content management platforms, and other SaaS-based environments where standardized structures are deployed across multiple user-facing interfaces.

Some disclosed embodiments involve, in a SaaS platform, accessing data of at least two user-facing applications, wherein each of the at least two user-facing applications is dependent on a respective template through metadata and is associated with at least one data structure, including data fields and data entries governed by the respective template. The at least two user-facing applications are therefore not derived from a common origin or seed; rather, they represent separate instantiations built upon different templates. Put differently, while both applications may serve similar functional purposes or address related operational needs, they do so through independently defined structures, interfaces, and organizational logic. Accessing data from such user-facing applications may entail a continuous set of operations executed by one or more software components or processing units. These operations may include retrieving, querying, modifying, or updating the contents of the user-facing applications. From a technical standpoint, this may involve interacting with databases, data structures, or data sources linked to the user-facing applications, such as reading specific elements, searching for values, issuing queries based on defined criteria, or performing updates such as inserting or deleting data entries. Templates, as previously described, serve as the architectural backbone for standardizing user interfaces, operational workflows, and data formats across multiple deployments. Each user-facing application thus corresponds to a localized implementation of its respective template, tailored to the needs of an individual user or group, yet structurally tethered to the master configuration. This linkage may allow for centralized governance and dynamic propagation of updates, ensuring consistency across distributed instances while still permitting contextual customization. The fact that the two user-facing applications are dependent on different templates underscores the diversity of their structural origins. However, this does not preclude their interoperability through the application of a schema, as further explained below. Process 2900 includes a step 2902 of accessing data of at least two user-facing applications dependent on different templates through metadata, as illustrated in FIG. 29.

In some embodiments, the at least two user-facing applications include at least two SaaS platform elements of same or different types. SaaS elements may range from dashboards, boards, cards, or workflows to more complex constructs such as project trackers, issue management systems, or custom data repositories. Each element may serve as a distinct interface or operational unit within the platform, tailored to specific user needs or organizational functions. The diversity in element types reflects the flexibility of the SaaS platform, allowing users to build and customize their tools according to context, while still enabling schema-based standardization and interoperability across these varied implementations. Additionally, or alternatively, in some embodiments, the data structure of each of the at least two user-facing applications includes a table format. As previously described, a table format refers to an organized arrangement of data into rows and columns defining cells, where each column may represent a specific attribute or field, and each row may correspond to a discrete record or entry. A table format may be used to define the layout of user-facing applications such as boards, task lists, or resource trackers, where each cell in the table may be populated according to predefined rules or user input.

In some embodiments, each respective template governing each of the at least two user-facing applications is controlled by a different user of the SaaS platform. Because each template may be managed by a distinct user, the resulting user-facing applications may vary significantly in terminology, data organization, and interface design, reflecting the unique preferences, requirements, or domain-specific practices of the template owners.

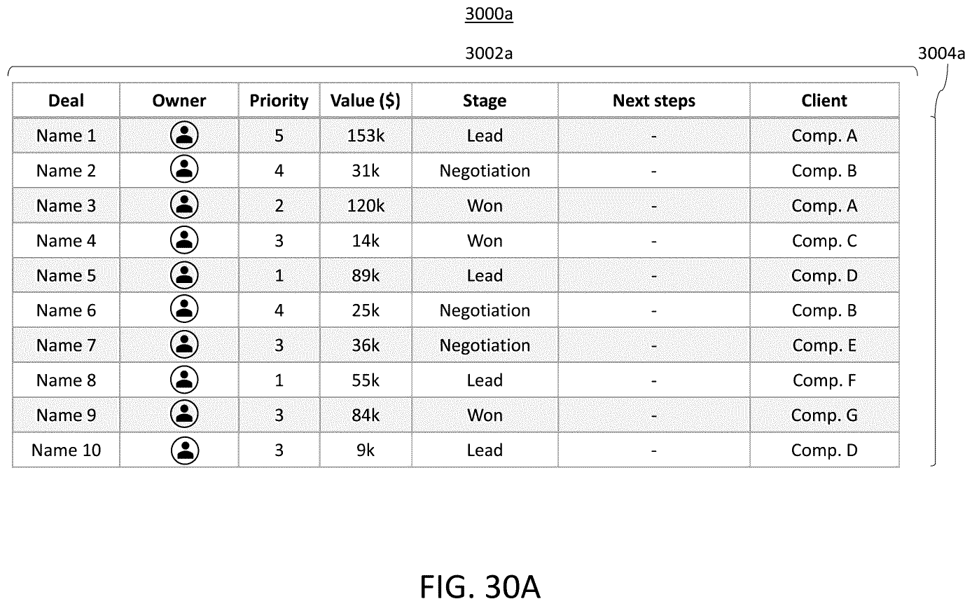

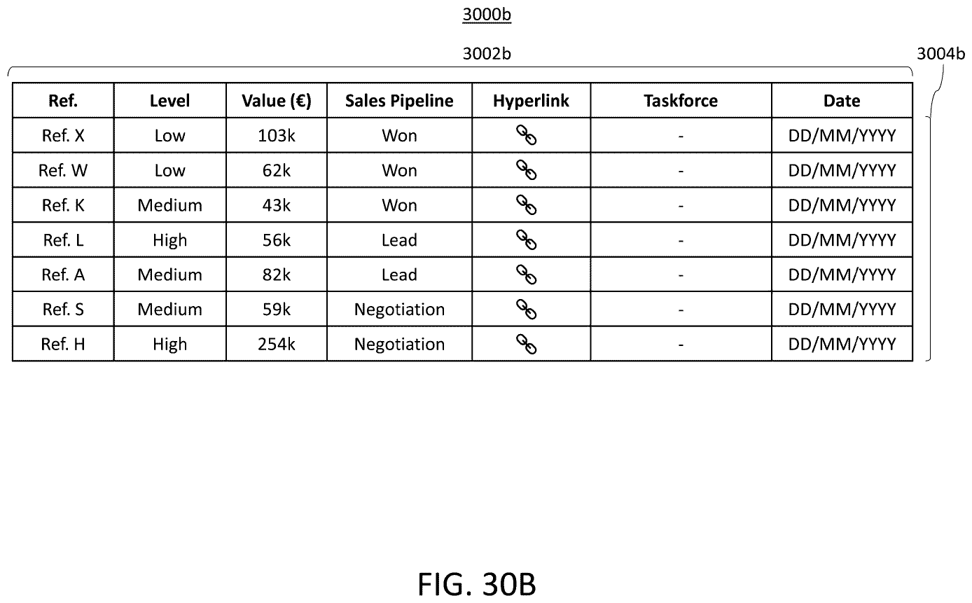

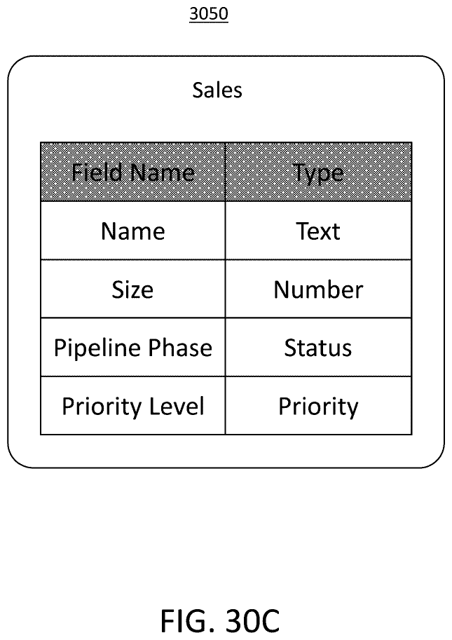

FIGS. 30A-30B illustrate two exemplary user-facing applications, 3000a and 3000b, each dependent on a distinct template, in accordance with the disclosed embodiments. Both applications correspond to SaaS platform elements, specifically, boards (with an associated data structure including a table format) composed of columns (3002a and 3002b) and rows (3004a and 3004b). Despite serving a similar operational purpose, i.e., tracking the sales pipeline for their respective teams, these user-facing applications are structurally and semantically different due to their reliance on independently developed templates. User-facing application 3000a is associated with a sales team based in the United States, while application 3000b corresponds to a European sales team. The divergence in templates stems from their historical development, likely by different individuals or teams, each tailoring the structure to regional needs and conventions. As a result, the terminology and data organization vary significantly between the two. For instance, the U.S. sales team tracks deals using fields such as “Name,” “Stage,” and “Priority,” with priority represented numerically from 1 to 5 (where 1 indicates the highest urgency). In contrast, the European team uses “Ref.” for deal identification, “Sales Pipeline” to denote progress, and “Level” to indicate importance, with level expressed as textual labels like “High,” “Medium,” or “Low.” Currency formats also differ: U.S. deals are tracked in dollars, while European deals are recorded in euros. Beyond terminology and data types, structural and positional differences are also evident. Certain fields, such as “Owner,” “Next Steps,” and “Client,” appear exclusively in application 3000a, whereas “Hyperlink,” “Taskforce,” and “Date” are unique to application 3000b. Even when similar information is captured, the order and arrangement of fields differ, further complicating direct comparison or aggregation. These variations underscore the challenges of achieving cross-application standardization when user-facing applications are built on distinct templates. However, through the application of a schema consistent interpretation, aggregation, and reporting across structurally divergent entities may be achieved.

Some disclosed embodiments involve applying a schema including a predefined set of rules and definitions configured to standardize interpretation and organization of data entries across the at least two user-facing applications. As described above, the term “schema,” refers to a structure-less logical abstraction and is distinct from a conventional database schema, and functions as an abstract overlay independent of any particular physical or logical structure. The rules and definitions of the schema define the requirements that a database or corresponding data structure (i.e., the physical and logical organization of data elements as they exist within a given database) and its associated data entries need or should satisfy in order to be associated with the schema. In some embodiments, the schema is data structure agnostic, meaning that the rules, definitions, and relationships defined may be independent of any underlying physical or logical database architecture. In other words, the schema may not rely on a specific table layout, column order, storage format, or platform-specific implementation. In this context, applying a schema refers to the process of using a predefined set of abstract rules and definitions to standardize how data is interpreted and organized across multiple user-facing applications and/or associated data structures. Once applied, the schema may facilitate interoperability, aggregation, and unified reporting across heterogeneous user-facing applications, regardless of their native template. Process 2900 includes a step 2904 of applying a schema across at least two user-facing applications, as illustrated in FIG. 29.

FIG. 30C is an illustration of a schema 3050 comprising a predefined set of rules and definitions, consistent with the disclosed embodiments. Schema 3050 corresponds to a Sales schema entity, which defines a plurality of data fields and associated data types that a user-facing application and/or associated data structure is required to include in order to be associated with the sales schema entity. Specifically, to be associated with the sales schema entity, a data structure associated with a user-facing application must include at least four data fields: a “Name” data field of type “text”, a “Size” data field of type “number”, an “Pipeline phase” data field of type “Status”, and a “Priority Level” data field of type “priority”. Certain specialized data types, such as “status” and “priority”, may impose additional constraints on the data entries (e.g., list of potential values). For example the “status” data type may require that the data entry correspond to a predefined set of sales pipeline status, such as “Lead,” “Negotiation,” or “Won.” Similarly, the “priority” data type may require that the data entry correspond to one of a predefined set of levels, such as “High,” “Medium,” or “Low.” Schema 3050 may be maintained within a SaaS platform, and as described further below, may be implemented to enable the association of one or more user-facing applications therewith, such as user-facing applications 3000a and 3000b.

Some disclosed embodiments involve receiving mapping information, wherein the mapping information identifies schema-compliant data entries included in the at least two user-facing applications. Mapping refers to the process of creating a correspondence between the data fields and associated entries of a database/data structure associated with a user-facing application, on the one hand, and the predefined set of rules and definitions included in the schema, on the other hand. Such mapping enables heterogeneous data structures, which may differ in terminology, data type, permissible values, or organizational conventions, to be reconciled and aligned under a unified schema framework. Mapping information may serve as a critical bridge between the native structure of each user-facing application and the schema's abstract framework. In some embodiments, schema-compliant data entries from the at least two user-facing applications is associated with data fields of different names and/or of different data types. For example, referring to FIGS. 30A-C, mapping information may indicate that a field labeled “Priority” in user-facing application 3000a and “Level” in user-facing application 3000b both map to the “Priority Level” definition of schema 3050, even if some data field names differ and even if user-facing application 3000a uses numeric values and user-facing application 3000b uses textual labels. Process 2900 includes a step 2906 of receiving mapping information, as illustrated in FIG. 29.

In some embodiments, receiving mapping information includes performing a compliance check on data entries of each of the at least two user-facing applications using the predefined set of rules and definitions of the schema to identify schema-compliant data entries. The compliance check may serve as a validation process to determine whether the data entries within each user-facing application meet the schema's requirements, such as the presence of specific fields, expected data types, and permissible value sets. By executing this compliance check, portions of the data that are schema-compliant and therefore eligible for standardized interpretation and integration may be identified. This process may enable semantic alignment across applications that may differ in structure, terminology, or origin. The compliance check may be performed automatically, in real time as data is added or updated, or periodically as part of schema maintenance. Once completed, the results of the check form the basis of the mapping information, which links native data entries to schema-defined categories and facilitates interoperability across heterogeneous user-facing applications.

Additionally, in some embodiments, performing the compliance check includes using a machine learning model trained to identify common patterns in unlabelled data fields. Such a machine learning model may leverage techniques such as natural language processing (NLP), semantic analysis, and statistical pattern recognition to infer the meaning and structure of data entries, even when explicit labels are absent or vary across applications. For example, the machine learning model may recognize that numerical values ranging from 1 to 5 in user-facing application 3000a and textual labels like “High,” “Medium,” and “Low” in user-facing application 3000b both represent priority levels, despite differing formats.

Some disclosed embodiments involve associating the identified schema-compliant data entries included in the at least two user-facing applications with the schema. In other words, after receiving the mapping information and identifying schema-compliant data entries, the at least two user-facing applications may become formally associated with the schema. This inclusion may allow the schema-compliant data entries in schema-driven operations. By becoming part of the schema-associated group, the schema-compliant data entries gain access to a unified framework for data interpretation, enabling consistent aggregation, cross-database querying, and execution of schema-level commands. This means that even if the at least user-facing applications were originally created independently from two different templates, they can now be integrated into broader workflows and reporting mechanisms that rely on schema-defined standards. Process 2900 includes a step 2908 of associating identified schema-compliant data entries with a schema, as illustrated in FIG. 29.

The schema association does not interfere with or override the central governance of the respective templates. The schema does not alter the internal structure or layout of the user-facing applications; instead, it acts as a semantic layer that translates and aligns their underlying data for consistent interpretation across the platform. A template governs the structure of a user-facing application. A template defines the layout, data format, and operational rules, such as which fields are present, how they are labeled, what types of values are allowed, etc. A schema, on the other hand, operates at a deeper, more abstract level, as a schema does not impose structure on the application itself but instead acts as a semantic layer that interprets and aligns the data entries across different applications. Put differently, templates ensure structural consistency at the interface level, while schemas ensure semantic coherence at the data level, and therefore, both can work together effectively.

Some disclosed embodiments involve translating one or more high-level commands applicable across the at least two user-facing applications, wherein the schema translates the one or more high-level commands into instructions adapted to the at least one data structure governed by the specific template of each of the at least two user-facing applications to execute an intended action. A high-level command refers to an abstract or schema-level instruction specifying a desired operation or analysis on data included in the at least two user-facing applications, without requiring knowledge of underlying structure, format, or implementation details of the individual user-facing application. Examples of high-level commands include, but are not limited to, aggregating data, filtering entries based on specific criteria, updating fields, generating reports, calculating statistics, or performing cross-database comparisons. The schema may be configured to translate each high-level command into instructions that are adapted to the specific data structures of each of the at least two user-facing applications, such that the intended action can be executed correctly for each user-facing application. For example, if a high-level command requests the aggregation of data to count the number of occurrences of a particular entries, the schema may translate this command to identify the appropriate fields and/or entries in each data structure associated with the user-facing-application, regardless of differences in column names, data types, or layouts, and then execute the counting operation on the relevant data. Process 2900 includes a step 2908 of translating one or more high-level commands applicable across the at least two user-facing applications, as illustrated in FIG. 29.

In some embodiments, the one or more high-level commands include aggregating schema-compliant data entries from the at least two user-facing applications associated with the schema. The aggregation is performed in accordance with the predefined set of rules of the schema. By performing the aggregation in accordance with the schema, data entries that may differ in structure, terminology, or format across the at least two user-facing applications may be interpreted and processed uniformly, ensuring that the resulting dataset is standardized and semantically consistent. Additionally, in some embodiments, the one or more high-level commands include generating a unified report based on the aggregated data entries. The unified report present schema-compliant data entries standardized across the at least two user-facing applications. In other words, such a report may present schema-compliant data entries in a standardized format, thereby enabling a coherent, cross-database view of the information. For instance, the unified report may include summaries, statistics, or other derived information that reflects the combined data from the at least two user-facing applications. Additionally, in some embodiments, the unified report is generated following a request received from at least one SaaS platform user having access to the at least two user-facing applications.

Referring to FIGS. 30A-30C, a SaaS platform user, such as a sales manager overseeing both U.S. and European teams, may issue a high-level command to aggregate sales data across the two territories and generate a unified report. In response, the schema 3050 may first map the fields from each user-facing application (3000a and 3000b) to the corresponding schema-defined fields, resolving differences in terminology, structure, and data types. Once the mapping is complete, the schema may translate the high-level aggregation command into tailored instructions that are compatible with the data structures of each application 3000a and 3000b. This may ensure that sales records, regardless of the labels being used and whether they are recorded in dollars or euros, are interpreted consistently. Based on this aggregation, the schema may generate a unified report that presents a consolidated, schema-standardized view of all sales activity across both teams. The report may include total sales figures, deal stages, priority levels, and other relevant metrics, all harmonized under the schema framework.

In some embodiments, the one or more high-level commands may include implementing at least one additional rule to schema-compliant data entries from the at least two user-facing applications associated with the schema. As used herein, an additional rule refers to a rule or constraint that is applied at the level of the aggregated or schema-compliant data, beyond the predefined rules and definitions of the schema itself. Such rules may specify operations, validations, transformations, or business logic to be applied to the data entries after they have been identified as compliant with the schema. For example, an additional rule may include filtering schema-compliant entries to select only those meeting a certain condition, such as filtering and aggregating the sales deals that are won.

Some disclosed embodiments further involve, upon detecting an update to one of the respective templates governing the at least two user-facing applications, performing a re-evaluation to determine whether the corresponding user-facing application remains associated with the schema based on the updated template. While a user-facing application can simultaneously be governed by a template and associated with a schema, certain changes to the underlying template, and by extension, to the user-facing application's data structure, may disrupt this schema linkage. For example, if a template update removes or renames a required field that was previously mapped to a schema-defined attribute, the application may no longer meet the schema's compliance criteria. Similarly, if the data types or value sets of key fields are altered in a way that conflicts with the schema's predefined rules, the semantic alignment may be compromised. In such cases, a re-evaluation process may be triggered to reassess compliance, update mappings, or prompt corrective actions to restore schema association. This mechanism may ensure that schema-linked operations, such as unified reporting, aggregation, and cross-application querying, can remain accurate and reliable, even as templates evolve independently. The re-evaluation process may also preserve the integrity of the schema framework by continuously validating that associated applications conform to its standards.

In some embodiments, the re-evaluation identifies portions of the data structure governed by the at least one updated respective template that remain schema-compliant and selectively retain partial association of the corresponding user-facing application with the schema. If certain fields or entries remain compliant, selective partial association may be retained between the user-facing application and the schema. In other words, even if the template update alters some aspects of the user-facing application's structure or data definitions, the schema may continue to operate on the compliant portions, preserving interoperability and enabling continued participation in schema-driven operations such as aggregation, reporting, and querying.

Alternatively, in some embodiments, if the re-evaluation determines non-compliance of at least one updated template with the predefined set of rules and definitions of the schema, the corresponding user-facing application is automatically disassociated from the schema. This disassociation may ensure that only data structures and corresponding user-facing applications meeting the schema's standards remain part of the schema-linked ecosystem, preserving the integrity and consistency of schema-driven operations such as aggregation, reporting, and cross-application querying. The automatic disassociation process may be triggered when critical changes to the template, such as the removal of required fields, alteration of data types, or restructuring of key relationships, result in the application's data no longer satisfying the schema's compliance criteria. Once disassociated, the user-facing application will no longer participate in schema-level commands or unified reporting until it is re-evaluated and/brought back into alignment, either through manual adjustments or further template updates. Some disclosed embodiments further involve notifying an associated user of the schema of the disassociation and the reason for schema non-compliance. The notification may include information such as which required fields were removed, which data types were altered, or what structural changes introduced incompatibilities with the schema. By surfacing these details, the user may understand the impact of recent template updates and take appropriate action. This may include modifying the application to restore schema compliance or, if the template is governed by another user, initiating communication with the template owner to address the incompatibility.

In some embodiments, updates to the respective templates governing at least two user-facing applications are tracked via version control, and historical compliance status with the schema is recorded for each version. By maintaining this historical record, traceability and accountability in schema governance may be enabled. Users may review past versions to understand when and why a user-facing application became compliant or non-compliant with the schema. This may be particularly useful in collaborative environments where templates are managed by different users or teams, as it provides visibility into how structural changes impact schema association. Moreover, version-controlled compliance tracking may support intelligent schema management. For example, if a recent update causes a loss of compliance, a previous version may be referenced to suggest corrective actions or even allow rollback to a schema-compliant state.

While the disclosed and illustrated processes describe different aspects of management and organization of resources within a collaborative work system, in some embodiments, the steps within the disclosed processes may be combined with each other or integrated into a more comprehensive process. This global process may be implemented using one or more components of a computing device 200 (as discussed in FIG. 2A) or a user device 254 within the computing architecture 250 (as discussed in FIG. 2B). The disclosed embodiments may involve at least one processor configured to execute stored instructions for performing the global process. By combining the steps from various processes or designing a more extensive process, the disclosed embodiments provide a seamless integration of various enhanced computer functionalities into a unified system. The computing resources and processors disclosed herein may play a key role in executing the instructions that drive such a unified or global process.

In some examples, a trained machine learning algorithm may be used as an inference model that when provided with an input generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value for the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an image, and the inferred output may include a classification of an item depicted in the image. In yet another example, a trained machine learning algorithm may include a regression model, the input may include an image, and the inferred output may include an inferred value for an item depicted in the image (such as an estimated property of the item, such as size, volume, age of a person depicted in the image, cost of a product depicted in the image, and so forth). In an additional example, a trained machine learning algorithm may include an image segmentation model, the input may include an image, and the inferred output may include a segmentation of the image. In yet another example, a trained machine learning algorithm may include an object detector, the input may include an image, and the inferred output may include one or more detected objects in the image and/or one or more locations of objects within the image. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs. Some non-limiting examples of such artificial neural networks may include shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long/short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

Differing embodiments of this disclosure may involve systems, methods, and/or computer readable media containing instructions. A system refers to at least two interconnected or interrelated components or parts that work together to achieve a common objective, function, or subfunction. A method refers to at least two steps, actions, or techniques to be followed to complete a task or a sub-task, to reach an objective, or to arrive at a next step. Computer-readable media containing instructions refers to any storage mechanism that contains program code instructions, for example to be executed by a computer processor. Examples of computer-readable media are further described elsewhere in this disclosure. Instructions may be written in any type of computer programming language, such as an interpretive language (e.g., scripting languages such as HTML and JavaScript), a procedural or functional language (e.g., C or Pascal that may be compiled for converting to executable code), an object-oriented programming language (e.g., Java or Python), a logical programming language (e.g., Prolog or Answer Set Programming), and/or any other programming language. Instructions executed by at least one processor may include implementing one or more program code instructions in hardware, in software (including in one or more signal processing and/or application specific integrated circuits), in firmware, or in any combination thereof, as described earlier. Causing a processor to perform operations may involve causing the processor to calculate, execute, or otherwise implement one or more arithmetic, mathematic, logic, reasoning, or inference steps.

Examples of inventive concepts are contained in the following clauses which are an integral part of this disclosure.

Clause 1. A non-transitory computer-readable medium containing instructions that, when executed by at least one processor, cause the at least one processor to perform operations for governing a centralized framework that enforces a hierarchical relationship between a template and a plurality of user-facing applications implementing the template, the operations comprising:
maintaining a data structure storing a template integrable with a plurality of user-facing applications, wherein the template includes a data format, at least one existing pre-population rule for configuring data within the data format, variable definitions, and metadata that links each of the plurality of user-facing applications to the template;
establishing control between the template and the plurality of user-facing applications, wherein each of the plurality of user-facing applications is structurally and functionally dependent on the template through the metadata;
providing an interface for modifying the template, wherein modifications to the template are centrally managed and propagated to each of the plurality of user-facing applications in which the template is integrated;
updating and enforcing template modifications across each of the plurality of user-facing applications; and
maintaining hierarchical governance between the template and each of the plurality of user-facing applications, wherein modifications to the template are inherited by each of the plurality of user-facing applications.

Clause 2. The non-transitory computer-readable medium of clause 1, wherein modifications to the template include at least one of modifications to the data format, variable definitions, or the at least one pre-population rule.

Clause 3. The non-transitory computer-readable medium of any of clauses 1 to 2, wherein at least one of the plurality of user-facing applications is a private user-facing application, and wherein data included in the private user-facing application is not accessible by the interface.

Clause 4. The non-transitory computer-readable medium of any of clauses 1 to 3, wherein the private user-facing application is governed by the template through metadata enforcement.

Clause 5. The non-transitory computer-readable medium of any of clauses 1 to 4, wherein at least one of a name or an owner of the private user-facing application is accessible by the interface.

Clause 6. The non-transitory computer-readable medium of any of clauses 1 to 5, wherein:
at least one of the plurality of user-facing applications in which the template is integrated is a sub-template integrable with an additional plurality of user-facing applications different from the plurality of user-facing applications, wherein the sub-template includes the data format, variable definitions, at least one additional existing pre-population rule for configuring the data within the data format different from the at least one pre-population rule, and metadata that linking each of the additional plurality of user-facing applications to the sub-template; and
updating and enforcing template modifications across each of the plurality of user-facing applications includes updating and enforcing template modifications to the sub-template in which the template is integrated thereby generating modifications to the sub-template and updating and enforcing sub-template modifications across each of the additional plurality of user-facing applications in which the sub-template is integrated.

Clause 7. The non-transitory computer-readable medium of any of clauses 1 to 6, wherein relationships between the sub-template and the additional plurality of user-facing applications are stored in the data structure.

Clause 8. The non-transitory computer-readable medium of any of clauses 1 to 7, wherein relationships between the template and the plurality of user-facing applications are stored in the data structure.

Clause 9. The non-transitory computer-readable medium of any of clauses 1 to 8, wherein the data format includes a table format.

Clause 10. The non-transitory computer-readable medium of any of clauses 1 to 9, wherein the at least one pre-population rule configuring data within the data format includes a pre-population rule configuring content of at least one cell within the table format.

Clause 11. The non-transitory computer-readable medium of any of clauses 1 to 10, wherein the at least one pre-population rule configuring data within the data format includes a plurality of pre-population rules configuring a content of a plurality of cells within the table format.

Clause 12. The non-transitory computer-readable medium of any of clauses 1 to 11, wherein the operations further comprise generating and presenting on the interface a snapshot of an updated template incorporating modifications.

Clause 13. The non-transitory computer-readable medium of any of clauses 1 to 12, wherein the operations further comprise transmitting a notification to each of the plurality of user-facing applications in which the template is integrated, wherein the notification is configured to inform an owner of the user-facing application that the template has been modified.

Clause 14. The non-transitory computer-readable medium of any of clauses 1 to 13, wherein updating and enforcing template modifications is performed automatically or is performed after receiving from the interface a signal for updating and enforcing template modifications.

Clause 15. The non-transitory computer-readable medium of any of clauses 1 to 14, wherein at least a portion of the data format is unaffected by the at least one pre-population rule.

Clause 16. The non-transitory computer-readable medium of any of clauses 1 to 15, wherein at least a portion of the data format is unaffected by the modifications to the template.

Clause 17. The non-transitory computer-readable medium of any of clauses 1 to 16, wherein the operations further comprise receiving via the interface, instructions to generate permission rules blocking access to at least a portion of the data for at least some users of the plurality of user-facing applications in which the template is integrated.

Clause 18. The non-transitory computer-readable medium of any of clauses 1 to 17, wherein the operations further comprise:
receiving utilization data from at least some of the plurality of user-facing applications;
aggregating utilization data; and
generating suggestions for implementing modifications to the template based on aggregated utilization data.

Clause 19. A method for governing a centralized framework that enforces a hierarchical relationship between a template and a plurality of user-facing applications implementing the template, the method comprising:
maintaining a data structure storing a template integrable with a plurality of user-facing applications, wherein the template includes a data format, at least one existing pre-population rule for configuring data within the data format, variable definitions, and metadata that link each of the plurality of user-facing applications to the template;
establishing control between the template and the plurality of user-facing applications, wherein each of the plurality of user-facing applications is structurally and functionally dependent on the template through the metadata;

providing an interface for modifying the template, wherein modifications to the template are centrally managed and propagated to each of the plurality of user-facing applications in which the template is integrated;
updating and enforcing template modifications across each of the plurality of user-facing applications; and
maintaining hierarchical governance between the template and each of the plurality of user-facing applications, wherein modifications to the template are inherited by each of the plurality of user-facing applications.

Clause 20. A system for governing a centralized framework that enforces a hierarchical relationship between a template and a plurality of user-facing applications implementing the template, the system comprising:
at least one processor configured to:
   maintain a data structure storing a template integrable with a plurality of user-facing applications, wherein the template includes a data format, at least one existing pre-population rule for configuring data within the data format, variable definitions, and metadata that link each of the plurality of user-facing applications to the template;
   establish control between the template and the plurality of user-facing applications, wherein each of the plurality of user-facing applications is structurally and functionally dependent on the template through the metadata;
   provide an interface for modifying the template, wherein modifications to the template are centrally managed and propagated to each of the plurality of user-facing applications in which the template is integrated;
   update and enforce template modifications across each of the plurality of user-facing applications; and
   maintain hierarchical governance between the template and each of the plurality of user-facing applications, wherein modifications to the template are inherited by each of the plurality of user-facing applications.

Clause 21. A non-transitory computer-readable medium containing instructions that, when executed by at least one processor, cause the at least one processor to perform operations for controlling access to information included in user-facing software integrating a template, the operations comprising:
accessing a data structure storing a template integrateable with a plurality of user-facing applications, and wherein the template includes a data format and at least one existing pre-population rule for configuring data within the data format;
receiving from a user, via an interface for editing the template, instructions to generate at least one permission rule configured to block control, by at least some users of the plurality of user-facing applications in which the template is integrated, of at least a portion of the data included in the data format;
receiving from the user via the interface for editing the template, instructions to modify the template;
updating the template by including the newly generated permission rule and modifications in the template;
determining compatibility of each user-facing application with the updated template by analyzing a current state of each of the plurality of user-facing applications; and
pushing the updated template to the plurality of user-facing applications integrable with the template by:
   identifying differences between the updated template and each user-facing application;
   generating a set of updates that apply only the determined differences to each of the plurality user-facing applications; and
   applying the set of updates to each of the plurality of user-facing applications.

Clause 22. The non-transitory computer-readable medium of any of clauses 1 to 21, wherein relationships between the template and the plurality of user-facing applications are stored in the data structure.

Clause 23. The non-transitory computer-readable medium of any of clauses 1 to 22, wherein the data format includes a table format.

Clause 24. The non-transitory computer-readable medium of any of clauses 1 to 23, wherein the at least one permission rule is configured to block control of at least one cell within the table format.

Clause 25. The non-transitory computer-readable medium of any of clauses 1 to 24, wherein the at least one permission rule is configured to block control of at least one column within the table format.

Clause 26. The non-transitory computer-readable medium of any of clauses 1 to 25, wherein the operations further comprise transmitting a notification to each of the plurality of user-facing applications in which the template is integrated, wherein the notification is configured to inform users of the user-facing application concerned by the permission rules that control of the at least a portion of the data included in the data format is prohibited.

Clause 27. The non-transitory computer-readable medium of any of clauses 1 to 26, wherein pushing the updated template to the plurality of user-facing applications includes receiving from the interface a signal for pushing the updated template.

Clause 28. The non-transitory computer-readable medium of any of clauses 1 to 27, wherein pushing the updated template to the plurality of user-facing applications includes pushing the updated template while at least some of the plurality of user-facing applications are in use.

Clause 29. The non-transitory computer-readable medium of any of clauses 1 to 28, wherein the at least one permission rule is configured to block control of at least a first portion of the data included in the data format to at least some first users of the plurality of user-facing applications and to block control of at least a second portion of the data included in the data format to at least some second users of the plurality of user-facing applications.

Clause 30. The non-transitory computer-readable medium of any of clauses 1 to 29, wherein the set of updates includes, when at least one of the user-facing applications has missed one or more previous template updates, applying only the differences between a most recent template update and the at least one user-facing application.

Clause 31. The non-transitory computer-readable medium of any of clauses 1 to 30, wherein the set of updates includes adapting structural changes in the updated template to each of the plurality of user-facing applications in a manner minimizing impact of the structural changes on each of the plurality of user-facing applications.

Clause 32. The non-transitory computer-readable medium of any of clauses 1 to 31, wherein the set of updates includes detecting whether at least one of the plurality of user-facing applications already incorporates one or more modifications included in the updated template and, in response, converting corresponding resources in the user-facing application.

Clause 33. The non-transitory computer-readable medium of any of clauses 1 to 32, wherein the set of updates further includes:
detecting dependencies between the updated template and pre-existing configurations in each user-facing application; and applying adjustments to resolve conflicts before integrating the updates into each user-facing application.

Clause 34. The non-transitory computer-readable medium of any of clauses 1 to 33, wherein the set of updates includes identifying and preserving user-customized elements within each user-facing application while integrating changes from the updated template.

Clause 35. The non-transitory computer-readable medium of any of clauses 1 to 34, wherein the operations further comprise:
inputting the differences between the updated template and each user-facing application into an AI agent;
processing the differences with the AI agent to ascertain consequences for each user-facing application resulting from the updated template, and to develop a textual explanation of the consequences of the updated template; and
sending to an owner of each user-facing application a notification configured to provide the textual explanation of consequences of the updated template.

Clause 36. The non-transitory computer-readable medium of any of clauses 1 to 35, wherein sending the notification occurs while the updated template is pushed.

Clause 37. The non-transitory computer-readable medium of any of clauses 1 to 36, wherein sending the notification occurs after the updated template is pushed.

Clause 38. A method for controlling access to information included in user-facing software integrating a template, the method comprising:
accessing a data structure storing a template integrateable with a plurality of user-facing applications, and wherein the template includes a data format and at least one existing pre-population rule for configuring data within the data format;
receiving from a user, via an interface for editing the template, instructions to generate at least one permission rule configured to block control by at least some users of the plurality of user-facing applications in which the template is integrated, of at least a portion of the data included in the data format;
receiving from the user via the interface for editing the template, instructions to modify the template;
updating the template by including the newly generated permission rule and modifications in the template;
determining compatibility of each user-facing application with the updated template by analyzing a current state of each of the plurality of user-facing applications; and
pushing the updated template to the plurality of user-facing applications integrable with the template by:
   identifying differences between the updated template and each user-facing application;
   generating a set of updates that apply only the determined differences to each of the plurality user-facing applications; and
   applying the set of updates to each of the plurality of user-facing applications.

Clause 39. The method of any of clauses 1 to 38, wherein relationships between the template and the plurality of user-facing applications are stored in the data structure.

Clause 40. A system for controlling access to information included in user-facing software integrating a template, the system comprising:
at least one processor configured to:
   access a data structure storing a template integrateable with a plurality of user-facing applications, and wherein the template includes a data format and at least one existing pre-population rule for configuring data within the data format;
   receive from a user, via an interface for editing the template, instructions to generate at least one permission rule configured to block control by at least some users of the plurality of user-facing applications in which the template is integrated, of at least a portion of the data included in the data format;
   receive from the user via the interface for editing the template, instructions to modify the template;
   update the template by including the newly generated permission rule and modifications in the template;
   determine compatibility of each user-facing application with the updated template by analyzing a current state of each of the plurality of user-facing applications; and
push the updated template to the plurality of user-facing applications integrable with the template by:
   identifying differences between the updated template and each user-facing application;
   generating a set of updates that apply only the determined differences to each of the plurality user-facing applications; and
   applying the set of updates to each of the plurality of user-facing applications.

Clause 41. A non-transitory computer-readable medium storing instructions that, when executed by at least one processor, cause the at least one processor to perform operations for consolidating data from multiple data sources, the operations comprising:
accessing data from at least two differently structured databases, each of the at least two differently structured databases being associated with at least one data structure including data fields;
in a SaaS platform, maintaining a schema including a predefined set of rules and definitions configured to standardize interpretation and organization of data entries across the at least two differently structured databases;
implementing the schema to:
   for each of the at least two differently structured databases, use the predefined set of rules of the schema to perform a compliance check on at least one portion of the data entries;
   upon determining compliance of the at least one portion of the data entries with the predefined set of rules of the schema, identify schema-compliant data entries and associate each of the at least two differently structured databases with the schema;
   enable interaction between the at least two differently structured databases; and
   facilitate issuance of one or more high-level commands applicable across the at least two differently structured databases, wherein the schema translates the one or more high-level commands into instructions adapted to the at least one data structure of each of the at least two differently structured databases to execute an intended action.

Clause 42. The non-transitory computer-readable medium of any of clauses 1 to 41, wherein the at least two differently structured databases are maintained without a shared governing schema.

Clause 43. The non-transitory computer-readable medium of any of clauses 1 to 42, wherein the schema is data structure agnostic.

Clause 44. The non-transitory computer-readable medium of any of clauses 1 to 43, wherein the association within the schema is independent of locations of data fields within the at least two differently structured.

Clause 45. The non-transitory computer-readable medium of any of clauses 1 to 44,
wherein performing the compliance check includes at least one of: verifying that the least one portion of the data entries of each of the at least two
differently structured databases fits the predefined set of rules of the schema; or running the predefined set of rules to identify matching inputs in the least one portion of the data entries of each of the at least two differently structured databases.

Clause 46. The non-transitory computer-readable medium of any of clauses 1 to 45, wherein data entries of different types match one rule of the predefined set of rules.

Clause 47. The non-transitory computer-readable medium of any of clauses 1 to 46, wherein the at least two differently structured databases include two databases including identical data entries located at different positions within the databases.

Clause 48. The non-transitory computer-readable medium of any of clauses 1 to 47, wherein identifying schema-compliant data entries includes mapping data fields and associated entries of the at least two differently structured databases with the predefined set of rules and definitions included in the schema.

Clause 49. The non-transitory computer-readable medium of any of clauses 1 to 48, wherein the operations further comprise, after association of each of the at least two differently structured databases with the schema, maintaining the association of each of the at least two differently structured databases by updating the mapping.

Clause 50. The non-transitory computer-readable medium of any of clauses 1 to 49, wherein the operations further comprise, when at least one of the at least two differently structured databases fails to pass the compliance check, identifying one or more issues with the predefined set of rules of the schema and suggesting one or more actions to resolve the one or more issues.

Clause 51. The non-transitory computer-readable medium of any of clauses 1 to 50, wherein associating each of the at least two differently structured databases with the schema includes associating an entirety of each of the at least two differently structured databases and wherein the entirety of each of the at least two differently structured databases is accessible within the schema.

Clause 52. The non-transitory computer-readable medium of any of clauses 1 to 51, wherein each of the at least two differently structured databases associated with the schema includes schema-compliant data entries and non-schema-compliant data entries.

Clause 53. The non-transitory computer-readable medium of any of clauses 1 to 52, wherein one schema-compliant data field corresponds to two or more different data fields included in the at least two differently structured databases.

Clause 54. The non-transitory computer-readable medium of any of clauses 1 to 53, wherein the one or more high-level commands include:
aggregating schema-compliant data entries from the at least two differently structured databases associated with the schema, wherein the aggregation is performed in accordance with the predefined set of rules of the schema; and
generating a unified report based on the aggregated data entries, the unified report presenting schema-compliant data entries standardized across the at least two differently structured databases, wherein the unified report is generated following a request received from at least one SaaS platform user.

Clause 55. The non-transitory computer-readable medium of any of clauses 1 to 54, wherein the one or more high-level commands include implementing at least one additional rule to schema-compliant data entries from the at least two differently structures databases associated with the schema.

Clause 56. The non-transitory computer-readable medium of any of clauses 1 to 55, wherein the compliance check with the predefined set of rules included in the schema is performed in real time as new data entries are added to the at least two differently structured databases.

Clause 57. The non-transitory computer-readable medium of any of clauses 1 to 56, wherein the schema supports user-defined extensions to allow at least one SaaS platform user to customize the data schema.

Clause 58. The non-transitory computer-readable medium of any of clauses 1 to 57, wherein identifying schema compliant data entries is performed using a machine learning model trained to identify common patterns in unlabeled data fields.

Clause 59. A method for consolidating data from multiple data sources, the method comprising:
accessing data from at least two differently structured databases, each of the at least two differently structured databases being associated with at least one data structure including data fields;
in a SaaS platform, maintaining a schema including a predefined set of rules and definitions configured to standardize interpretation and organization of data entries across the at least two differently structured databases;
implementing the schema to:
   for each of the at least two differently structured databases, use the predefined set of rules of the schema to perform a compliance check on at least one portion of the data entries;
   upon determining compliance of the at least one portion of the data entries with the predefined set of rules of the schema, identify schema-compliant data entries and associate each of the at least two differently structured databases with the schema;
   enable interaction between the at least two differently structured databases; and
   facilitate issuance of one or more high-level commands applicable across the at least two differently structured databases, wherein the schema translates the one or more high-level commands into instructions adapted to the at least one data structure of each of the at least two differently structured databases to execute an intended action.

Clause 60. A system for consolidating data from multiple data sources, the system comprising:
at least one processor configured to:
   access data from at least two differently structured databases, each of the at least two differently structured databases being associated with at least one data structure including data fields;
   in a SaaS platform, maintain a schema including a predefined set of rules and definitions configured to standardize interpretation and organization of data entries across the at least two differently structured databases;
   implement the schema to:
      for each of the at least two differently structured databases, use the predefined set of rules of the schema to perform a compliance check on at least one portion of the data entries;
      upon determining compliance of the at least one portion of the data entries with the predefined set of rules of the schema, identify schema-compliant data entries and associate each of the at least two differently structured databases with the schema;
      enable interaction between the at least two differently structured databases; and
      facilitate issuance of one or more high-level commands applicable across the at least two differently structured databases, wherein the schema translates the one or more high-level commands into instructions adapted to the at least one data structure of each of the at least two differently structured databases to execute an intended action.

Clause 61. A non-transitory computer-readable medium containing instructions that, when executed by at least one processor, cause the at least one processor to perform operations for bottom-up data structure development, the operations comprising:
in a SaaS platform, maintaining a schema, including a predefined set of rules and definitions configured to standardize interpretation and organization of data entries across a group of data structures, wherein each data structure of the group is associated with the schema and includes data fields and associated entries;
accessing an additional data structure including data fields and associated entries, wherein the additional data structure is differently structured than at least one data structure from the group of data structures and is not initially associated with the schema;
receiving a signal to associate the additional data structure with the schema;
performing a compliance check on at least one portion of the entries within the additional data structure with the predefined set of rules and definitions of the schema;
upon determining compliance of the at least one portion of the entries with the predefined set of rules and definitions of the schema, mapping data fields and associated entries of the additional data structure with the predefined set of rules and definitions included in the schema; and
adding the additional data structure to the group of data structures, to thereby establish compatibility and standardization across the group of data structures.

Clause 62. The non-transitory computer-readable medium of any of clauses 1 to 61, wherein the additional data structure is associated with at least one additional schema different from the maintained schema.

Clause 63. The non-transitory computer-readable medium of any of clauses 1 to 62, wherein the signal to associate the additional data structure with the schema is received from a SaaS platform user.

Clause 64. The non-transitory computer-readable medium of any of clauses 1 to 63, wherein the signal to associate the additional data structure with the schema is generated in response to a data recognition framework applied to the data fields and associated entries of the additional data structure, the data recognition framework being configured to identify similarities between the data fields and associated entries of the additional data structure, and the predefined set of rules and definitions included in the schema.

Clause 65. The non-transitory computer-readable medium of any of clauses 1 to 64, wherein applying a data recognition framework includes using artificial intelligence.

Clause 66. The non-transitory computer-readable medium of any of clauses 1 to 65, wherein the operations further comprise presenting on an interface the similarities identified by the applied data recognition framework.

Clause 67. The non-transitory computer-readable medium of any of clauses 1 to 66, wherein the operations further comprise querying, via the interface, for accuracy confirmation of the presented similarities.

Clause 68. The non-transitory computer-readable medium of any of clauses 1 to 67, wherein the operations further comprise presenting on an interface a compliance score of the at least one portion of the entries within the additional data structure with the predefined set of rules and definitions of the schema.

Clause 69. The non-transitory computer-readable medium of any of clauses 1 to 68, wherein the operations further comprise presenting on the interface suggestions for improving the compliance score of the at least one portion of the entries within the additional data structure.

Clause 70. The non-transitory computer-readable medium of any of clauses 1 to 69, wherein mapping data fields and associated entries of the additional data structure with the predefined set of rules and definitions included in the schema includes using artificial intelligence.

Clause 71. The non-transitory computer-readable medium of any of clauses 1 to 70, wherein mapping data fields and associated entries of the additional data structure with the predefined set of rules and definitions included in the schema includes receiving input from a SaaS platform user via an interface.

Clause 72. The non-transitory computer-readable medium of any of clauses 1 to 71, wherein the operations further comprise applying metadata definitions to the additional data structure associated with the schema.

Clause 73. The non-transitory computer-readable medium of any of clauses 1 to 72, wherein the operations further comprise updating schema reports based on entries included within the additional data structure.

Clause 74. The non-transitory computer-readable medium of any of clauses 1 to 73, wherein mapping data fields and associated entries of the additional data structure with the predefined set of rules and definitions included in the schema includes mapping one or more different data types to a given definition of the schema.

Clause 75. The non-transitory computer-readable medium of any of clauses 1 to 74, wherein mapping data fields and associated entries of the additional data structure with the predefined set of rules and definitions included in the schema includes mapping one or more different data entries to a given definition of the schema.

Clause 76. The non-transitory computer-readable medium of any of clauses 1 to 75, wherein mapping data fields and associated entries of the additional data structure with the predefined set of rules and definitions included in the schema includes running an AI agent configured to analyze at least some of the data fields and associated entries of the additional data structure and to identify a mapping with a given definition of the schema.

Clause 77. A method for bottom-up data structure development, the method comprising:
in a SaaS platform, maintaining a schema, including a predefined set of rules and definitions configured to standardize interpretation and organization of data entries across a group of data structures, wherein each data structure of the group is associated with the schema and includes data fields and associated entries;
accessing an additional data structure including data fields and associated entries, wherein the additional data structure is differently structured than at least one data structure from the group of data structures and is not initially associated with the schema;
receiving a signal to associate the additional data structure with the schema;
performing a compliance check on at least one portion of the entries within the additional data structure with the predefined set of rules and definitions of the schema;
upon determining compliance of the at least one portion of the entries with the predefined set of rules and definitions of the schema, mapping data fields and associated entries of the additional data structure with the predefined set of rules and definitions included in the schema; and
adding the additional data structure to the group of data structures, to thereby establish compatibility and standardization across the group of data structures.

Clause 78. The method of any of clauses 1 to 77, wherein the signal to associate the additional data structure with the schema is generated in response to a data recognition framework applied to the data fields and associated entries of the additional data structure, the data recognition framework being configured to identify similarities between the data fields and associated entries of the additional data structure and the predefined set of rules and definitions included in the schema.

Clause 79. A system for bottom-up data structure development, the system comprising:
at least one processor configured to:
in a SaaS platform, maintain a schema, including a predefined set of rules and definitions configured to standardize interpretation and organization of data entries across a group of data structures, wherein each data structure of the group is associated with the schema and includes data fields and associated entries;
access an additional data structure including data fields and associated entries, wherein the additional data structure is differently structured than at least one data structure from the group of data structures and is initially not associated with the schema;
receive a signal to associate the additional data structure with the schema;
perform a compliance check on at least one portion of the entries within the additional
data structure with the predefined set of rules and definitions of the schema;
upon determining compliance of the at least one portion of the entries with the predefined set of rules and definitions of the schema, map data fields and associated entries of the additional data structure with the predefined set of rules and definitions included in the schema; and
add the additional data structure to the group of data structures, to thereby establish compatibility and standardization across the group of data structures.

Clause 80. The system of any of clauses 1 to 79, wherein the signal to associate the additional data structure with the schema is generated in response to a data recognition framework applied to the data fields and associated entries of the additional data structure, the data recognition framework being configured to identify similarities between the data fields and associated entries of the additional data structure and the predefined set of rules and definitions included in the schema.

Clause 81. A non-transitory computer-readable medium storing instructions that, when executed by at least one processor, cause the at least one processor to perform operations for connecting user-facing applications governed by distinct templates, the operations comprising:
in a SaaS platform, accessing data of at least two user-facing applications, wherein each of the at least two user-facing applications is dependent on a respective template through metadata and is associated with at least one data structure, including data fields and data entries governed by the respective template;
applying a schema including a predefined set of rules and definitions configured to standardize interpretation and organization of data entries across the at least two user-facing applications;
receiving mapping information, wherein the mapping information identifies schema-compliant data entries included in the at least two user-facing applications;
associating the identified schema-compliant data entries included in the at least two user-facing applications with the schema; and
translating one or more high-level commands applicable across the at least two user-facing applications, wherein the schema translates the one or more high-level commands into instructions adapted to the at least one data structure governed by the specific template of each of the at least two user facing applications to execute an intended action.

Clause 82. The non-transitory computer-readable medium of any of clauses 1 to 81, wherein each respective template governing each of the at least two user-facing applications is controlled by a different user of the SaaS platform.

Clause 83. The non-transitory computer-readable medium of any of clauses 1 to 82, wherein the at least two user-facing applications include at least two SaaS platform elements of same or different types.

Clause 84. The non-transitory computer-readable medium of any of clauses 1 to 83, wherein the schema is data structure agnostic.

Clause 85. The non-transitory computer-readable medium of any of clauses 1 to 84, wherein the data structure of each of the at least two user-facing applications includes a table format.

Clause 86. The non-transitory computer-readable medium of any of clauses 1 to 85, wherein the one or more high-level commands include:
aggregating schema-compliant data entries from the at least two user-facing applications associated with the schema, wherein the aggregation is performed in accordance with the predefined set of rules of the schema; and
generating a unified report based on the aggregated data entries, the unified report presenting schema-compliant data entries standardized across the at least two user-facing applications.

Clause 87. The non-transitory computer-readable medium of any of clauses 1 to 86, wherein the unified report is generated following a request received from at least one SaaS platform user having access to the at least two user-facing applications.

Clause 88. The non-transitory computer-readable medium of any of clauses 1 to 87, wherein the one or more high-level commands include implementing at least one additional rule to schema-compliant data entries from the at least two user-facing applications associated with the schema.

Clause 89. The non-transitory computer-readable medium of any of clauses 1 to 88, wherein receiving mapping information includes performing a compliance check on data entries of each of the at least two user-facing applications using the predefined set of rules and definitions of the schema to identify schema-compliant data entries.

Clause 90. The non-transitory computer-readable medium of any of clauses 1 to 89, wherein performing the compliance check includes using a machine learning model trained to identify common patterns in unlabeled data fields.

Clause 91. The non-transitory computer-readable medium of any of clauses 1 to 90, wherein schema-compliant data entries from the at least two user-facing applications are associated with data fields of different names.

Clause 92. The non-transitory computer-readable medium of any of clauses 1 to 91, wherein the operations further comprise, upon detecting an update to one of the respective templates governing the at least two user-facing applications, performing a re-evaluation to determine whether the corresponding user-facing application remains associated with the schema based on the updated template.

Clause 93. The non-transitory computer-readable medium of any of clauses 1 to 92, wherein the re-evaluation identifies portions of the data structure governed by the at least one updated respective template that remain schema-compliant and selectively retains partial association of the corresponding user-facing application with the schema.

Clause 94. The non-transitory computer-readable medium of any of clauses 1 to 93, wherein if the re-evaluation determines non-compliance of at least one updated template with the predefined set of rules and definitions of the schema, the corresponding user-facing application is automatically disassociated from the schema.

Clause 95. The non-transitory computer-readable medium of any of clauses 1 to 94, wherein the operations further comprise notifying an associated user of the schema of the disassociation and the reason for schema non-compliance.

Clause 96. The non-transitory computer-readable medium of any of clauses 1 to 95, wherein updates to the respective templates governing the at least two user-facing applications are tracked via version control, and historical compliance status with the schema is recorded for each version.

Clause 97. A method for connecting user-facing applications governed by distinct templates, the method comprising:
in a SaaS platform, accessing data of at least two user-facing applications, wherein each of the at least two user-facing applications is dependent on a respective template through metadata and is associated with at least one data structure, including data fields and data entries governed by the respective template;
applying a schema including a predefined set of rules and definitions configured to standardize interpretation and organization of data entries across the at least two user-facing applications;
receiving mapping information, wherein the mapping information identifies schema-compliant data entries included in the at least two user-facing applications;
associating the identified schema-compliant data entries included in the at least two user-facing applications with the schema; and
translating one or more high-level commands applicable across the at least two user-facing applications, wherein the schema translates the one or more high-level commands into instructions adapted to the at least one data structure governed by the specific template of each of the at least two user facing applications to execute an intended action.

Clause 98. The method of any of clauses 1 to 97, wherein the one or more high-level commands include:
aggregating schema-compliant data entries from the at least two user-facing applications associated with the schema, wherein the aggregation is performed in accordance with the predefined set of rules of the schema; and
generating a unified report based on the aggregated data entries, the unified report presenting schema-compliant data entries standardized across the at least two user-facing applications.

Clause 99. A system for connecting user-facing applications governed by distinct templates, the system comprising:
at least one processor configured to:
   in a SaaS platform, access data of at least two user-facing applications, wherein each of the at least two user-facing applications is structurally and functionally dependent on a respective template through metadata and is associated with at least one data structure, including data fields and data entries governed by the respective template;
   apply a schema including a predefined set of rules and definitions configured to standardize interpretation and organization of data entries across the at least two user-facing applications;
   receive mapping information, wherein the mapping information identifies schema-compliant data entries included in the at least two user-facing applications;
   associate the identified schema-compliant data entries included in the at least two user-facing applications with the schema; and
   translate one or more high-level commands applicable across the at least two user-facing applications, wherein the schema translates the one or more high-level commands into instructions adapted to the at least one data structure governed by the specific template of each of the at least two user facing applications to execute an intended action.

Clause 100. The system of any of clauses 1 to 99, wherein the one or more high-level commands include:
aggregating schema-compliant data entries from the at least two user-facing applications associated with the schema, wherein the aggregation is performed in accordance with the predefined set of rules of the schema; and
generating a unified report based on the aggregated data entries, the unified report presenting schema-compliant data entries standardized across the at least two user-facing applications.

Disclosed embodiments may include any one of the following bullet-pointed features alone or in combination with one or more other bullet-pointed features, whether implemented as a system and/or method, by one or more hardware components disclosed herein, as well as by at least one processor or circuitry, and/or stored as executable instructions on non-transitory computer readable media or computer readable media.
maintaining a data structure storing a template integrable with a plurality of user-facing applications, wherein the template includes a data format, at least one existing pre-population rule for configuring data within the data format, variable definitions, and metadata that links each of the plurality of user-facing applications to the template.
establishing control between the template and the plurality of user-facing applications, wherein each of the plurality of user-facing applications is structurally and functionally dependent on the template through the metadata.
providing an interface for modifying the template, wherein modifications to the template are centrally managed and propagated to each of the plurality of user-facing applications in which the template is integrated.
updating and enforcing template modifications across each of the plurality of user-facing applications.
maintaining hierarchical governance between the template and each of the plurality of user-facing applications, wherein modifications to the template are inherited by each of the plurality of user-facing applications.
modifications to the template include at least one of modifications to the data format, variable definitions, or the at least one pre-population rule.
at least one of the plurality of user-facing applications is a private user-facing application, and wherein data included in the private user-facing application is not accessible by the interface.
private user-facing application is governed by the template through metadata enforcement.
at least one of a name or an owner of the private user-facing application is accessible by the interface.
at least one of the plurality of user-facing applications in which the template is integrated is a sub-template integrable with an additional plurality of user-facing applications different from the plurality of user-facing applications, wherein the sub-template includes the data format, variable definitions, at least one additional existing pre-population rule for configuring the data within the data format different from the at least one pre-population rule, and metadata that linking each of the additional plurality of user-facing applications to the sub-template.
updating and enforcing template modifications across each of the plurality of user-facing applications includes updating and enforcing template modifications to the sub-template in which the template is integrated thereby generating modifications to the sub-template and updating and enforcing sub-template modifications across each of the additional plurality of user-facing applications in which the sub-template is integrated.
relationships between the sub-template and the additional plurality of user-facing applications are stored in the data structure.
relationships between the template and the plurality of user-facing applications are stored in the data structure.
the data format includes a table format.
the at least one pre-population rule configuring data within the data format includes a pre-population rule configuring content of at least one cell within the table format.
the at least one pre-population rule configuring data within the data format includes a plurality of pre-population rules configuring a content of a plurality of cells within the table format.
generating and presenting on the interface a snapshot of an updated template incorporating modifications.
transmitting a notification to each of the plurality of user-facing applications in which the template is integrated, wherein the notification is configured to inform an owner of the user-facing application that the template has been modified.
updating and enforcing template modifications is performed automatically or is performed after receiving from the interface a signal for updating and enforcing template modifications.
at least a portion of the data format is unaffected by the at least one pre-population rule.
at least a portion of the data format is unaffected by the modifications to the template.
the operations further comprise receiving via the interface, instructions to generate permission rules blocking access to at least a portion of the data for at least some users of the plurality of user-facing applications in which the template is integrated.
receiving utilization data from at least some of the plurality of user-facing applications;
aggregating utilization data.
generating suggestions for implementing modifications to the template based on aggregated utilization data.
accessing a data structure storing a template integrateable with a plurality of user-facing applications, and wherein the template includes a data format and at least one existing pre-population rule for configuring data within the data format.
receiving from a user, via an interface for editing the template, instructions to generate at least one permission rule configured to block control, by at least some users of the plurality of user-facing applications in which the template is integrated, of at least a portion of the data included in the data format.
receiving from the user via the interface for editing the template, instructions to modify the template.
updating the template by including the newly generated permission rule and modifications in the template.
determining compatibility of each user-facing application with the updated template by analyzing a current state of each of the plurality of user-facing applications.
pushing the updated template to the plurality of user-facing applications integrable with the template by: identifying differences between the updated template and each user-facing application; generating a set of updates that apply only the determined differences to each of the plurality user-facing applications; and applying the set of updates to each of the plurality of user-facing applications.
relationships between the template and the plurality of user-facing applications are stored in the data structure.
the data format includes a table format.
the at least one permission rule is configured to block control of at least one cell within the table format.
the at least one permission rule is configured to block control of at least one column within the table format.
transmitting a notification to each of the plurality of user-facing applications in which the template is integrated, wherein the notification is configured to inform users of the user-facing application concerned by the permission rules that control of the at least a portion of the data included in the data format is prohibited.
pushing the updated template to the plurality of user-facing applications includes receiving from the interface a signal for pushing the updated template.
pushing the updated template to the plurality of user-facing applications includes pushing the updated template while at least some of the plurality of user-facing applications are in use.
the at least one permission rule is configured to block control of at least a first portion of the data included in the data format to at least some first users of the plurality of user-facing applications and to block control of at least a second portion of the data included in the data format to at least some second users of the plurality of user-facing applications.
the set of updates includes, when at least one of the user-facing applications has missed one or more previous template updates, applying only the differences between a most recent template update and the at least one user-facing application.
the set of updates includes adapting structural changes in the updated template to each of the plurality of user-facing applications in a manner minimizing impact of the structural changes on each of the plurality of user-facing applications.
the set of updates includes detecting whether at least one of the plurality of user-facing applications already incorporates one or more modifications included in the updated template and, in response, converting corresponding resources in the user-facing application.
the set of updates further includes: detecting dependencies between the updated template and pre-existing configurations in each user-facing application; and applying adjustments to resolve conflicts before integrating the updates into each user-facing application.
the set of updates includes identifying and preserving user-customized elements within each user-facing application while integrating changes from the updated template.
inputting the differences between the updated template and each user-facing application into an AI agent; processing the differences with the AI agent to ascertain consequences for each user-facing application resulting from the updated template, and to develop a textual explanation of the consequences of the updated template; and sending to an owner of each user-facing application a notification configured to provide the textual explanation of consequences of the updated template.
sending the notification occurs while the updated template is pushed. sending the notification occurs after the updated template is pushed.
accessing data from at least two differently structured databases, each of the at least two differently structured databases being associated with at least one data structure including data fields.
in a SaaS platform, maintaining a schema including a predefined set of rules and definitions configured to standardize interpretation and organization of data entries across the at least two differently structured databases.
implementing the schema to: for each of the at least two differently structured databases, use the predefined set of rules of the schema to perform a compliance check on at least one portion of the data entries; upon determining compliance of the at least one portion of the data entries with the predefined set of rules of the schema, identify schema-compliant data entries and associate each of the at least two differently structured databases with the schema; enable interaction between the at least two differently structured databases; and facilitate issuance of one or more high-level commands applicable across the at least two differently structured databases, wherein the schema translates the one or more high-level commands into instructions adapted to the at least one data structure of each of the at least two differently structured databases to execute an intended action.
the at least two differently structured databases are maintained without a shared governing schema.
the schema is data structure agnostic.
the association within the schema is independent of locations of data fields within the at least two differently structured.
performing the compliance check includes at least one of: verifying that the least one portion of the data entries of each of the at least two differently structured databases fits the predefined set of rules of the schema; or running the predefined set of rules to identify matching inputs in the least one portion of the data entries of each of the at least two differently structured databases.
data entries of different types match one rule of the predefined set of rules.
the at least two differently structured databases include two databases including identical data entries located at different positions within the databases.
identifying schema-compliant data entries includes mapping data fields and associated entries of the at least two differently structured databases with the predefined set of rules and definitions included in the schema.
after association of each of the at least two differently structured databases with the schema, maintaining the association of each of the at least two differently structured databases by updating the mapping.
when at least one of the at least two differently structured databases fails to pass the compliance check, identifying one or more issues with the predefined set of rules of the schema and suggesting one or more actions to resolve the one or more issues.
associating each of the at least two differently structured databases with the schema includes associating an entirety of each of the at least two differently structured databases and wherein the entirety of each of the at least two differently structured databases is accessible within the schema.
each of the at least two differently structured databases associated with the schema includes schema-compliant data entries and non-schema-compliant data entries.
one schema-compliant data field corresponds to two or more different data fields included in the at least two differently structured databases.
the one or more high-level commands include: aggregating schema-compliant data entries from the at least two differently structured databases associated with the schema, wherein the aggregation is performed in accordance with the predefined set of rules of the schema; and generating a unified report based on the aggregated data entries, the unified report presenting schema-compliant data entries standardized across the at least two differently structured databases, wherein the unified report is generated following a request received from at least one SaaS platform user.
the one or more high-level commands include implementing at least one additional rule to schema-compliant data entries from the at least two differently structures databases associated with the schema.
the compliance check with the predefined set of rules included in the schema is performed in real time as new data entries are added to the at least two differently structured databases.
the schema supports user-defined extensions to allow at least one SaaS platform user to customize the data schema.
identifying schema compliant data entries is performed using a machine learning model trained to identify common patterns in unlabeled data fields.
in a SaaS platform, maintaining a schema, including a predefined set of rules and definitions configured to standardize interpretation and organization of data entries across a group of data structures, wherein each data structure of the group is associated with the schema and includes data fields and associated entries.
accessing an additional data structure including data fields and associated entries, wherein the additional data structure is differently structured than at least one data structure from the group of data structures and is not initially associated with the schema.
receiving a signal to associate the additional data structure with the schema.
performing a compliance check on at least one portion of the entries within the additional data structure with the predefined set of rules and definitions of the schema.
upon determining compliance of the at least one portion of the entries with the predefined set of rules and definitions of the schema, mapping data fields and associated entries of the additional data structure with the predefined set of rules and definitions included in the schema.
adding the additional data structure to the group of data structures, to thereby establish compatibility and standardization across the group of data structures.
the additional data structure is associated with at least one additional schema different from the maintained schema.
the signal to associate the additional data structure with the schema is received from a SaaS platform user.
the signal to associate the additional data structure with the schema is generated in response to a data recognition framework applied to the data fields and associated entries of the additional data structure, the data recognition framework being configured to identify similarities between the data fields and associated entries of the additional data structure, and the predefined set of rules and definitions included in the schema.
applying a data recognition framework includes using artificial intelligence.
presenting on an interface the similarities identified by the applied data recognition framework.
querying, via the interface, for accuracy confirmation of the presented similarities.
presenting on an interface a compliance score of the at least one portion of the entries within the additional data structure with the predefined set of rules and definitions of the schema.
presenting on the interface suggestions for improving the compliance score of the at least one portion of the entries within the additional data structure.
mapping data fields and associated entries of the additional data structure with the predefined set of rules and definitions included in the schema includes using artificial intelligence.
mapping data fields and associated entries of the additional data structure with the predefined set of rules and definitions included in the schema includes receiving input from a SaaS platform user via an interface.
applying metadata definitions to the additional data structure associated with the schema.
updating schema reports based on entries included within the additional data structure.
mapping data fields and associated entries of the additional data structure with the predefined set of rules and definitions included in the schema includes mapping one or more different data types to a given definition of the schema.
mapping data fields and associated entries of the additional data structure with the predefined set of rules and definitions included in the schema includes mapping one or more different data entries to a given definition of the schema.
mapping data fields and associated entries of the additional data structure with the predefined set of rules and definitions included in the schema includes running an AI agent configured to analyze at least some of the data fields and associated entries of the additional data structure and to identify a mapping with a given definition of the schema.
in a SaaS platform, accessing data of at least two user-facing applications, wherein each of the at least two user-facing applications is dependent on a respective template through metadata and is associated with at least one data structure, including data fields and data entries governed by the respective template.
applying a schema including a predefined set of rules and definitions configured to standardize interpretation and organization of data entries across the at least two user-facing applications.
receiving mapping information, wherein the mapping information identifies schema-compliant data entries included in the at least two user-facing applications.
associating the identified schema-compliant data entries included in the at least two user-facing applications with the schema.
translating one or more high-level commands applicable across the at least two user-facing applications, wherein the schema translates the one or more high-level commands into instructions adapted to the at least one data structure governed by the specific template of each of the at least two user facing applications to execute an intended action.
respective template governing each of the at least two user-facing applications is controlled by a different user of the SaaS platform.
the at least two user-facing applications include at least two SaaS platform elements of same or different types.
the schema is data structure agnostic.
the data structure of each of the at least two user-facing applications includes a table format.
the one or more high-level commands include: aggregating schema-compliant data entries from the at least two user-facing applications associated with the schema, wherein the aggregation is performed in accordance with the predefined set of rules of the schema; and generating a unified report based on the aggregated data entries, the unified report presenting schema-compliant data entries standardized across the at least two user-facing applications.
the unified report is generated following a request received from at least one SaaS platform user having access to the at least two user-facing applications.
the one or more high-level commands include implementing at least one additional rule to schema-compliant data entries from the at least two user-facing applications associated with the schema.
receiving mapping information includes performing a compliance check on data entries of each of the at least two user-facing applications using the predefined set of rules and definitions of the schema to identify schema-compliant data entries.
performing the compliance check includes using a machine learning model trained to identify common patterns in unlabeled data fields.
compliant data entries from the at least two user-facing applications are associated with data fields of different names.
upon detecting an update to one of the respective templates governing the at least two user-facing applications, performing a re-evaluation to determine whether the corresponding user-facing application remains associated with the schema based on the updated template.
the re-evaluation identifies portions of the data structure governed by the at least one updated respective template that remain schema-compliant and selectively retains partial association of the corresponding user-facing application with the schema.
if the re-evaluation determines non-compliance of at least one updated template with the predefined set of rules and definitions of the schema, the corresponding user-facing application is automatically disassociated from the schema.
notifying an associated user of the schema of the disassociation and the reason for schema non-compliance.
updates to the respective templates governing the at least two user-facing applications are tracked via version control, and historical compliance status with the schema is recorded for each version.
generating a unified report based on the aggregated data entries, the unified report presenting schema-compliant data entries standardized across the at least two user-facing applications.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, while illustrative embodiments have been described herein, the scope of any and all embodiments having equivalent elements, modifications, omissions, combinations (e.g., of aspects across various embodiments), adaptations, and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure may be implemented as a chip or a circuit. As software or algorithm, selected steps of the disclosure may be implemented as a plurality of software instructions being executed by a computer using any suitable operating system. In any case, selected steps of the method and system of the disclosure may be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally include a “network” or a “computer network”.

To provide for interaction with a user, the systems and techniques described here may be implemented on a computer having a display device (a LED (light-emitting diode), or OLED (organic LED), or LCD (liquid crystal display) monitor/screen) for displaying information to the user and a touch-sensitive layer such as a touchscreen, or keyboard and a pointing device (e.g., a mouse or a trackball), by which the user can provide input to the computer. Other kinds of devices may be used to provide for interaction with a user as well; for example, feedback provided to the user may be any form of sensory feedback (e.g., visual feedback, auditory feedback, or tactile feedback); and input from the user can be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

It should be appreciated that the above-described methods and apparatus may be varied in many ways, including omitting or adding steps, changing the order of steps, and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein may include various combinations and/or sub-combinations of the functions, components, and/or features of the different implementations described.

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It should be appreciated that the above-described embodiments can be implemented by hardware, or software (program codes), or a combination of hardware and software. If implemented by software, it can be stored in the above-described computer-readable media. The software, when executed by the processor may perform the disclosed methods. The computing units and other functional units described in the present disclosure may be implemented by hardware, or software, or a combination of hardware and software. One of ordinary skill in the art will also understand that multiple ones of the above-described modules/units may be combined as one module or unit, and each of the above-described modules/units may be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that may vary from implementation to implementation. Certain adaptations and modifications of the described embodiments can be made. Other embodiments may be apparent to those skilled in the art from consideration of the specification and practice of the invention disclosed herein. It is intended that the specification and examples be considered as examples only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Computer programs based on the written description and methods of this specification are within the skill of a software developer. The various programs or program modules may be created using a variety of programming techniques. One or more of such software sections or modules may be integrated into a computer system, non-transitory computer readable media, or existing software.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Various terms used in the specification and claims may be defined or summarized differently when discussed in connection with differing disclosed embodiments. It is to be understood that the definitions, summaries, and explanations of terminology in each instance apply to all instances, even when not repeated, unless the transitive definition, explanation, or summary would result in inoperability of an embodiment.

Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods may be modified in any manner, including by reordering steps or inserting or deleting steps. It is intended, therefore, that the specification and examples be considered as exemplary only, with a true scope and spirit being indicated by the following claims and their full scope of equivalents.

1-60. (canceled)

61. A non-transitory computer-readable medium containing instructions that, when executed by at least one processor, cause the at least one processor to perform operations for bottom-up data structure development, the operations comprising:
in a SaaS platform, maintaining a schema, including a predefined set of rules and definitions configured to standardize interpretation and organization of data entries across a group of data structures, wherein each data structure of the group is associated with the schema and includes data fields and associated entries;
accessing an additional data structure including data fields and associated entries, wherein the additional data structure is differently structured than at least one data structure from the group of data structures and is not initially associated with the schema;
receiving a signal to associate the additional data structure with the schema;
performing a compliance check on at least one portion of the entries within the additional data structure with the predefined set of rules and definitions of the schema;
upon determining compliance of the at least one portion of the entries with the predefined set of rules and definitions of the schema, mapping data fields and associated entries of the additional data structure with the predefined set of rules and definitions included in the schema; and
adding the additional data structure to the group of data structures, to thereby establish compatibility and standardization across the group of data structures.

62. The non-transitory computer-readable medium of claim 61, wherein the additional data structure is associated with at least one additional schema different from the maintained schema.

63. The non-transitory computer-readable medium of claim 61, wherein the signal to associate the additional data structure with the schema is received from a SaaS platform user.

64. The non-transitory computer-readable medium of claim 61, wherein the signal to associate the additional data structure with the schema is generated in response to a data recognition framework applied to the data fields and associated entries of the additional data structure, the data recognition framework being configured to identify similarities between the data fields and associated entries of the additional data structure, and the predefined set of rules and definitions included in the schema.

65. The non-transitory computer-readable medium of claim 64, wherein applying a data recognition framework includes using artificial intelligence.

66. The non-transitory computer-readable medium of claim 64, wherein the operations further comprise presenting on an interface the similarities identified by the applied data recognition framework.

67. The non-transitory computer-readable medium of claim 64, wherein the operations further comprise querying, via the interface, for accuracy confirmation of the presented similarities.

68. The non-transitory computer-readable medium of claim 61, wherein the operations further comprise presenting on an interface a compliance score of the at least one portion of the entries within the additional data structure with the predefined set of rules and definitions of the schema.

69. The non-transitory computer-readable medium of claim 68, wherein the operations further comprise presenting on the interface suggestions for improving the compliance score of the at least one portion of the entries within the additional data structure.

70. The non-transitory computer-readable medium of claim 61, wherein mapping data fields and associated entries of the additional data structure with the predefined set of rules and definitions included in the schema includes using artificial intelligence.

71. The non-transitory computer-readable medium of claim 61, wherein mapping data fields and associated entries of the additional data structure with the predefined set of rules and definitions included in the schema includes receiving input from a SaaS platform user via an interface.

72. The non-transitory computer-readable medium of claim 61, wherein the operations further comprise applying metadata definitions to the additional data structure associated with the schema.

73. The non-transitory computer-readable medium of claim 61, wherein the operations further comprise updating schema reports based on entries included within the additional data structure.

74. The non-transitory computer-readable medium of claim 61, wherein mapping data fields and associated entries of the additional data structure with the predefined set of rules and definitions included in the schema includes mapping one or more different data types to a given definition of the schema.

75. The non-transitory computer-readable medium of claim 61, wherein mapping data fields and associated entries of the additional data structure with the predefined set of rules and definitions included in the schema includes mapping one or more different data entries to a given definition of the schema.

76. The non-transitory computer-readable medium of claim 61, wherein mapping data fields and associated entries of the additional data structure with the predefined set of rules and definitions included in the schema includes running an AI agent configured to analyze at least some of the data fields and associated entries of the additional data structure and to identify a mapping with a given definition of the schema.

77. A method for bottom-up data structure development, the method comprising:
in a SaaS platform, maintaining a schema, including a predefined set of rules and definitions configured to standardize interpretation and organization of data entries across a group of data structures, wherein each data structure of the group is associated with the schema and includes data fields and associated entries;
accessing an additional data structure including data fields and associated entries, wherein the additional data structure is differently structured than at least one data structure from the group of data structures and is not initially associated with the schema;
receiving a signal to associate the additional data structure with the schema;
performing a compliance check on at least one portion of the entries within the additional data structure with the predefined set of rules and definitions of the schema;
upon determining compliance of the at least one portion of the entries with the predefined set of rules and definitions of the schema, mapping data fields and associated entries of the additional data structure with the predefined set of rules and definitions included in the schema; and
adding the additional data structure to the group of data structures, to thereby establish compatibility and standardization across the group of data structures.

78. The method of claim 77, wherein the signal to associate the additional data structure with the schema is generated in response to a data recognition framework applied to the data fields and associated entries of the additional data structure, the data recognition framework being configured to identify similarities between the data fields and associated entries of the additional data structure and the predefined set of rules and definitions included in the schema.

79. A system for bottom-up data structure development, the system comprising:
at least one processor configured to:
in a SaaS platform, maintain a schema, including a predefined set of rules and definitions configured to standardize interpretation and organization of data entries across a group of data structures, wherein each data structure of the group is associated with the schema and includes data fields and associated entries;
access an additional data structure including data fields and associated entries, wherein the additional data structure is differently structured than at least one data structure from the group of data structures and is initially not associated with the schema;
receive a signal to associate the additional data structure with the schema;
perform a compliance check on at least one portion of the entries within the additional data structure with the predefined set of rules and definitions of the schema;
upon determining compliance of the at least one portion of the entries with the predefined set of rules and definitions of the schema, map data fields and associated entries of the additional data structure with the predefined set of rules and definitions included in the schema; and
add the additional data structure to the group of data structures, to thereby establish compatibility and standardization across the group of data structures.

80. The system of claim 79, wherein the signal to associate the additional data structure with the schema is generated in response to a data recognition framework applied to the data fields and associated entries of the additional data structure, the data recognition framework being configured to identify similarities between the data fields and associated entries of the additional data structure and the predefined set of rules and definitions included in the schema.

81-100. (canceled)
